(19) United States
(12) Patent Application Publication
(10) Pub. No.: US 2011/0213084 A1
(43) Pub. Date: Sep. 1, 2011

(54) POLYMERS HAVING BOTH HARD AND SOFT SEGMENTS, AND PROCESS FOR MAKING SAME

(75) Inventors: Joseph P. Kennedy, Akron, OH (US); Gabor Erdodi, Stow, OH (US); Suresh Jewrajka, Akron (IN); Jungmee Kang, Stow, OH (US)

(73) Assignee: THE UNIVERSITY OF AKRON, Akron, OH (US)

(21) Appl. No.: 13/120,927

(22) PCT Filed: Oct. 1, 2009
(86) PCT No.: PCT/US2009/059269

§ 371 Date: May 19, 2011

Related U.S. Application Data
(60) Provisional application No. 61/194,896, filed on Oct. 1, 2008.
(60) Provisional application No. 61/204,857, filed on Jan. 12, 2009.
(60) Provisional application No. 61/178,529, filed on May 15, 2009.

(51) Int. Cl. C08F 255/10; C08G 18/65; C08G 18/08

(52) U.S. Cl. 525/131; 525/123

(57) ABSTRACT

The present invention generally relates to alcohol- and amine-terminated polyisobutylene (PIB) compounds, and to a process for making such compounds. In one embodiment, the present invention relates to primary alcohol- and amine-terminated polyisobutylene compounds, and to a process for making such compounds. In still another embodiment, the present invention relates to polyisobutylene compounds that can be used to synthesize polyurethanes and polyureas, to polyurethane and polyurea compounds made via the use of such polyisobutylene compounds, and to processes for making such compounds. In yet another embodiment, the present invention relates to polyisobutylene compounds containing urea or urethane segments therein, and to a method of producing such compounds. In still yet another embodiment, the present invention relates to a polymer having one or more different soft segments and one or more different hard segments.

### RELATED APPLICATION DATA

This patent application claims priority to U.S. Provisional Patent Application No. 61/194,896, filed on Oct. 1, 2008, entitled “Polyisobutylenes and Process for Making Same;” U.S. Provisional Patent Application No. 61/204,857, filed Jan. 12, 2009, entitled “Polyisobutylenes and Process for Making Same;” and U.S. Provisional Patent Application No. 61/178,529, filed May 15, 2009, entitled “Polyurethanes Containing Mixed PIB/PTMO and PIB/Aliphatic PC Soft Segments and Partially-Crystalline Hard Segments;” the entireties of which are hereby incorporated by reference herein.

The present invention was made in the course of research that was supported by National Science Foundation (NSF) Grant DMR 02-43314-3. The United States government may have certain rights to the invention or inventions herein.

### FIELD OF THE INVENTION

The present invention generally relates to alcohol- and amine-terminated polyisobutylene (PIB) compounds, and to a process for making such compounds. In one embodiment, the present invention relates to primary alcohol- and amine-terminated polyisobutylene compounds, and to a process for making such compounds. In still another embodiment, the present invention relates to polyisobutylene compounds that can be used to synthesize polyurethanes and polyureas, to polyurethane and polyurea compounds made via the use of such polyisobutylene compounds, and to processes for making such compounds. In yet another embodiment, the present invention relates to primary alcohol-terminated polyisobutylene compounds having two or more primary alcohol termini and to a process for making such compounds. In yet another embodiment, the present invention relates to primary amine-terminated polyisobutylene compounds having two or more primary amine termini. In yet another embodiment, the present invention relates to polyisobutylene compounds containing urea or urethane segments therein, and to a method of producing such compounds. In still yet another embodiment, the present invention relates to a polymer having one or more different soft segments and one or more different hard segments.

### BACKGROUND OF THE INVENTION

Various polyurethanes (PUs) are multibillion dollar commodities and are manufactured worldwide by some of the largest chemical companies (e.g., Dow, DuPont, BASF, and Mitsui). Polyurethanes are used in a wide variety of industrial and clinical applications in the form of, for example, thermoplastics, rubbers, foams, upholstery, tubing, and various biomaterials.

Typically, PUs are made by combining three ingredients: (1) a diol (such as tetramethylene oxide); (2) a diisocyanate (such as 4,4′-methylene diphenyl diisocyanate); and (3) a chain extender (such as 1,4-butanediol). Generally, polyurethanes (PUs) contain a soft (rubbery) and a hard (crystalline) component; and the properties of PUs depend on the nature and relative concentration of the soft/hard components.

Even though primary alcohol-terminated PIB compounds, such as HOCH₂—PIB—CH₂OH, have been prepared in the past, previous synthesis methods have been uneconomical. As such, the cost of manufacturing primary alcohol-terminated PIB compounds has been too high for commercial production. One reason for the high cost associated with manufacturing primary alcohol-terminated PIB compounds, such as HOCH₂—PIB—CH₂OH, is that the introduction of a terminal —CH₂OH group at the end of the PIB molecule necessitates the use of the hydroboration/oxidation method—a method that requires the use of expensive boron chemicals (such as H₆B₂ and its complexes).

Given the above, numerous efforts have been made to develop an economical process for manufacturing primary alcohol-terminated PIB compounds, such as HOCH₂—PIB—CH₂OH. For example, BASF has spent millions of dollars on the research and development of a process to make HOCH₂—PIB—CH₂OH by hydroboration/oxidation, where such a process permitted the recovery and reuse of the expensive boron containing compounds used therein. Other research efforts have met with limited success in reducing the cost associated with producing primary alcohol-terminated PIB compounds, such as PIB—CH₂OH or HOCH₂—PIB—CH₂OH.

With regard to amine-terminated PIBs, early efforts directed toward the synthesis of amine-terminated telechelic PIBs were both cumbersome and expensive, and the final structures of the amine-telechelic PIBs are different from those described below.

More recently, Binder et al. (see, e.g., D. Machl, M. J. Kunz and W. H. Binder, Polymer Preprints, 2003, 44(2), p. 85) initiated the living polymerization of isobutylene under well-known conditions, terminated the polymer with 1-(3-bromopropyl)-4-(1-phenylvinyl)-benzene, and effected a complicated series of reactions on the product to obtain amine-terminated PIBs. Complex structures different from those disclosed herein were obtained and the above method fails to yield amine-terminated telechelic PIB compounds that carry a defined number, for example 1.0±0.05, functional groups.

Given the above, there is a need in the art for a manufacturing process that permits the efficient and cost-effective production/manufacture of primary alcohol-terminated PIB compounds, primary amine-terminated PIB compounds, primary methacrylate-terminated PIB compounds, and/or primary amine-terminated telechelic PIB compounds. Also, there is a need in the art for a polymer having one or more different soft segments and one or more different hard segments, and to a method for synthesizing same.

### SUMMARY OF THE INVENTION

The present invention generally relates to alcohol- and amine-terminated polyisobutylene (PIB) compounds, and to a process for making such compounds. In one embodiment, the present invention relates to primary alcohol- and amine-terminated polyisobutylene compounds, and to a process for making such compounds. In still another embodiment, the present invention relates to polyisobutylene compounds that can be used to synthesize polyurethanes and polyureas, to polyurethane and polyurea compounds made via the use of such polyisobutylene compounds, and to processes for making such compounds. In yet another embodiment, the present invention relates to primary alcohol-terminated polyisobutylene compounds having two or more primary alcohol termini and to a process for making such compounds. In yet another embodiment, the present invention relates to primary amine-terminated polyisobutylene compounds having two or more primary amine termini. In yet another embodiment, the present invention relates to polyisobutylene compounds containing urea or urethane segments therein, and to a method of producing such compounds. In still yet another embodiment, the present invention relates to a polymer having one or more different soft segments and one or more different hard segments.

In one embodiment, the present invention relates to a method for producing a polyisobutylene compound containing urea hard segments comprising the steps of: (A) providing a primary amine-terminated polyisobutylene having at least two primary amine termini; (B) reacting the primary amine-terminated polyisobutylene with a diisocyanate and a chain extender; and (C) recovering the polyisobutylene compound containing various urea hard segments.

In another embodiment, the present invention relates to a polyisobutylene compound formed from the above method, wherein the polyisobutylene comprises urea hard segment portions.

In still another embodiment, the present invention relates to a method for producing a polyisobutylene compound containing urethane segments comprising the steps of: (a) providing a primary alcohol-terminated polyisobutylene having at least two primary alcohol termini; (b) reacting the primary alcohol-terminated polyisobutylene with a diisocyanate and a chain extender; and (c) recovering the polyisobutylene compound containing various urethane segments.

In still yet another embodiment, the present invention relates to a polyisobutylene compound formed from the above method, wherein the polyisobutylene comprises urethane segment portions.

In still yet another embodiment, the present invention relates to a polymer compound comprising urea or urethane segments therein, the polymer compound comprising: (i) one hard segment, wherein the hard segment is selected from a urea or urethane hard segment; and (ii) two soft segments.

In still yet another embodiment, the present invention relates to a polymer composition as disclosed and described herein.

In still yet another embodiment, the present invention relates to a method for making a polymer composition as disclosed and described herein.

### BRIEF DESCRIPTION OF THE DRAWINGS

FIG. 1A is a ¹H NMR spectrum of a three-arm star PIB molecule where the arm segments are-terminated with allyl groups (Ø-(PIB-Allyl)₃);

FIG. 1B is a ¹H NMR spectrum of a three-arm star PIB molecule where the arm segments are-terminated with primary bromines (—CH₂—Br);

FIG. 2 is a ¹H NMR spectrum of phthalimide-telechelic polyisobutylene;

FIG. 3 is a ¹H NMR spectrum of amine-telechelic polyisobutylene;

FIG. 4A is a graph illustrating stress (MPa) versus percent hard segment content for various compounds formed in accordance with the present invention;

FIG. 4B is a graph illustrating percent elongation versus percent by weight hard segment content for H₂N—PIB—NH₂/HMDI/HDA reaction process with varying amounts of hard segments;

FIG. 5 is a graph illustrating stress/strain traces for various PIB/HMDI/HDA and PIB/HMDI compounds containing different amounts of hard segments;

FIG. 6 is a ¹H NMR spectrum of H₂N—PIB—NH₂, Mₙ=6,200 grams/mole;

FIG. 7 is a set of GPC traces for H₂N—PIB—NH₂ of Mₙ=2,500 grams/mole, and those of non-chain-extended polyureas obtained with MDI and HMDI;

FIG. 8a is a graph illustrating tensile stress (MPa) versus percent hard segment content for various polyurea compounds formed in accordance with the present invention stress versus;

FIG. 8b is a graph illustrating strain (percent elongation) versus percent hard segment content for various polyurea compounds formed in accordance with the present invention;

FIG. 9 is a graph illustrating stress/strain traces for various PIB-based polyurea compounds containing different amounts of hard segments;

FIG. 10 is a graph illustrating TGA thermograms of polyurea compounds in accordance with the present invention;

FIG. 11 is a graph illustrating DMTA traces of polyurea compounds in accordance with the present invention;

FIG. 12 is an idealized structure of a PIB/PTMO-based polyurea (obtained at H₂N—PIB—NH₂/H₂N—PTMO—NH₂/OCN—X—NCO=1.3:1:9+stoichiometric amount of chain-extender);

FIG. 13 shows tensile strengths and elongations as a function of hard segment content of select polyureas;

FIG. 14 details stress-strain traces of various PIB-based polyureas with different hard segment contents (numbering refers to entries in Table 6);

FIG. 15 is a graph showing storage moduli vs. temperature traces of various polyureas and two commercially available polyurethanes before and after contact with CoCl₂/H₂O₂ for 40 days at 50° C.;

FIG. 16 are SEM images of Polyureas and Controls after CoCl₂/H₂O₂ treatment for 40 days at 50° C.;

FIG. 17 is an exemplary synthesis route for producing a phase-separated microstructure of a mixed soft segment polyurethane according to one embodiment of the present invention;

FIG. 18 is a graph showing representative GPC traces of the soft segment HO—PIB—OH (Mₙ=1,500 g/mol, marked “1”); HO—PTMO—OH (Mₙ=650 g/mol, marked “2”); and the polyurethane HO—PIB—OH(1.5 K-40%)+HO—PTMO—OH(0.6 k-20%)/HMDI+HD=40% (marked “3”);

FIG. 19 is a graph illustrating tensile strengths and elongations of PIB-based polyurethanes (absence of PTMO) with various hard segment contents and molecular weights (where each line corresponds to a single M_{W} PIB soft segment and each point in a line represents a different PIB/HS ratio);

FIG. 20 is a set of graphs that shown the effect of PTMO content on the tensile strength and elongation of polyurethanes (the molecular weights of PIB and PTMO=4,050 and 1,000 g/mol, respectively);

FIG. 21 is a graph showing tensile strength versus elongations at various PTMO contents and PIB molecular weights (PIB content=50%, the digits indicate percent PTMO);

FIG. 22 is a graph showing stress strain curves of representative PIB-based polyurethanes: HO—PIB—OH(4 k-50)/HMDI+HD=50% (marked “1”) , HO—PIB—OH(11 k-50)/HMDI+HD=50% (marked “2”), HO—PIB—OH(11 k-50)/HO—PTMO—OH(1 k-20)/HMDI+HD=30% (marked “3”);

FIG. 23 is a graph showing the effect of PIB molecular weight and 20% by weight PTMO on hardness (Microhardness as a function of hard segment content);

FIG. 24 is a graph showing a representative DSC trace of a mixed soft segment polyurethane [HO—PIB—OH(4 K, 50%)+HO—PTMO—OH(1K, 20%)/HMDI+HD=30%];

FIG. 25 is an illustration of one proposed morphology of: (a) PIB-based PUs, and (b) PIB+PTMO- or PIB+PC-based PUs, where HS^{cr} denotes crystalline region of HS, HS^{am} amorphous region of HS, HS^{d} short hard segments connecting two soft segments where a solid curve=PIB; a dotted curve=PTMO or PC and hydrogen bonds are represented by short thin lines;

FIG. 26 is a graph of DSC traces of various exemplary PIB/PTMO-based polyurethanes, where the numbers 1 through 4 denote the first four examples from the top of Table 9 below and where the arrows denote the melting peaks;

FIG. 27 is a graph of DSC traces of various exemplary PIB/PTMO-based polyureas, where the numbers 5 and 6 denote the fifth and sixth examples from the top of Table 9 and where the arrows denote the melting peaks;

FIG. 28 is a graph of DSC traces of various exemplary PIB/PC-based polyurethanes, where the numbers 7 through 10 denote seventh through tenth examples from the top of Table 9 and where the arrows denote the melting peaks;

FIG. 29 is an AFM phase image of HO—PIB—OH(4 K,48%)+HO—PTMO—OH(1K,21%)/HMDI+HDO=31% (third example from the top of Table 9);

FIG. 30 is a SAXS graph of PIB- and PIB/PTMO-, and PIB/PC-based polyurethanes or polyureas where the numbers 1 through 10 denote the first through tenth examples from the top of Table 9 and where the number in parentheses denotes the interdomain spacing;

FIG. 31 is a DMTA graph of PIB/PTMO-based polyurethanes where the numbers 2 through 4 denote the second through fifth examples from the top of Table 9; and

FIG. 32 is FTIR spectra of: (a) the carbonyl region of the model hard segment (CHI—HDO—HMDI—HDO—HMDI—HDO—HMDI—HDO—CHI), (b) the carbonyl region of PIB/PMTO-based polyurethanes, and (c) the N—H region of various polyurethanes where the parenthetical numbers correspond to the following compounds (1) HO—PIB—OH(4K,70%)/HMDI+HDO=30%; (2) HO—PIB—OH(4K,60%)+HO—PTMO—OH(1 K,10%)/HMDI+HDO=30%; (3) HO—PIB—OH(4 K,48%)+HO—PTMO—OH(1 K,21%)/HMDI+HDO=31%; (4) HO—PIB—OH(4 K,40%)+HO—PTMO—OH(1 K,30%)/HMDI+HDO=30%.

### DETAILED DESCRIPTION OF THE INVENTION

The present invention generally relates to alcohol- and amine-terminated polyisobutylene (PIB) compounds, and to a process for making such compounds. In one embodiment, the present invention relates to primary alcohol- and amine-terminated polyisobutylene compounds, and to a process for making such compounds. In still another embodiment, the present invention relates to polyisobutylene compounds that can be used to synthesize polyurethanes and polyureas, to polyurethane and polyurea compounds made via the use of such polyisobutylene compounds, and to processes for making such compounds. In yet another embodiment, the present invention relates to primary alcohol-terminated polyisobutylene compounds having two or more primary alcohol termini and to a process for making such compounds. In yet another embodiment, the present invention relates to primary amine-terminated polyisobutylene compounds having two or more primary amine termini. In yet another embodiment, the present invention relates to polyisobutylene compounds containing urea or urethane segments therein, and to a method of producing such compounds. In still yet another embodiment, the present invention relates to a polymer having one or more different soft segments and one or more different hard segments.

Although the present invention specifically discloses a method for producing various PIB molecules-terminated with one —CH₂—CH₂—CH₂—OH group, the present invention is not limited thereto. Rather, the present invention can be used to produce a wide variety of PIB molecular structures, where such molecules are terminated with one or more primary alcohols.

In one embodiment, the primary alcohols that can be used as terminating groups in the present invention include, but are not limited to, any straight or branched chain primary alcohol substituent group having from 1 to about 12 carbon atoms, or from 1 to about 10 carbon atoms, or from 1 to about 8, or from about 1 to about 6 carbon atoms, or even from about 2 to about 5 carbon atoms. Here, as well as elsewhere in the specification and claims, individual range limits can be combined to form alternative non-disclosed ranges and/or range limits.

In one embodiment, the present invention relates to linear, star-shaped, hyperbranched, or arborescent PIB compounds, where such compounds contain one or more primary alcohol-terminated segments. Such molecular structures are known in the art, and a discussion herein is omitted for the sake of brevity. In another embodiment, the present invention relates to star-shaped molecules that contain a center cyclic group (e.g., an aromatic group) to which three or more primary alcohol-terminated PIB arms are attached.

The following examples are exemplary in nature and the present invention is not limited thereto. Rather, as is noted above, the present invention relates to the production and/or manufacture of various PIB compounds and polyurethane and polyurea compounds made therefrom.

### EXAMPLES

### Section One

The following example concerns the synthesis of a primary hydroxyl-terminated polyisobutylene in three steps:

### (I) Preparation of a Star Molecule with Three Allyl-Terminated PIB Arms (Ø-(PIB-Allyl)₃)

The synthesis of Ø-(PIB-Allyl)₃ followed the procedure described by Lech Wilczek and Joseph P. Kennedy in The Journal of Polymer Science: Part A: Polymer Chemistry, 25, pp. 3255 through 3265 (1987), the disclosure of which is incorporated by reference herein in its entirety.

The first step involves the polymerization of isobutylene to tert-chlorine-terminated PIB by the 1,3,5-tri(2-methoxyisopropyl)benzene/TiCl₄ system under a blanket of N₂ in a dry-box. Next, in a 500 mL three-neck round bottom glass flask, equipped with an overhead stirrer, the following are added: a mixed solvent (n-hexane/methyl chloride, 60/40 v/v), 2,6-di-t-butyl pyridine (0.007 M), 1,3,5-tri(2-methoxyisopropyl)benzene (0.044M), and isobutylene (2 M) at a temperature of −76° C. Polymerization is induced by the rapid addition of TiCl₄ (0.15 M) to the stirred charge. After 10 minutes of stirring the reaction is terminated by the addition of a 3 fold molar excess of allyltrimethylsilane (AllylSiMe₃) relative to the tert-chlorine end groups of the Ø(PIB—Cl)₃ that formed. After 60 minutes of further stirring at −76° C., the system is deactivated by introducing a few milliliters of aqueous NaHCO₃, and the (allyl-terminated polyisobutylene) product is isolated. The yield is 28 grams (85 percent of theoretical) and the Mₙ=3,000 grams/mole.

### (II) Preparation of Ø-(PIB—CH₂—CH₂—CH₂—Br)₃: Anti-Markovnikov Addition of HBr to Ø-(PIB—Allyl)₃

A 100 mL three-neck flask is charged with heptane (50 mL) and allyl-telechelic polyisobutylene (10 grams), and air is bubbled through the solution for 30 minutes at 100° C. to activate the allylic end groups. Then the solution is cooled to approximately −10° C. and HBr gas is bubbled through the system for 10 minutes.

Dry HBr is generated by the reaction of aqueous (47 percent) hydrogen bromide and sulfuric acid (95 to 98 percent). After neutralizing the solution with aqueous NaHCO₃ (10 percent), the product is washed 3 times with water. Finally the solution is dried over magnesium sulfate for at least 12 hours (i.e., overnight) and filtered. The solvent is then removed via a rotary evaporator. The product is a clear viscous liquid.

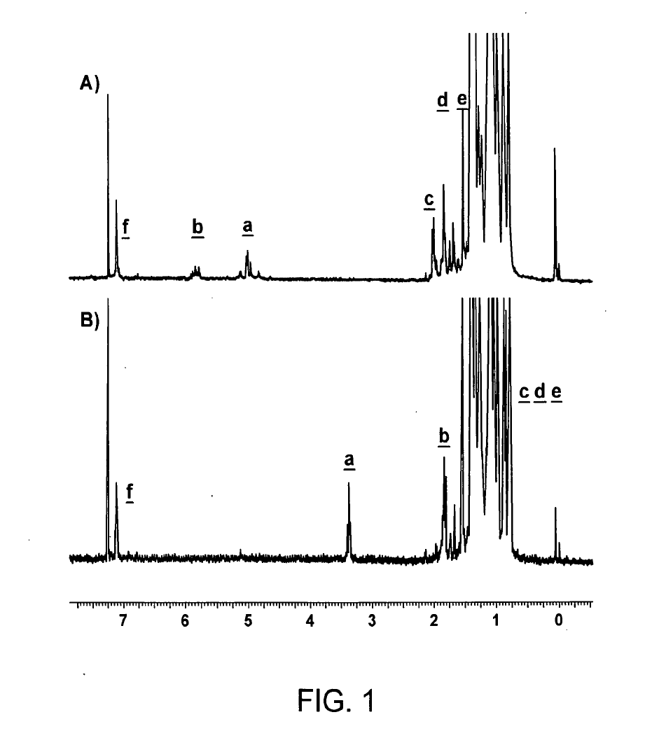

FIG. 1A shows the ¹H NMR spectrum of the allyl-terminated PIB and the primary bromine-terminated PIB product (FIG. 1B). The formulae and the group assignments are indicated below for FIGS. 1A and 1B.

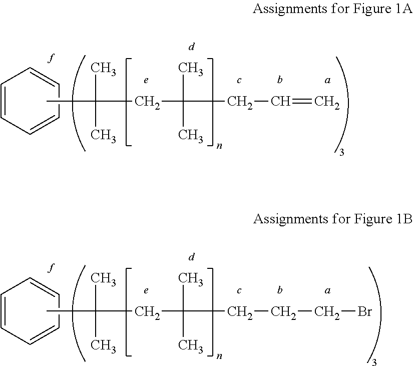

where n is an integer from 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

It should be noted that the present invention is not limited to solely the use of allyl-terminated compounds, shown above, in the alcohol-terminated polyisobutylene production process disclosed herein. Instead, other straight or branched C₃ to C₁₂, C₄ to C₁₀, or even C₅ to C₇ alkenyl groups can be used so long as one double bond in such alkenyl groups is present at the end of the chain. Here, as well as elsewhere in the specification and claims, individual range limits can be combined to form alternative non-disclosed ranges and/or range limits.

As a further example regarding the above-mentioned alkenyl groups the following general formula is used to show the positioning of the end double bond:

—R₁=CH₂

where R₁ is the remaining portion of the straight or branched alkenyl groups described above. In another embodiment, the alkenyl groups of the present invention contain only one double bond and this double bond is at the end of the chain as described above.

The olefinic (allylic) protons at 5 ppm present in spectrum (A) completely disappear upon anti-Markovnikov hydrobromination, as is shown in spectrum (B). The aromatic protons present in the 1,3,5-tri(2-methoxyisopropyl)benzene (initiator residue) provide an internal reference. Thus, integration of the terminal methylene protons of the —PIB—CH₂—CH₂—CH₂—Br relative to the three aromatic protons in the initiator fragment yields quantitative functionality information. The complete absence of allyl groups and/or secondary bromines indicates substantially 100 percent conversion to the target anti-Markovnikov product Ø-(PIB—CH₂—CH₂—CH₂—Br)₃.

### (III) Preparation of Ø-(PIB—CH₂—CH₂—CH₂—OH)₃ from Ø-(PIB—CH₂—CH₂—CH₂—Br)₃

The conversion of the terminal bromine product to a terminal primary hydroxyl group is performed by nucleophilic substitution on the bromine. A round bottom flask equipped with a stirrer is charged with a solution of Ø(PIB—CH₂—CH₂—CH₂—Br)₃ in THF. Then an aqueous solution of NaOH is added, and the charge is stirred for 2 hours at room temperature. Optionally, a phase transfer catalyst such as tetraethyl ammonium bromide can be added to speed up the reaction. The product is then washed 3 times with water, dried over magnesium sulfate overnight and filtered. Finally the solvent is removed via the use of a rotary evaporator. The product, a primary alcohol-terminated PIB product, is a clear viscous liquid.

In another embodiment, the present invention relates to a process for producing halogen-terminated PIBs (e.g., chlorine-terminated PIBs rather than the bromine containing compounds discussed above). These halogen-terminated PIBs can also be utilized in the above process and converted to primary alcohol-terminated PIB compounds. Additionally, as is noted above, the present invention relates to the use of such PIB compounds in the production of polyurethanes and polyureas, as well as a variety of other polymeric end products, such as methacrylates (via a reaction with methacryloyl chloride), hydrophobic adhesives (e.g., cyanoacrylate derivatives), epoxy resins, polyesters, etc.

In still another embodiment, the primary halogen-terminated PIB compounds of the present invention can be converted into PIB compounds that contain end epoxy groups, amine groups, etc. Previous efforts to inexpensively prepare primary halogen-terminated PIB compounds were fruitless and only resulted in compounds with tertiary terminal halogens.

As noted above, the primary alcohol-terminated PIBs are useful intermediates in the preparation of polyurethanes by reaction via conventional techniques, i.e., by the use of known isocyanates (e.g., 4,4′-methylenediphenyl diisocyanate, MDI) and chain extenders (e.g., 1,4-butanediol, BDO). The great advantage of these polyurethanes (PUs) is their biostability imparted by the biostable PIB segment. Moreover, since PIB is known to be biocompatible, any PU made from the PIB compounds of the present invention is novel as well as biocompatible.

The primary terminal OH groups can be further derivatized to yield additional useful derivatives. For example, they can be converted to terminal cyanoacrylate groups which can be attached to living tissue and in this manner new tissue adhesives can be prepared.

In one embodiment of the present invention, the starting PIB segment can be mono-, di- tri, and multi-functional, and in this manner one can prepare di-terminal, tri-terminal, or other PIB derivatives. In another embodiment, the present invention makes it possible to prepare a,w di-terminal (telechelic), tri-terminal, or other PIB derivatives. One of the most interesting PIB starting materials is arborescent-PIB (arb-PIB) that can carry many primary halogen termini, all of which can be converted to primary alcohol groups.

In another embodiment, the following equations describe further processes and compounds that can be produced via the present invention. As a general rule, all of the following reactions can be run at a 95 percent or better conversion rate.

(A) Cationic living isobutylene polymerization affords a first intermediate which is, for example, a tert-Cl-terminated PIB chain:

˜˜˜C(CH₃)₂—[CH₂—C(CH₃)₂]ₙ—CH₂—C(CH₃)₂—Cl (A)

where ˜˜˜ represents the remaining portion of a linear, star, hyperbranched, or arborescent molecule and n is defined as noted above. As would be apparent to those of skill in the art, ˜˜˜ can in some instances represent another chlorine atom in order to permit the production of substantially linear di-terminal primary alcohol PIBs. Additionally, it should be noted that, in some embodiments, the present invention is not limited to the above specific linking groups (i.e., the —C(CH₃)₂) between the repeating PIB units and the remainder of the molecules of the present invention.

(B) The next step is the dehydrogenation of (A) to afford the second intermediate shown below:

˜˜˜C(CH₃)₂—[CH₂—C(CH₃)₂]ₙ—CH₂—C(CH₃)═CH₂ (B).

(C) The third step is the anti-Markovnikov bromination of (B) to afford the primary bromide shown below:

˜˜˜C(CH₃)₂—[CH₂—C(CH₃)₂]ₙ—CH₂—CH(CH₃)—CH₂—Br (C).

(D) The fourth step is the conversion of the primary bromide by the use of a base (e.g., NaOH, KOH, or tert-BuONa) to a primary hydroxyl group according to the following formula:

˜˜˜C(CH₃)₂—[CH₂—C(CH₃)₂]ₙ—CH₂—CH(CH₃)—CH₂—OH (D).

In another embodiment, the following reaction steps can be used to produce a primary alcohol-terminated PIB compound according to the present invention.

(B′) Instead of the dehydrochlorination, as outlined in (B), one can use an allyl silane such as trimethyl allyl silane to prepare an allyl terminated PIB:

˜˜˜C(CH₃)₂—[CH₂—C(CH₃)₂]ₙ—CH₂—CH═CH₂ (B′)

(C′) Similarly to the reaction shown in (C) above, the (B′) intermediate is converted to the primary bromide by an anti-Markovnikov reaction to yield the following compound:

˜˜˜C(CH₃)₂—[CH₂—C(CH₃)₂]ₙ—CH₂—CH₂—CH₂—Br (C′).

(D′) (C′) can be converted to a primary alcohol-terminated compound as discussed above to yield the following compound:

˜˜˜C(CH₃)₂[CH₂—C(CH₃)₂]ₙ—CH₂—CH₂—CH₂—OH (D′).

As discussed above, in another embodiment the present invention relates to primary terminated polyisobutylene compounds having two or more primary termini selected from an amine groups or methacrylate groups. Again, as in other embodiments of the present invention, the following embodiments can be applied to linear, star, hyperbranched, or arborescent molecules with the number of repeating units in the PIB portion of such molecules being the same as defined as noted above.

### (IV) Synthesis of Polyisobutylene Methacrylate Macromolecules (PIB—(CH₂)₃-MA

Synthesis of a primary methacrylate-terminated polyisobutylene is carried out according to the exemplary reaction scheme shown below:

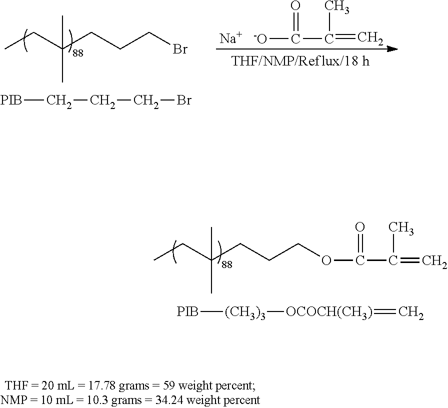

To 1.0 grams of PIB—(CH₂)₃—Br (Mₙ=5,160 grams/mole and M_{w}/Mₙ=1.065) dissolved in 20 mL of THF is added 10.0 mL NMP to increase the polarity of the medium. To this solution is added 1 gram of sodium methacrylate, and the mixture is refluxed at 80° C. for 18 hours. The charge is diluted by the addition of 50 mL hexanes and washed 3 times with excess water. The organic layer is separated, washed three times with distilled water and dried over MgSO₄. The hexanes are removed by a rotavap and the resulting polymer is dried under vacuum, and the yield of PIB—(CH₂)₃—MA is 0.95 grams (95 percent).

It should be noted that the above embodiment is not limited to just the use of sodium methacrylate, but rather other suitable methacrylate compounds could be used. Such compounds include, but are not limited to, alkaline methacrylate compounds.

Additionally, the present invention is not limited to solely the use of allyl-terminated compounds in the methacrylate-terminated polyisobutylene production process disclosed herein. Instead, other straight or branched C₃ to C₁₂, C₄ to C₁₀, or even C₅ to C₇ alkenyl groups can be used so long as one double bond in such alkenyl groups is present at the end of the chain. Here, as well as elsewhere in the specification and claims, individual range limits can be combined to form alternative non-disclosed ranges and/or range limits.

As a further example regarding the above-mentioned alkenyl groups the following general formula is used to show the positioning of the end double bond:

—R₁═CH₂

where R₁ is the remaining portion of the straight or branched alkenyl groups described above. In another embodiment, the alkenyl groups of the present invention contain only one double bond and this double bond is at the end of the chain as described above.

### (V) Synthesis of Amine-Terminated Polyisobutylene (PIB—(CH₂)₃—NH₂)

In this embodiment, the synthesis of PIB—(CH₂)₃—NH₂ involves two steps: (a) substitution of the terminal primary bromine to phthalimide-terminated polyisobutylene (PIB—(CH₂)₃—phthalimide); and (b) hydrazinolysis of the phthalimide terminated polyisobutylene to primary amine-terminated polyisobutylene (PIB—(CH₂)₃—NH₂).

### (a) Synthesis of Phthalimide-Terminated Polyisobutylene (PIB—(CH₂)₃-Phthalimide)

Synthesis of a phthalimide-terminated polyisobutylene (PIB—(CH₂)₃-phthalimide) is carried out according to the reaction scheme shown below:

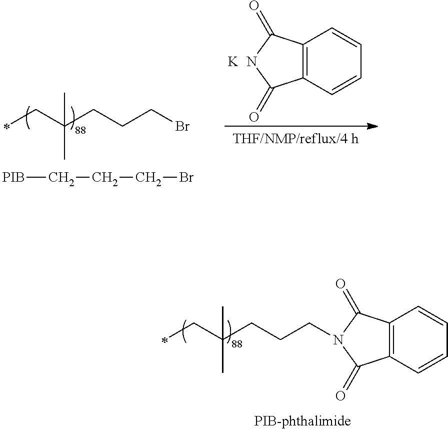

To 1.0 gram of PIB—(CH₂)₃—Br (Mₙ=5160 grams/mole and M_{w}/Mₙ=1.06) dissolved in 20 mL THF is added 10 mL of NMP to increase the polarity of the medium. To this solution is added 1.0 gram of potassium phthalimide and the mixture is refluxed at 80° C. for 4 hours. The reaction mixture is diluted by the addition of 50 mL hexanes and washed 3 times with excess water. The organic layer is separated, washed three times with distilled water and dried over MgSO₄.

The hexanes are removed by a rotavap, and the resulting polymer is dried under vacuum. The yield of PIB—(CH₂)₃—phthalimide is 0.97 grams.

### (b) Synthesis of Primary Amine-Terminated Polyisobutylene (PIB—(CH₂)₃—NH₂)

Synthesis of an amine-terminated polyisobutylene (PIB—(CH₂)₃—NH₂) is carried out according to the reaction scheme shown below:

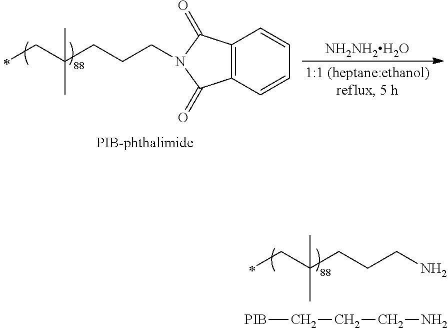

To 1.0 gram of PIB—(CH₂)₃-phthalimide dissolved in a mixture of 20 mL heptane and 20 mL of ethanol is added 3 grams of hydrazine hydrate. This mixture is then refluxed at 105° C. for 5 hours. Then the charge is diluted with 50 mL of hexanes and washed 3 times with excess water. The organic layer is separated, washed three times with distilled water and dried over MgSO₄. The hexanes are removed by a rotavap and the polymer is dried under vacuum. The yield of PIB—(CH₂)₃—NH₂ is 0.96 grams.

It should be noted that the present invention is not limited to solely the use of allyl-terminated compounds, shown above, in the amine-terminated polyisobutylene production process disclosed herein. Instead other straight or branched C₃ to C₁₂, C₄ to C₁₀, or even C₅ to C₇ alkenyl groups can be used so long as one double bond in such alkenyl groups is present at the end of the chain. Here, as well as elsewhere in the specification and claims, individual range limits can be combined to form alternative non-disclosed ranges and/or range limits.

As a further example regarding the above-mentioned alkenyl groups the following general formula is used to show the positioning of the end double bond:

R₁═CH₂

where R₁ is the remaining portion of the straight or branched alkenyl groups described above. In another embodiment, the alkenyl groups of the present invention contain only one double bond and this double bond is at the end of the chain as described above.

In another embodiment, the present invention relates to a polyisobutylenes having at least two primary bromine termini as shown in the formula below:

˜˜˜C(CH₃)₂—[CH₂—C(CH₃)₂]ₙ—R₃—Br

where ˜˜˜ represents the remaining portion of a linear, star, hyperbranched, or arborescent molecule and n is defined as noted above. As would be apparent to those of skill in the art, ˜˜˜ can in some instances represent another bromine atom in order to permit the production of substantially linear di-terminal primary alcohol PIBs. In the above formula R₃ represents the remainder of the alkenyl group left after subjecting a suitable alkenyl-terminated compound to an anti-Markovnikov bromination step in accordance with the present invention. As would be apparent to those of skill in the art, R₃ could be either a straight or branched C₃ to C₁₂, C₄ to C₁₀, or even C₅ to C₇ alkyl group (the result of the “starting” alkenyl group having only one double bond, with such double bond being present at the end of the chain as described above). In another embodiment, R₃ could be either a straight or branched C₃ to C₁₂, C₄ to C₁₀, or even C₅ to C₇ alkenyl group (the result of the “starting” alkenyl group having two or more double bonds, with one of the double bonds being present at the end of the chain as described above).

### Telechelic Amine and Alcohol PIBs for Use in the Production of Various Polymer Compounds:

In another embodiment, the present invention relates to amine-telechelic polyisobutylenes (PIBs) that carry a certain amount of functional primary (—NH₂), secondary (—NH—R₄), or tertiary (═N—R₄) amine end groups where R₄ is as defined below. In yet another embodiment, the present invention relates to alcohol-telechelic PIBs that carry a certain amount of functional primary alcohol end groups (—OH).

The term telechelic (from the Greek telos=far, and chelos=claw) indicates that each and every terminus of a polymer molecule is fitted with a functional end group. In one embodiment of the present invention the functional end groups of the present invention are hydroxyl or amine end groups. In another embodiment of the present invention, each chain end of a hydroxyl- or an amine-telechelic PIB molecule carries about 1.0±0.05 functional groups (i.e., a total of about 2.0±0.05, i.e., better than about 95 mole percent).

As is noted above, in one embodiment the present invention relates to amine-telechelic polyisobutylenes (PIBs) that carry primary (—NH₂), secondary (—NH—R₄), or tertiary (═N—R₄) amine end groups, where R₄ is selected from linear or branched C₁ to C₃₀ alkyl group, a linear or branched C₂ to C₃₀ alkenyl group, a linear or branched C₂ to C₃₀ alkynyl group. In another embodiment, R₄ is selected from linear or branched C₁ to C₂₀ alkyl group, a linear or branched C₂ to C₂₀ alkenyl group, a linear or branched C₂ to C₂₀ alkynyl group. In still another embodiment, R₄ is selected from linear or branched C₁ to C₁₀ alkyl group, a linear or branched C₂ to C₁₀ alkenyl group, a linear or branched C₂ to C₁₀ alkynyl group, or even C₁ to C₅ alkyl group, a linear or branched C₂ to C₆ alkenyl group, a linear or branched C₂ to C₆ alkynyl group. Here, as well as elsewhere in the specification and claims, individual range limits can be combined to form alternative non-disclosed ranges and/or range limits.

In yet another embodiment, R₄ is selected from either a methyl, ethyl, propyl, or butyl group, or in still another embodiment R₄ is selected from a methyl or ethyl group.

The simplest telechelic PIB molecule is the ditelechelic structure; for example, a PIB fitted with one —NH₂ group at either end of the molecule: H₂N—PIB—NH₂. A PIB carrying only one —NH₂ terminus (i.e., PIB—NH₂) is not an amine-telechelic PIB within the definition known to those of skill in the art. A three-arm star amine-telechelic PIB (i.e., a tri-telechelic PIB) carries three —NH₂ groups, one —NH₂ group at each arm end: abbreviated R₅(PIB—NH₂)₃, where the R₅ is selected from any tri-substituted aromatic group. In another embodiment, in the case of a three-arm star amine-telechelic PIB, R₅ can be any suitable functional group that can be tri-substituted with three PIB—NH₂ groups. A hyperbranched or arborescent amine-telechelic PIB carries many —NH₂ termini, because all the branch ends carry an —NH₂ terminus (multi-telechelic PIB). In another embodiment, the primary NH₂ groups mentioned above can be replaced by the afore-mentioned secondary (—NH—R₄), or tertiary (═N—R₄) amine end groups with R₄ being defined above.

Molecules with less than about 1.0±0.05 hydroxyl or amine groups per chain end, and synthesis methods that yield less than about 1.0±0.05 hydroxyl or amine groups per chain end are of little or no practical interest in the production of compounds for use in the production of polyurethanes and/or polyureas. This stringent requirement must be met because these telechelic PIBs are designed to be used as intermediates for the production of polyurethanes and polyureas, and precise starting material stoichiometry is required for the preparation of polyurethane and/or polyurea compounds having optimum mechanical properties. In the absence of precise (i.e., about 1.0±0.05) terminal functionality, the preparation of high quality polyurethanes and polyureas is not possible.

Polymers obtained by the reaction of hydroxyl-ditelechelic PIB (i.e., HO—PIB—OH) and diisocyanates (e.g., MDI) contain urethane (carbamate) linkages:

˜˜˜OH+OCN˜˜˜→˜˜˜O—CO—NH˜˜˜

and are called polyurethanes, where in this case ˜˜˜ represents the remainder of the polyurethane molecule. Similarly, polymers prepared by amine-ditelechelic PIB (H₂N—PIB—NH₂) plus diisocyanates contain urea linkages:

˜˜˜NH₂+OCN˜˜˜→˜˜˜NH—CO—NH˜˜˜

and are called polyureas, where in this case ˜˜˜ represents the remainder of the polyurea molecule.

Finally, the overall cost of the products, as determined by the cost of the starting materials and the procedures, is of decisive importance because only low cost commercially feasible simple syntheses are considered.

Although the present invention specifically discloses a method for producing various alcohol-telechelic PIBs and amine-telechelic PIBs terminated with at least two alcohol or amine groups, the present invention is not limited thereto. Rather, the present invention can be used to produce a wide variety of PIB molecular structures where such molecules are terminated with two or more primary alcohols or two or more amine groups be they primary amine groups, secondary amine groups, or tertiary amine groups.

In one embodiment, the primary alcohols that can be used as terminating groups in the present invention include, but are not limited to, any straight or branched chain primary alcohol substituent group having from 1 to about 12 carbon atoms, or from 1 to about 10 carbon atoms, or from 1 to about 8, or from about 1 to about 6 carbon atoms, or even from about 2 to about 5 carbon atoms. Here, as well as elsewhere in the specification and claims, individual range limits can be combined to form alternative non-disclosed ranges and/or range limits.

In another embodiment, the present invention relates to linear, star-shaped, hyperbranched, or arborescent PIB compounds, where such compounds contain two or more primary alcohol-terminated segments, amine-terminated segments, or amine-containing segments. Such molecular geometries are known in the art, and a discussion herein is omitted for the sake of brevity. In another embodiment, the present invention relates to star-shaped molecules that contain a center cyclic group (e.g., an aromatic group) to which three or more primary alcohol-terminated PIB arms are attached, or three or more amine-containing PIB arms are attached.

The following examples are exemplary in nature and the present invention is not limited thereto. Rather, as is noted above, the present invention relates to the production and/or manufacture of various primary alcohol-terminated PIB compounds and polyurethane compounds made therefrom.

### EXAMPLES

### Section Two

The following example concerns the synthesis of a primary hydroxyl-terminated polyisobutylene in three steps as is discussed above:

### (I) Preparation of a Star Molecule with Three Allyl-Terminated PIB Arms (Ø(PIB-Allyl)₃)

The synthesis of Ø-(PIB-Allyl)₃ followed the procedure described by Lech Wilczek and Joseph P. Kennedy in The Journal of Polymer Science: Part A: Polymer Chemistry, 25, pp. 3255 through 3265 (1987), the disclosure of which is incorporated by reference herein in its entirety.

The first step involves the polymerization of isobutylene to tert-chlorine-terminated PIB by the 1,3,5-tri(2-methoxyisopropyl)benzene/TiCl₄ system under a blanket of N₂ in a dry-box. Next, in a 500 mL three-neck round bottom glass flask, equipped with an overhead stirrer, the following are added: a mixed solvent (n-hexane/methyl chloride, 60/40 v/v), 2,6-di-t-butyl pyridine (0.007 M), 1,3,5-tri(2-methoxyisopropyl)benzene (0.044M), and isobutylene (2 M) at a temperature of −76° C. Polymerization is induced by the rapid addition of TiCl₄ (0.15 M) to the stirred charge. After 10 minutes of stirring the reaction is terminated by the addition of a 3 fold molar excess of allyltrimethylsilane (AllylSiMe₃) relative to the tert-chlorine end groups of the Ø(PIB—Cl)₃ that formed. After 60 minutes of further stirring at −76° C., the system is deactivated by introducing a few milliliters of aqueous NaHCO₃, and the (allyl-terminated polyisobutylene) product is isolated. The yield is 28 grams (85 percent of theoretical) and the Mₙ=3,000 grams/mole.

### (II) Preparation of Ø(PIB—CH₂—CH₂CH₂—CH₂—Br)₃: Anti-Markovnikov Addition of HBr to Ø-(PIB-Allyl)₃

A 100 mL three-neck flask is charged with heptane (50 mL) and allyl-telechelic polyisobutylene (10 grams), and air is bubbled through the solution for 30 minutes at 100° C. to activate the allylic end groups. Then the solution is cooled to approximately −10° C. and HBr gas is bubbled through the system for 10 minutes.

Dry HBr is generated by the reaction of aqueous (47 percent) hydrogen bromide and sulfuric acid (95 to 98 percent). After neutralizing the solution with aqueous NaHCO₃ (10 percent), the product is washed 3 times with water. Finally the solution is dried over magnesium sulfate for at least 12 hours (i.e., over night) and filtered. The solvent is then removed via a rotary evaporator. The product is a clear viscous liquid.

FIG. 1A shows the ¹H NMR spectrum of the allyl-terminated PIB and the primary bromine-terminated PIB product (FIG. 1B). The formulae and the group assignments are indicated below for FIGS. 1A and 1B.

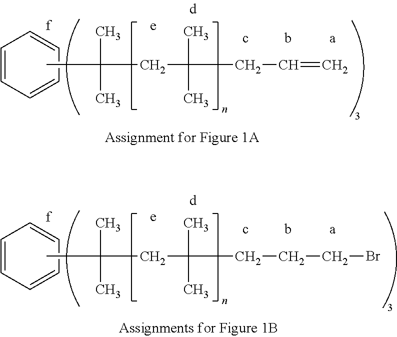

where n is an integer from 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

It should be noted that the present invention is not limited to solely the use of allyl-terminated compounds, shown above, in the alcohol-terminated polyisobutylene production process disclosed herein. Instead, other straight or branched C₃ to C₁₂, C₄ to C₁₀, or even C₅ to C₇ alkenyl groups can be used so long as one double bond in such alkenyl groups is present at the end of the chain. Here, as well as elsewhere in the specification and claims, individual range limits can be combined to form alternative non-disclosed ranges and/or range limits.

As a further example regarding the above-mentioned alkenyl groups the following general formula is used to show the positioning of the end double bond:

—R₁═CH₂

where R₁ is the remaining portion of the straight or branched alkenyl groups described above. In another embodiment, the alkenyl groups of the present invention contain only one double bond and this double bond is at the end of the chain as described above.

The olefinic (allylic) protons at 5 ppm present in spectrum (A) completely disappear upon anti-Markovnikov hydrobromination, as is shown in spectrum (B). The aromatic protons present in the 1,3,5-tri(2-methoxyisopropyl)benzene (initiator residue) provide an internal reference. Thus, integration of the terminal methylene protons of the —PIB—CH₂—CH₂—CH₂—Br relative to the three aromatic protons in the initiator fragment yields quantitative functionality information. The complete absence of allyl groups and/or secondary bromines indicates substantially 100 percent conversion to the target anti-Markovnikov product Ø—(PIB—CH₂—CH₂—CH₂—Br)₃.

### (III) Preparation of Ø-(PIB—CH₂—CH₂—CH₂OH)₃ from Ø-(PIB—CH₂—CH₂—CH₂—Br)₃

The conversion of the terminal bromine product to a terminal primary hydroxyl group is performed by nucleophilic substitution on the bromine. A round bottom flask equipped with a stirrer is charged with a solution of Ø-(PIB—CH₂—CH₂—CH₂—Br)₃ in THF. Then an aqueous solution of NaOH is added, and the charge is stirred for 2 hours at room temperature. Optionally, a phase transfer catalyst such as tetraethyl ammonium bromide can be added to speed up the reaction. The product is then washed 3 times with water, dried over magnesium sulfate overnight and filtered. Finally the solvent is removed via the use of a rotary evaporator. The product, a primary alcohol-terminated PIB product, is a clear viscous liquid.

In another embodiment, the present invention relates to a process for producing halogen-terminated PIBs (e.g., chlorine-terminated PIBs rather than the bromine containing compounds discussed above). These halogen-terminated PIBs can also be utilized in above process and converted to primary alcohol-terminated PIB compounds. Additionally, as is noted above, the present invention relates to the use of such PIB compounds in the production of polyurethanes, as well as a variety of other polymeric end products, such as methacrylates (via a reaction with methacryloyl chloride), hydrophobic adhesives (e.g., cyanoacrylate derivatives), epoxy resins, polyesters, etc.

In still another embodiment, the primary halogen-terminated PIB compounds of the present invention can be converted into PIB compounds that contain end epoxy groups, amine groups, etc. Previous efforts to inexpensively prepare primary halogen-terminated PIB compounds were fruitless and only resulted in compounds with tertiary terminal halogens.

As noted above, the primary alcohol-terminated PIBs are useful intermediates in the preparation of polyurethanes by reaction via conventional techniques, i.e., by the use of known isocyanates (e.g., 4,4′-methylenediphenyl diisocyanate, MDI) and chain extension agents (e.g., 1,4-butanediol, BDO). The great advantage of these polyurethanes (PUs) is their biostability imparted by the biostable PIB segment. Moreover, since PIB is known to be biocompatible, any PU made from the PIB compounds of the present invention is novel as well as biocompatible.

The primary terminal OH groups can be further derivatized to yield additional useful derivatives. For example, they can be converted to terminal cyanoacrylate groups which can be attached to living tissue and in this manner new tissue adhesives can be prepared.

In one embodiment of the present invention, the starting PIB segment can be mono-, di- tri, and multi-functional, and in this manner one can prepare di-terminal, tri-terminal, or other PIB derivatives. In another embodiment, the present invention makes it possible to prepare α,ω di-terminal (telechelic), tri-terminal, or other PIB derivatives. One of the most interesting PIB starting materials is arborescent-PIB (arb-PIB) that can carry many primary halogen termini, all of which can be converted to primary alcohol groups.

In another embodiment, the following equations describe further processes and compounds that can be produced via the present invention. As a general rule, all of the following reactions can be run at a 95 percent or better conversion rate.

(A) Cationic living isobutylene polymerization affords a first intermediate which is, for example, a tert-Cl-terminated PIB chain:

˜˜˜C(CH₃)₂—[CH₂—C(CH₃)₂]ₙ—CH₂—C(CH₃)₂—Cl (A)

where ˜˜˜ represents the remaining portion of a linear, star, hyperbranched, or arborescent molecule and n is defined as noted above. As would be apparent to those of skill in the art, ˜˜˜ can in some instances represent another chlorine atom in order to permit the production of substantially linear di-terminal primary alcohol PIBs. Additionally, it should be noted that the present invention is not limited to the above specific linking groups (i.e., the —C(CH₃)₂) between the repeating PIB units and the remainder of the molecules of the present invention.

(B) The next step is the dehydrochlorination of (A) to afford the second intermediate shown below:

˜˜˜C(CH₃)₂—[CH₂—C(CH₃)₂]ₙ—CH₂—C(CH₃)═CH₂ (B).

(C) The third step is the anti-Markovnikov bromination of (B) to afford the primary bromide shown below:

˜˜˜C(CH₃)₂—[CH₂—C(CH₃)₂]ₙ—CH₂—CH(CH₃)—CH₂—Br (C).

(D) The fourth step is the conversion of the primary bromide by the use of a base (e.g., NaOH, KOH, or tert-BuONa) to a primary hydroxyl group according to the following formula:

˜˜˜C(CH₃)₂—[CH₂—C(CH₃)₂]ₙ—CH₂—CH(CH₃)—CH₂—OH (D).

In another embodiment, the following reaction steps can be used to produce a primary alcohol-terminated PIB compound according to the present invention.

(B′) Instead of the dehydrogenation, as outlined in (B), one can use an allyl silane such as trimethyl allyl silane to prepare an allyl terminated PIB:

˜˜˜C(CH₃)₂—[CH₂—C(CH₃)₂]ₙ—CH₂—CH═CH₂ (B′).

(C′) Similarly to the reaction shown in (C) above, the (B′) intermediate is converted to the primary bromide by an anti-Markovnikov reaction to yield the following compound:

˜˜˜C(CH₃)₂—[CH₂—C(CH₃)₂]ₙ—CH₂—CH₂—CH₂Br (C′).

(D′) (C′) can be converted to a primary alcohol-terminated compound as discussed above to yield the following compound:

˜˜˜C(CH₃)₂—[CH₂—C(CH₃)₂]ₙ—CH₂—CH₂—CH₂—OH (D′)

### (IV) The Structure, Synthesis and Characterization of H₂N—PIB—NH₂

The detailed structure of this example, the amine-ditelechelic PIB, is defined by the following formula. However, the present invention is not limited thereto.

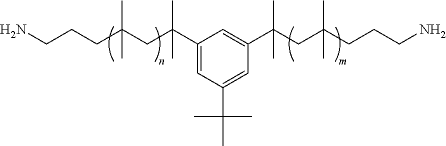

where n and m are each independently selected from an integer in the range of from 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

The above compound can be produced from a corresponding brominated structure as shown above in (C). The following chemical equations summarize the synthesis method for the above compound:

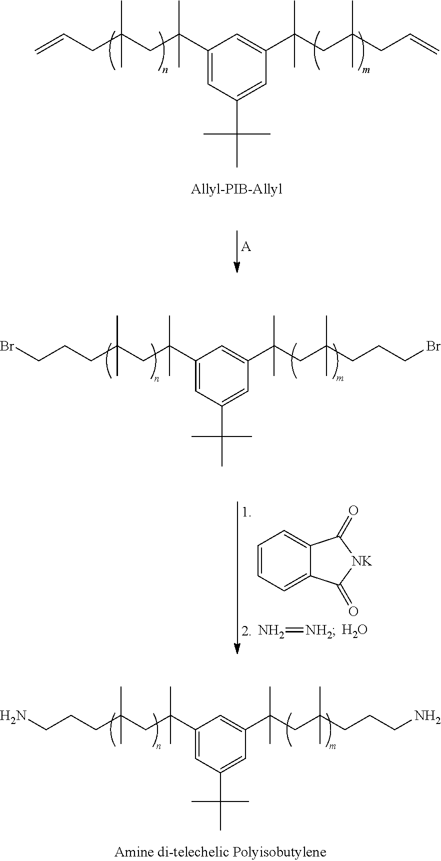

where n and m are each independently selected from an integer in the range of from 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

Additionally, the reaction conditions at A are: 30 grams of polymer, 150 mL of heptane (103 grams), reflux at 110° C. for 30 minutes, followed by passing HBr over the polymer solutions for 5 minutes at 0° C.

The Allyl-PIB-Allyl is then converted to the telechelic primary bromide, Br—(CH₂)₃—PIB—(CH₂)₃—Br, as described in above. Next, the Br—(CH₂)₃—PIB—(CH₂)₃—Br is converted by using: (1) potassium phthalimide; and (2) hydrazine hydrate to yield the target ditelechelic amine: NH₂—(CH₂)₃—PIB—(CH₂)₃—NH₂.

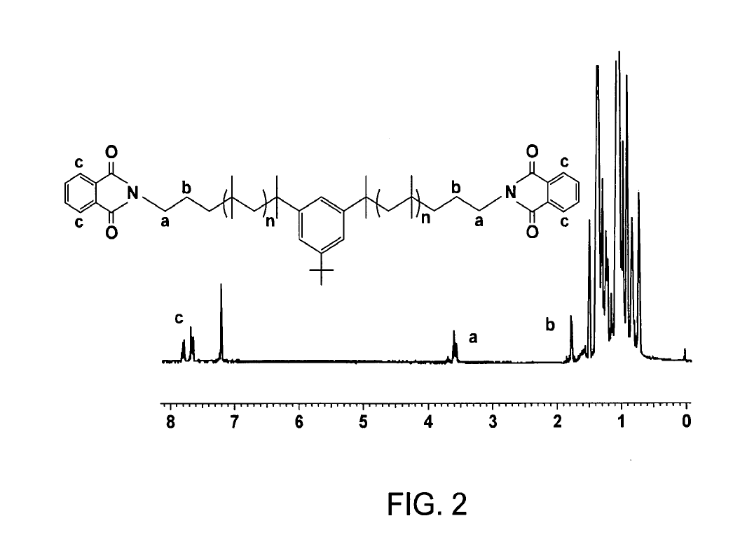

Following the above process, 16 grams of bromo-ditelechelic polyisobutylene (0.003 mol) is dissolved in 320 mL dry THF. Then, 160 mL of NMP and phthalimide potassium (2.2 grams, 0.012 moles) are added to this solution. Next, the solution is heated to reflux at 80° C. for 8 hours. The product is then dissolved in 100 mL of hexanes, extracted 3 times with water and dried over magnesium sulfate. The structure of the intermediate is ascertained by ¹H NMR spectroscopy. FIG. 2, below, shows the ¹H NMR spectrum of phthalimide-telechelic polyisobutylene together with assignments.

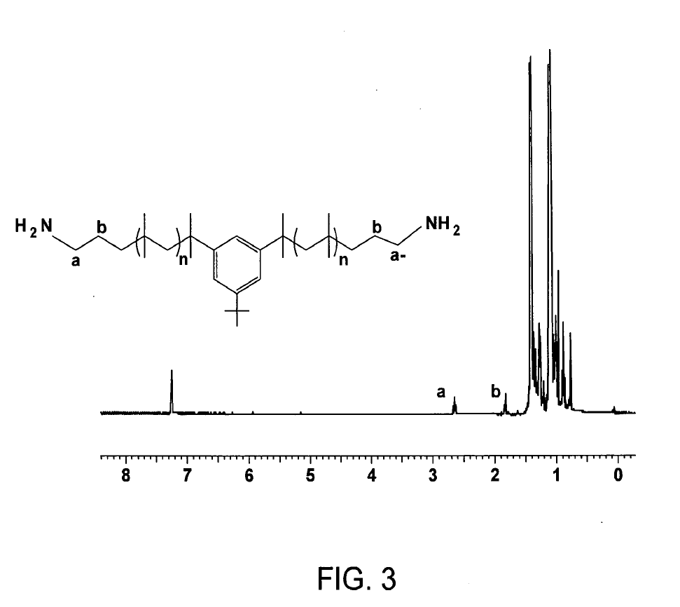

Then, the phthalimide-telechelic polyisobutylene (14 grams, 0.0025 moles) is dissolved in 280 mL of heptane, then 280 mL of ethanol and hydrazine hydrate (3.2 grams, 0.1 moles) are added thereto, and the solution is heated to reflux at 110° C. for 6 hours. The product is dissolved in hexanes, extracted 3 times with water, dried over magnesium sulfate, and the hexanes are removed by a rotavap. The structure of the target product is ascertained by ¹H NMR spectroscopy. FIG. 3 shows the ¹H NMR spectrum of amine-telechelic polyisobutylene together with assignments.

### The Synthesis and Characterization of PIB-Based Polyurethanes and Polyureas

### (a) Polyurethanes

(1) The Synthesis of the HO—PIB—OH Starting Material:

The synthesis of HO—PIB—OH is as described above. Thus, the starting material, a commercially available (Kaneka Inc.) allyl-ditelechelic PIB (M_{W}=5,500 grams/mole) is hydrobrominated by dissolving it in heptane and bubbling HBr through the solution for 30 minutes at 70° C. Then the product is dissolved in THF, aqueous KOH and n-methyl pyrrolidone are added, and the system is refluxed for 24 hours at 100° C. The structure of the HO—PIB—OH is ascertained by proton NMR spectroscopy.

(2) The Synthesis of a PIB-Based Polyurethane and Demonstration of its Oxidative Stability:

The polyurethane is obtained by reaction of the HO—PIB—OH with methylene-bis-phenyl isocyanate (MDI). The following equations describe the synthesis strategy used:

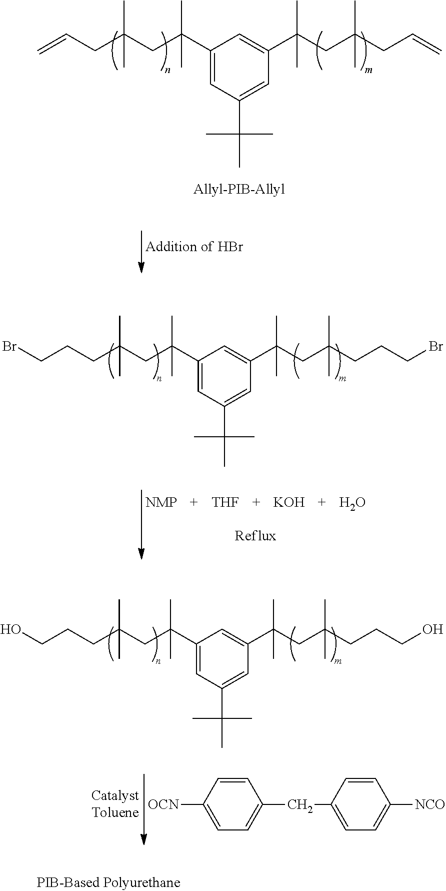

where n and m are each independently selected from an integer in the range of from 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

Thus, HO—PIB—OH (2.2 grams, Mₙ=5,500 grams/mole, hydroxyl equivalent 0.0008 mole) is dissolved in dry toluene (12 mL) and freshly distilled MDI (0.3 grams, 0.0012 moles of isocyanate) and tin dioctoate (0.03 mL) catalyst are added under a dry nitrogen atmosphere. The charge is then heated for 8 hours at 70° C., cooled to room temperature, and poured in a rectangular (5 cm×5 cm) Teflon mold. The system is air dried overnight and finally dried in a drying oven at 70° C. for 24 hours. The polyurethane product is a pale yellow supple rubbery sheet, soluble in THF. Manual examination reveals good mechanical properties.

The oxidative resistance of the polyurethane is tested by placing small amounts (approximately 0.5 grams) of pre-weighed samples in concentrated (65 percent) nitric acid in a 25 mL glass vial, and gently agitating the system at room temperature. Concentrated nitric acid is recognized to be one of the most aggressive and corrosive oxidizing agents. After 24 and 48 hours the appearance of the samples is examined visually and their weight loss determined gravimetrically by using the following expression:

Wₗₒₛₛ=(W_{b}−Wₐ/W_{b})100

where Wₗₒₛₛ is percent weight loss and W_{b}, and Wₐ are the weights of the samples before and after nitric acid exposure, respectively. The weight loss is experimentally determined by removing the pre-weighed samples from the nitric acid, rinsing them thoroughly with water, drying them till weight constancy (approximately 24 hours), and weighed again. For comparison, the same procedure is also carried out with a “control” polyurethane prepared using a HO—PDMS—OH and MDI, and with another commercially available polyurethane (AorTech Biomaterials, Batch #60802, E2A pellets sample).

The control polyurethane is prepared as follows: 1 gram (0.0002 moles) of hydroxyl-ditelechelic polydimethylsiloxane (DMS-C21, Gelest, Mₙ=4,500 to 5,500 grams/mole) is dissolved in 10 mL of toluene, and freshly distilled MDI (0.11 grams, 0.0002 moles) followed by (0.03 mL) tin octoate catalyst are added under a dry nitrogen atmosphere. The charge is heated for 8 hours at 70° C., cooled to room temperature, and poured in a rectangular (5 cm×5 cm) Teflon mold. The polyurethane sheet that is produced is air dried overnight and finally dried in a drying oven at 70° C. for 24 hours. The product is a pale yellow supple rubbery sheet, soluble in THF. Manual examination reveals good mechanical properties.

Table 1 summarizes the results of aggressive oxidative/hydrolytic degradation test performed with PIB-, PDMS-based polyurethanes and a PIB-based polyurea. The test reagent is 65 percent HNO₃ at room temperature.

TABLE 1

| | Time of | | | |
|---|---|---|---|---|
| | exposure to | | Weight | |
| | concentrated | | Loss in | |
| Materials | HNO₃ | | Percent | Observations |
| PIB-Based | 1 | hour | 0 | No visible change |
| (HO-PIB-OH) | 4 | hours | 0 | No visible change |
| Polyurethane | 24 | hours | 0 | No visible change |
| | 48 | hours | 0 | Deep brown |
| | | | | discoloration, sample |
| | | | | becomes weak |
| PDMS-based | 30 | minutes | 40 | Sample disintegrates to |
| (HO-PDMS-OH) | | | | pasty mass adhering to |
| Control | | | | glass |
| Polyurethane | 2 | hours | 60 | Sample largely dissolved, |
| | | | | some discolored jelly |
| | | | | mass remains |
| | 4 | hours | 90 | Sample largely dissolved, |
| | | | | some discolored jelly |
| | | | | mass remains |
| Commercial | 30 | minutes | 50 | Sample disintegrated, |
| Polyurethane | | | | some discolored jelly |
| (AorTech) | | | | mass remains |
| | 1.5 | hours | 70 | Sample disintegrated, |
| | | | | some discolored jelly |
| | | | | mass remains |
| | 4 | hours | 95 | Sample disintegrated, |
| | | | | some discolored jelly |
| | | | | mass remains |
| PIB-Based | 1 | hours | 0 | No visible change |
| (H₂N-PIB-NH₂) | 4 | hours | 0 | No visible change |
| Polyurea | 24 | hours | 0 | No visible change |
| | 48 | hours | 0 | Deep brown |
| | | | | discoloration, sample |
| | | | | becomes weak |

According to the data, the PIB-based polyurethanes and polyureas (prepared with HO—PIB—OH/MDI and H₂N—PIB—NH₂/MDI) do not degrade after 24 hours when exposed to concentrated HNO₃ at room temperature. Oxidative/hydrolytic resistance is demonstrated by the negligible weight loss of the polyurethane and polyurea films. After 48 hours exposure to concentrated HNO₃ both the PIB-based polyurethane and polyurea films exhibit deep brown discoloration and a visible weakening of the samples. In contrast, the control polyurethane prepared with HO—PDMS—OH/MDI, and a commercial polyurethane (i.e., a material considered highly oxidatively/hydrolytically stable) completely degrades, and becomes largely soluble in the acid after less than 4 hours of exposure.

While not wishing to be bound to any one theory, the spectacular oxidative/hydrolytic resistance of the PIB-based polyurethane and polyurethane formed in accordance with the synthesis processes of the present invention is most likely due to the protection of the vulnerable urethane (carbamate) and urea bonds by the inert PIB chains/domains. In contrast, the PDMS chains/domains cannot impart protection against the attack of the strong oxidizing acid.

### (b) Polyureas

(1) The Synthesis of PIB-Based Polyureas and

Demonstration of their Oxidative Stability:

To H₂N—PIB—NH₂ (1.5 grams, Mₙ=5,500 grams/mole, amine equivalent 0.00054 moles) dissolved in dry toluene (10 mL) is added freshly distilled MDI (0.125 grams, 0.0005 moles), with stirring, under a dry nitrogen atmosphere. Within a minute the solution becomes viscous. It is then diluted with 5 mL of toluene and poured in a rectangular (5 cm×5 cm) Teflon mold. The system is air dried overnight and finally dried in a drying oven at 70° C. for 24 hours. The polyurea product is a pale yellow supple rubbery sheet, soluble in THF. Manual examination reveals reasonable mechanical properties.

The oxidative/hydrolytic stability of the polyurea is tested by exposing the sample to concentrated HNO₃ at room temperature (see Table 1 above). The last entry in Table 1 shows data relating to this Example. Evidently, the PIB-based polyurea resists degradation under the harsh conditions detailed above for 24 hours.

(2) The Synthesis of PIB-Based Polyureas With Increased Hard Segment Content:

Given the above, polyureas with increased hard segment content can be synthesized as will be detailed below. The following process is also applicable to the production of polyurethanes using OH—PIB—OH as is described above. The use of increased hard segments is designed to achieve heretofore unavailable hydrolytically/oxidatively stable biocompatible and biostable high strength elastomers.

Additionally, the present invention also involves conditions for the homogeneous synthesis of polyisobutylene polyureas (PIBUs) by the use of H₂N—PIB—NH₂ (Mₙ=2,500 grams/mole), HMDI as the diisocyanate, and various diamine chain extenders (ethylenediamine (EDA), 1,4-diaminobutane (BDA), 1,6-diaminohexane (i.e., hexamethylene diamine or HDA), or 2-methyl-1,5-pentanediamine (MPDA)). In one embodiment, the hard segment content of such polyisobutylene polyureas (PIBUs) is at least about 8 percent by weight, at least about 10 percent by weight, at least about 15 percent by weight, at least about 20 percent by weight, at least about 25 percent by weight, at least about 30 percent by weight, about 35 percent by weight, at least about 40 percent by weight, or even about 45 or more percent by weight.

Through the use of HDA as the chain extender the amount of urea hard segment in a PIBU can be as high as 45 percent by weight without phase separation during synthesis. This product is optically clear and exhibits approximately 20 MPa tensile strength with approximately 110 percent elongation.

The tensile strength of this PIBU increases to approximately 23 MPa upon annealing overnight at 150° C. Additionally, the ultimate elongations of a series of

PIB/HMDI/HDA PIBUs containing increasing amounts of HDA-based hard segments do not fall below approximately 110 percent; this suggests an unexpected morphological feature of great practical interest. Alternatively, charges containing more than approximately 18 percent EDA and/or BDA undergo unacceptable phase separation during chain extension.

With the branched chain extender MPDA, the amount of hard segment could be increase to 40 percent by weight. However, the properties of the PIBU formed with MPDA are in some aspects inferior to those obtained with HDA.

(3) Chain Extension Experiments:

A representative synthesis procedure is as follows. In a 50 mL three-neck round bottom flask equipped with magnetic stirrer are placed, HMDI (0.6 grams, 0.00225 moles) and 2 mL of dry THF under a nitrogen atmosphere. The flask is sealed by a rubber septum, cooled to about 5° C., and H₂N—PIB—NH₂ (Mₙ=2,500, 1 gram, 0.0004 moles) is dissolved in 6 mL THF and is added dropwise via a syringe. The pre-polymer charge is stirred at room temperature for 30 minutes, cooled to 5° C., and HDA (0.22 grams, 0.0019 moles) is dissolved in 6 mL THF and is added dropwise. The charge is stirred at room temperature for an additional 1 hour, poured into a Teflon mold, and kept at 60° C. for a day. The 0.2 mm film thus obtained is dried under vacuum for 24 hour at 50° C. All the charges are homogeneous and optically clear during the reaction.

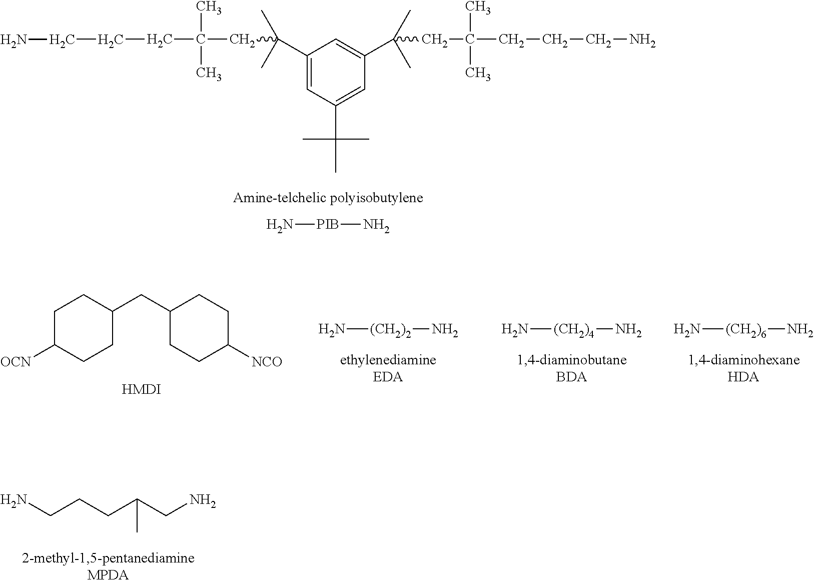

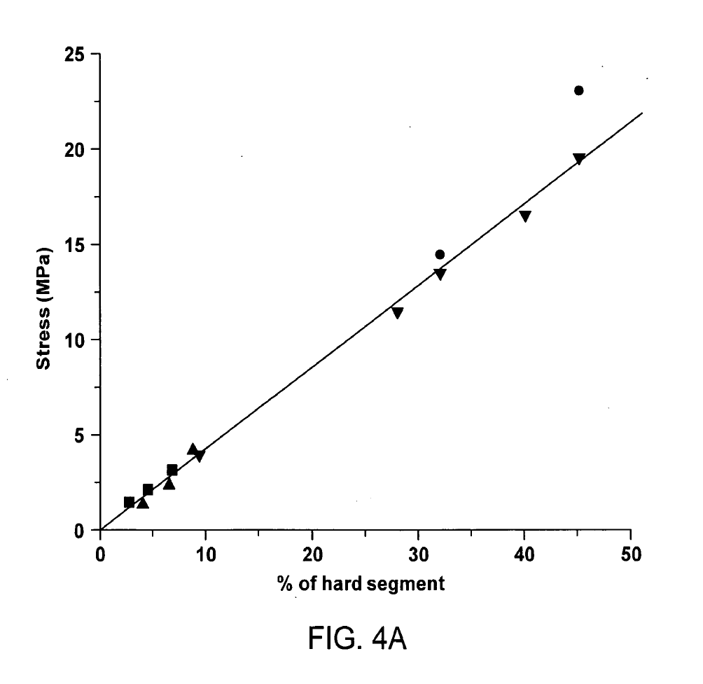

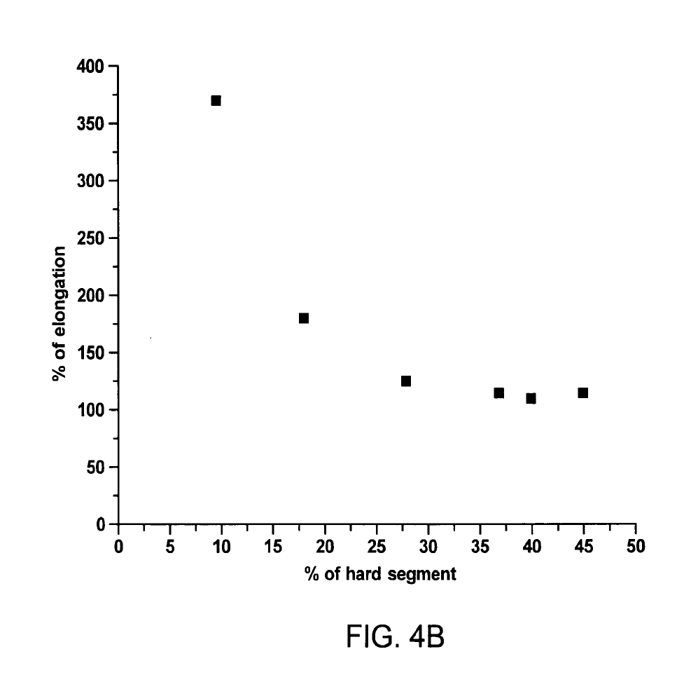

Table 2 below summarizes the various ingredients, relative reagent concentrations, hard segment content, various mechanical properties, and visual observations made during the syntheses. FIGS. 4A and 4B show the variation of stress (MPa) and strain (percent of elongation) with hard segment content, respectively. Evidently, tensile strengths increase linearly with the hard segment content, and the straight line can be back extrapolated to the origin. The increase of stress with hard segment content suggests that the urea hard segments are phase separated and homogeneously distributed in the soft PIB matrix.

The elongations of PIBUs prepared with HDA are higher than those prepared with MPDA. For example, at 37 weight percent hard segment, the elongations obtained with HDA and MPDA are 115 percent and 60 percent, respectively. While not wishing to be bound to any one theory, it is believed that the low elongation obtained with MPDA suggests that the methyl side chain of MPDA disrupts the organized alignment of the hard segments.

Annealing enhances the properties of PIBUs. It is found that the tensile strength of PIBUs containing 37 weight percent and 45 weight percent hard segment increases from 13.4 and 19.5 MPa, respectively, to 14.4 and 23 MPa, respectively, after annealing (see FIG. 4A, and Table 2 below). While not wishing to be bound to any one theory, it is believed that the increase of stress after annealing is most likely due to improved alignment of the hard segments.

In the compositions contained in Table 2 are prepared with H₂N—PIB—NH₂ having a Mₙ=2,500. Additionally, the stress and strain data given in Table 2 is an average of three determinations per sample.

FIG. 4A is a graph illustrating stress (MPa) versus percent hard segment for various compounds formed in accordance with the present invention where ▪ represents H₂N—PIB—NH₂/HDI (hexamethylene diisocyanate), represents H₂N—PIB—NH₂/HMDI/HDA after annealing at 150° C. for 12 hours, ▴ represents H₂N—PIB—NH₂/MDI (methylene diphenyl diisocyanate), and ▾ represents H₂N—PIB—NH₂/HMDI/HDA. FIG. 4B is a graph illustrating percent elongation versus percent by weight hard segment for H₂N—PIB—NH₂/HMDI/HDA reaction process with varying amounts of hard segments.

TABLE 2

| | H₂N-PIB-NH₂/ | Hard | | | | |
|---|---|---|---|---|---|---|
| Diisocyanate/ | Isocyanate/ | Segment | | | | |
| Chain | Chain Extender | Content | Stress | Strain | Hardness | |
| Extender | Mole Ratio | (Wt. %) | (MPa)* | (%)* | (Microshore) | Visual Observations |
| HMDI/— | 1/1/0 | 9.5 | 4 | 370 | 48 | Colorless, transparent film |
| HMDI/EDA | 1/2/1 | 18 | 8.5 | 120 | 55 | Colorless, transparent film |
| HMDI/EDA | 1/3/2 | 28 | | | | Phase separation during |
| | | | | | | reaction |
| HMDI/BDA | 1/2/1 | 18 | 8 | 140 | 52 | Colorless, transparent film |
| HMDI/BDA | 1/3/2 | 28 | | | | Phase separation during |
| | | | | | | reaction |
| HMDI/HDA | 1/2/1 | 18 | 7.5 | 175 | 60 | Colorless, transparent film |
| HMDI/HDA | 1/3/2 | 28 | 11.5 | 125 | 60 | Colorless, transparent film |
| HMDI/HDA | 1/4.4/3.4 | 37 | 13.5 | 115 | 60 | Colorless, transparent film |
| HMDI/HDA - After | 1/4.4/3.4 | 37 | 14.4 | 108 | 60 | Colorless, transparent film |
| Annealing at | | | | | | |
| 150° C. for | | | | | | |
| 12 hours | | | | | | |
| HMDI/HDA | 1/5.2/4.2 | 40 | 16.5 | 110 | 68 | Colorless, transparent film |
| HMDI/HDA | 1/5.7/4.7 | 45 | 19.5 | 115 | 72 | Colorless, transparent film |
| HMDI/HDA - After | 1/5.7/4.7 | 45 | 23 | 100 | 70 | Colorless, transparent film |
| Annealing at | | | | | | |
| 150° C. for | | | | | | |
| 12 hours | | | | | | |
| HMDI/MPDA | 1/4.4/3.4 | 32 | 12 | 60 | 70 | Colorless, transparent film |
| HMDI/MPDA | 1/5.2/4.2 | 40 | | | | Brittle film |

*Average of three determinations.

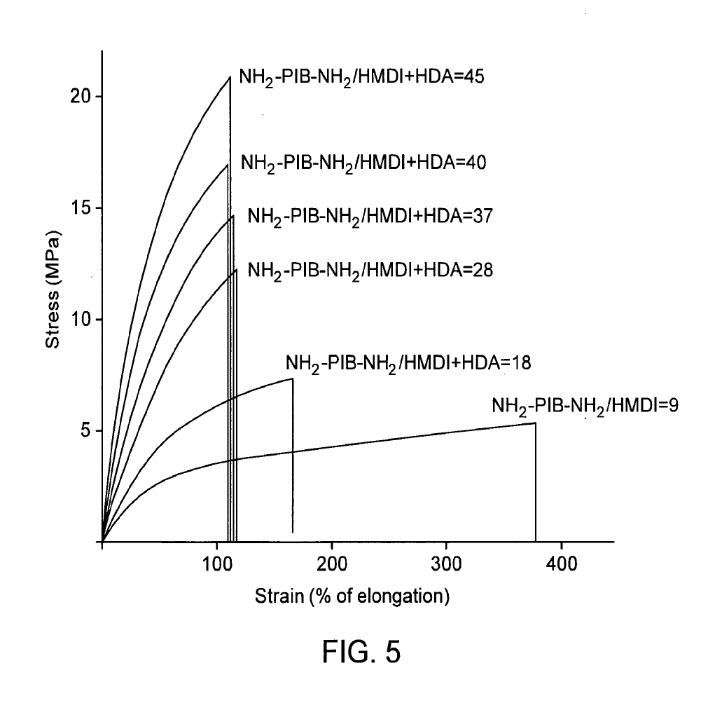

The combination of HMDI diisocyanate and HDA chain-extender produces homogeneous reaction mixtures even with 45 weight percent hard segment content (see Table 2 above). In contrast, the charges became opaque due to phase separation in the presence of more than approximately 18 weight percent EDA and or BDA chain extenders. FIG. 5 summarizes stress/strain profiles of a series of PIB/HMDI/HDA PIBUs containing increasing amounts of hard segments. Tensile strengths increases linearly with the amount of HDA in the 9 to 45 weight percent range, however, elongations decrease only to approximately 110 percent, at which level they plateau off and do not decrease further. While not wishing to be bound to any one theory, it is believed this due to the high degree of incompatibility between the soft PIB and the polar hard segments the rubbery phase tends to maintain continuity even in the presence of increasing hard segment content.

### (c) Additional Polyurea Embodiments: Section 1

(1) Materials:

Hydrogen bromide, hydrazine hydrate, potassium phthalimide, allyltrimethylsilane (allylSiMe₃), BCl₃ (1 M in dichloromethane) TiCl₄, 1,2-diaminoethane (EDA), 1,4-diaminobutane (BDA), 1,6-diaminohexane (HDA) 1,8-diaminooctane (ODA), 2-methyl-1,5-diaminopentane (MPDA), 1,6-hexanediisocyanate (HDI), 4,4′-methylenebis (cyclohexylisocyanate) (HMDI), 4,4′-methylenebis (phenylisocyanate) (MDI) are obtained from Aldrich and are used as received. Isobutylene (Lanxess), methylene chloride (Lanxess), methanol and ethanol (EMD Chemicals Inc), HNO₃ (J. T. Baker) are used as received. Hexanes and THF (EMD Chemicals Inc) are distilled over CaH₂ prior to use.

The structures below summarize the structures, names and abbreviations of the materials used in the syntheses of the intermediates and polyureas of this section.

### Soft Segment:

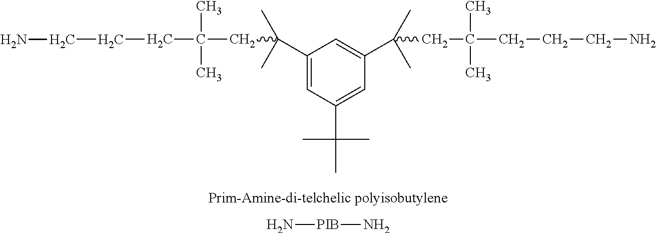

### Diisocyanate:

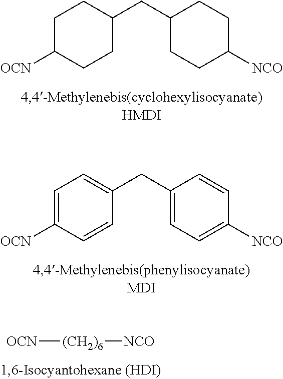

### Chain Extenders:

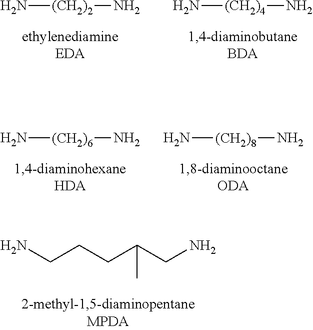

(2) Syntheses of Primary Amine Di-Telechelic PIB (H₂N—PIB—NH₂

The three-step synthesis route shown below illustrates one possible method, within the scope of the present invention, to achieve the synthesis of H₂N—PIB—NH₂. The first step is the living polymerization of isobutylene to a predetermined molecular weight allyl di-telechelic PIB (allyl-PIB-allyl). The second step is the anti-Markovnikov hydrobromination of allyl-PIB-allyl to the primary bromine di-telechelic PIB(Br—PIB—Br). The third step is the conversion of Br—PIB—Br to the target H₂N—PIB—NH₂.

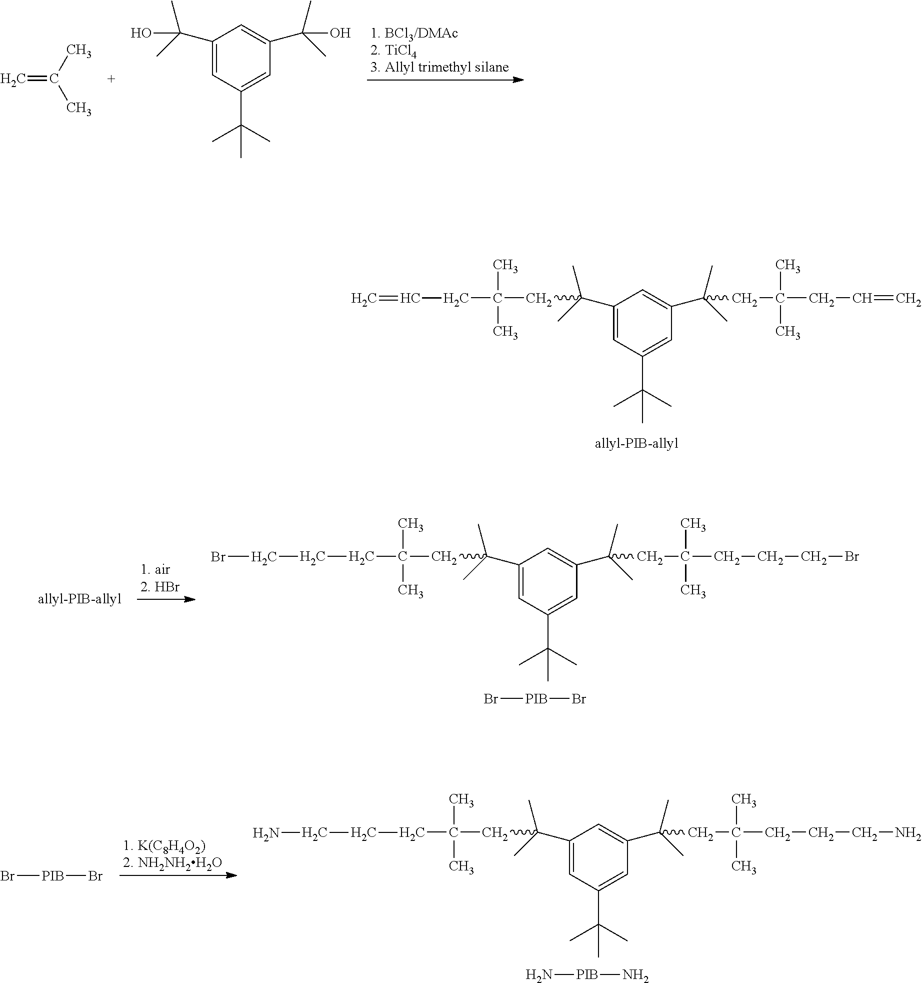

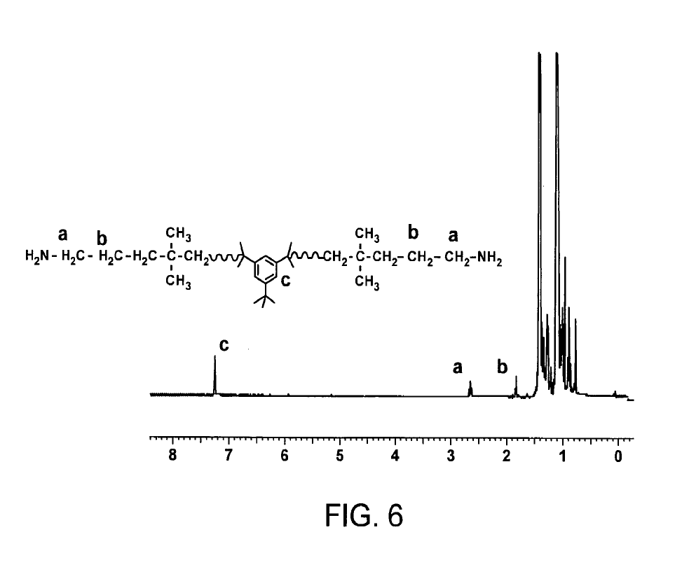

In this section, H₂N—PIB—NH₂ with Mₙ=2,500 and 6,500 grams/mole are prepared. The structure of the products is characterized by proton NMR spectroscopy, and their molecular weight by GPC and titration. FIG. 6 shows a representative ¹H NMR spectrum of H₂N—PIB—NH₂, Mₙ=6,200 grams/mole.

(3) Polymer Syntheses:

(i) Synthesis of Non-Chain-Extended (Stoichiometric) PIB-Based Polyureas:

A representative synthesis of a non-chain extended PIB-based polyurea is as follows: to H₂N—PIB—NH₂ (1.5 grams, Mₙ=5,600 grams/mole, amine equivalent 0.00054 moles) dissolved in 4 mL THF is added dropwise HDI (0.053 grams, isocyanate equivalent 0.00059 moles) dissolved in 1 mL THF under a dry nitrogen atmosphere at room temperature. The mixture is heated for 2 hours at 50° C., poured into the cavity of a Teflon mold (5 cm×5 cm), kept at 50° C. over night, and dried under vacuum (approximately 2 days) until a consistent weight is achieved. The product is a colorless optically clear supple rubbery sheet, soluble in THF.

This one-step procedure is used for the preparation of all non-chain-extended PIB-based polyureas.

(ii) Synthesis of Chain-Extended PIB-Based Polyureas:

A representative one-pot two-step synthesis is as follows. In a 50 mL three-neck round bottom flask equipped with magnetic stirrer are placed, HMDI (0.6 grams, 0.00225 moles) in 2 mL dry THF under a nitrogen atmosphere. The flask is sealed by a rubber septum, cooled to about 5° C., and H₂N—PIB—NH₂ of Mₙ=2,500 (1 gram, 0.0004 moles dissolved in 6 mL THF) is added dropwise by a syringe. This prepolymer charge is stirred at room temperature for 30 minutes, cooled to 5° C., and HDA (0.22 grams, 0.0019 moles) dissolved in 6 mL THF is added dropwise. The charge is stirred at room temperature for an additional 1 hour, poured into a Teflon mold, and kept at 60° C. for a day. A 0.2 mm thick film is obtained and is dried under vacuum for 24 hours at 50° C.

All the charges are homogeneous and optically clear during the syntheses, and all the products are colorless and optically clear.

Regarding the polymer abbreviations used herein: the abbreviation of polymers indicate, in sequence, the H₂N—PIB—NH₂ soft segment, the molecular weight of the soft segment in parentheses, the diisocyanate, the chain extender, and the percent hard segment content. For example, H₂N—PIB—NH₂(6.2 K)/HMDI+HDA=45 indicate a polyurea containing a PIB soft segment of Mₙ=6,200 grams/mole, that is reacted with HMDI as the diisocyanate to yield a prepolymer, which is chain extended with HDA to produce a polyurea with 45 percent hard segment.

(4) Instruments and Procedures:

The Mₙs of H₂N—PIB—NH₂s are routinely determined by proton NMR spectroscopy and acid-base titration. By titration 0.5 grams of H₂N—PIB—NH₂ is dissolved in 10 mL toluene and diluted with 6 mL isopropanol. A drop of methylene blue indicator is added and the solution is titrated with 0.1 M aqueous HCl. Averages of three determinations are used for stoichiometric calculations. Molecular weights obtained by titration and ¹H NMR spectroscopy are within experimental error.

The hardness (Microshore) of approximately 0.5 mm thick films is determined by a Micro-O-Ring Hardness Tester. The averages of three determinations are reported.

Thermogravimetric analysis (TGA) is carried out by a TGA Q 500 instrument (TA Instruments) in the temperature range from 30° C. to 600° C. using an aluminum pan with 5° C./minute heating rate.

Differential scanning calorimetry is affected by the use of a DSC Q 200 (TA Instruments) working under a nitrogen atmosphere. The instrument is calibrated with indium for each set of experiments. Approximately 10 mg samples are placed in aluminum pans sealed by a quick press, and heated at 10° C./minute scanning rate. The glass-transition temperature (T_{g}) is obtained from the second heating scan.

Stress-strain profiles of solution cast films are determined by an Instron Model 5543 tester Universal Testing system controlled by Series Merlin 3.11 software. A bench-top die is used to cut 30 mm dogbone samples (30 mm×3.5 mm×0.2 mm) from the films. The samples are tested to failure at a crosshead speed of 10 mm/minute and their load versus displacement recorded. The averages values of three samples are tested for strength, modulus and elongation at failure.

(5) Hydrolytic/Oxidative Stability:

The hydrolytic/oxidative stability of samples is investigated by exposure to boiling distilled water for 15 days, and to concentrated (36 percent) nitric acid for 12 hours at room temperature.

Thus, virgin samples (solution cast films 5 cm×2 cm×0.02 cm) are placed in refluxing water or stirred concentrated (36 percent) nitric acid at room temperature. Visual observations are made during experiments. After desired times the samples are removed from the liquids, and thoroughly rinsed with water. The water-exposed films are cut to dumbbell shaped specimens and their tensile strengths and elongations are measured while keeping the samples moist with moist tissue paper. Water uptake is determined from the change of weight of samples before and after refluxing with water.

The films exposed to nitric acid are thoroughly rinsed with distilled water, dried, and dumbbells are prepared. The mechanical properties of nitric acid exposed samples are determined with dry sample.

(6) Results and Discussion:

(i) Syntheses:

The reaction processes shown below outline various strategies used for the synthesis of PIB-based non-chain-extended and chain-extended polyureas. After considerable preliminary experimentation conditions are developed for the homogeneous synthesis of optically clear colorless products. Leads are pursued only if the solutions are and remained homogeneous during syntheses, and solution cast films are optically clear.

a. Non-Chain-Extended PIBUs

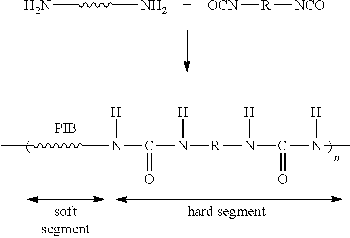

b. Chain-Extended PIBUs

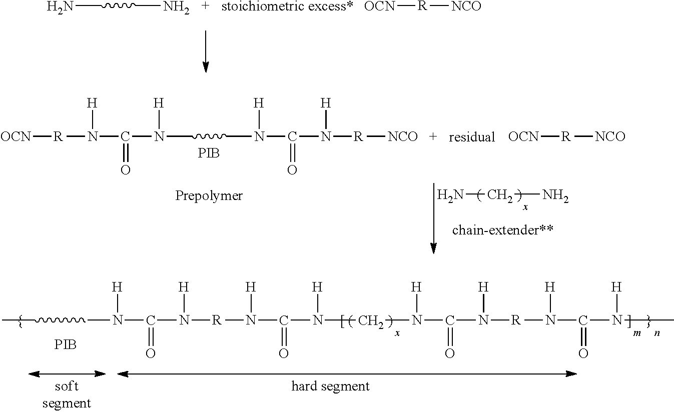

*amount of diisocyanate and chain-extender determines hard segment content, and
** the —(CH₂)ₓ— in the chain extender is varied (see above).

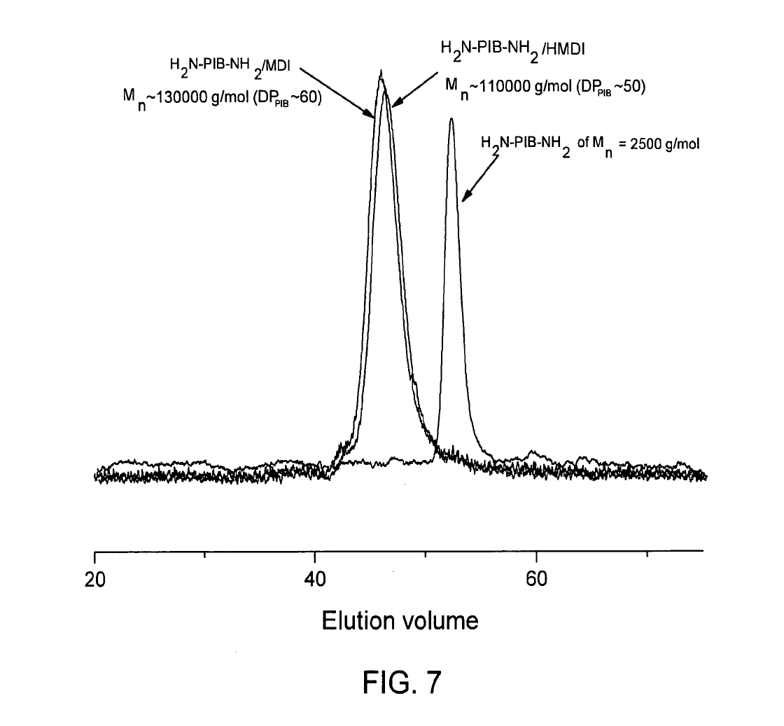

The non-chain-extended products are prepared in one step by mixing stoichiometric amounts of H₂N—PIB—NH₂ and diisocyanates (typically HMDI). Product compositions (hard segment content) are controlled by the molecular weight of the PIB. FIG. 7 shows representative GPS traces of polyureas prepared with H₂N—PIB—NH₂ of Mₙ=2,500 grams/mole plus MDI and HMDI. The products were of high M_{W} and narrow MWD. The large shifts of the sharp traces suggest quantitative reactions between the H₂N—PIB—NH₂ and the diisocyanates.

Chain-extended polyureas are synthesized by the conventional one-pot two-step prepolymer technique, i.e., prepolymer synthesis followed by chain extension. The prepolymers are prepared with H₂N—PIB—NH₂ of Mₙ=2,500 and 5,600 grams/mole, and various diisocyanates, i.e., HDI, MDI and HMDI. The chain extenders are added at about 0° C. to about 5° C. to suppress side reactions (the addition of chain extenders at about 25° C. may produce insoluble particulars).

Table 3 summarizes the various ingredients, relative reagent concentrations, hard segment contents, some mechanical properties, and visual observations made during the syntheses of chain-extended polyureas with up to 45 percent hard segment. Above about 45 percent hard segment the products are judged to be too stiff (micro hardness greater than 70) for applications as soft rubbers, one target for the products of the present invention. In this regard, products with micro hardnesses of greater than 70 are in no way precluded from the scope of the present invention. The data in the table are subdivided by the chain extender employed (EDA, BDA, HDA, ODA, and MPDA), and listed by increasing hard segment content.

Combinations of H₂N—PIB—NH₂ with Mₙ in the 2,500 to 6,200 grams/mole range and HMDI plus the chain extenders HDA, ODA and MPDA produced optically clear homogeneous products even with a hard segment content of up to 45 percent (see entries 6 through 12 in Table 3). In contrast, charges with more than about 18 percent EDA and BDA become opaque due to phase separation.

(ii) Characterization:

Mechanical Properties:

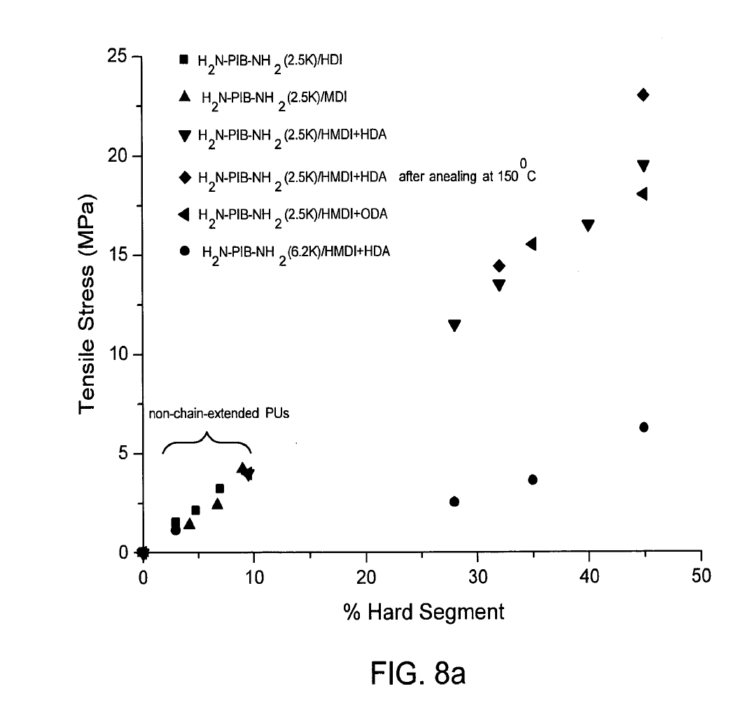

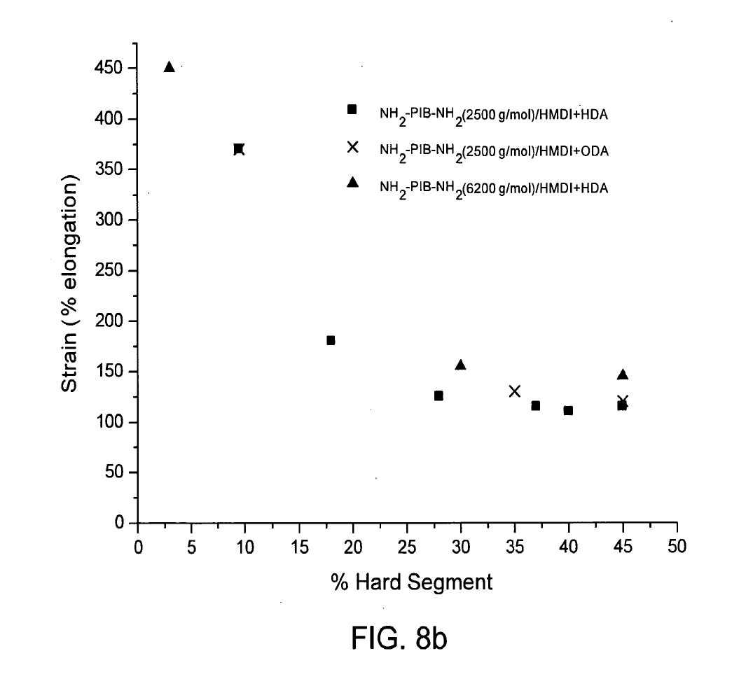

FIGS. 8a and 8b illustrate the variation of stress and strain as a function of hard segment content, respectively, of two families of polyureas synthesized with H₂N—PIB—NH₂ of Mₙ=2,500 and 6,200 grams/mole. Given the data of Table 3, for polyureas synthesized with H₂N—PIB—NH₂ of Mₙ=2,500, tensile strengths increase linearly with hard segment content, and the straight line can be smoothly back extrapolated to the origin. The increase of stress with hard segment content suggests that the hard segments are phase separated and homogeneously distributed in the soft PIB matrix.

At the same hard segment content, the tensile strength of polyureas prepared with H₂N—PIB—NH₂ of 2,500 grams/mole is much higher than those prepared with Mₙ=6,200 grams/mole. The lower strength of polyureas synthesized at the same hard segment content with the higher molecular weight H₂N—PIB—NH₂ (Mₙ=6,200 grams/mole) is probably due to the lower number of hard segments in the rubber than those present in products prepared with the lower molecular weight H₂N—PIB—NH₂ (Mₙ=2,500 grams/mole). Also, the hard segment morphology of polyureas synthesized with H₂N—PIB—NH₂ (Mₙ=6,200) may not be continuous which would lead to inferior mechanical properties.

Elongations of polyureas prepared with HDA and ODA are superior to those prepared with MPDA. For example, at about the same hard segment content (32 percent to 38 percent), elongations obtained with HDA and MPDA are 115 percent and 60 percent, respectively. Evidently the methyl side group in MPDA disrupts the alignment of the hard segments.

Annealing enhances mechanical properties. For example, annealing at 150° C. for 2 hours increases the tensile strength of polyureas containing 32 percent and 45 percent hard segments from 13.4 and 19.5 MPa, respectively, to 14.4 and 23 MPa. (see FIG. 8a, and entries 8 and 11 in Table 3). The increase in strength upon annealing is most likely due to the enhanced alignment of the hard segments.

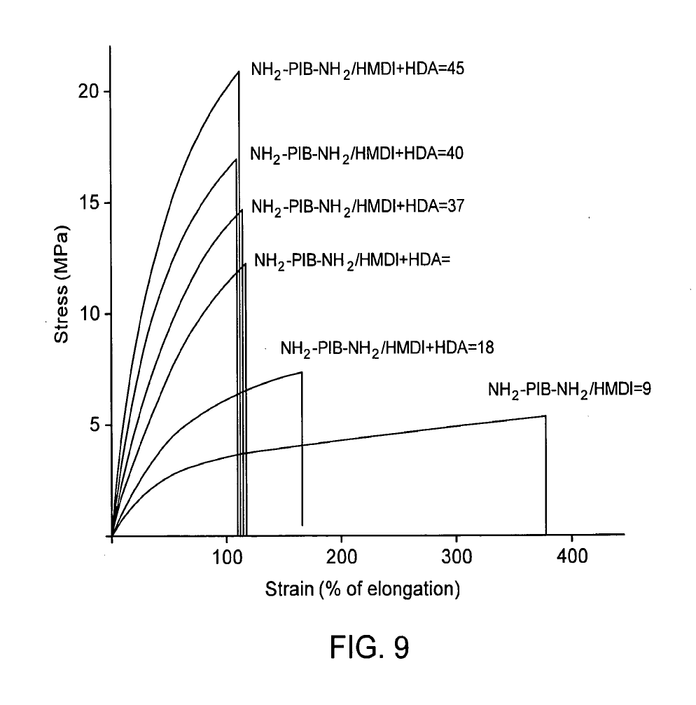

FIG. 9 summarizes stress/strain profiles of a series of H₂N—PIB—NH₂/HMDI+HDA polyureas containing various amounts of hard segments. While the tensile strengths increase linearly with the amount of HDA in the 9 percent to 45 percent range (see FIG. 8a), elongations decrease asymptotically to about 110 percent (see FIG. 8b), at which they level off and do not decrease further. While not wishing to be bound to any one theory, it is hypothesized that the rubbery PIB phase tends to maintain continuity even in the presence of increasing hard segment content.

TABLE 3

| | | H₂N-PIB-NH₂/ | | | | | |
|---|---|---|---|---|---|---|---|
| | | Isocyanate/ | Hard | | | | |
| | Diisocyanate/ | Chain | Segment | | | | |
| H₂N-PIB-NH₂ | Chain | Extender | Content | Stress | Strain | Hardness | |
| (Mₙ) | Extender | Mole Ratio | (Wt. %) | (MPa)* | (%)* | (Microshore) | Visual Observations |
| 2,500 | HMDI/— | 1/1/0 | 9.5 | 4 | 370 | 48 | Colorless, transparent film |
| 2,500 | HMDI/EDA | 1/2/1 | 18 | 8.5 | 120 | 55 | Colorless, transparent film |
| 2,500 | HMDI/EDA | 1/3/2 | 28 | | | | Phase separation during reaction |
| 2,500 | HMDI/BDA | 1/2/1 | 18 | 8 | 140 | 52 | Colorless, transparent film |
| 2,500 | HMDI/BDA | 1/3/2 | 28 | | | | Phase separation during reaction |
| 2,500 | HMDI/HDA | 1/2/1 | 18 | 7.5 | 170 | 60 | Colorless, transparent film |
| 2,500 | HMDI/HDA | 1/3/2 | 28 | 11.5 | 125 | 60 | Colorless, transparent film |
| 2,500 | HMDI/HDA | 1/3.6/2.6 | 32 | 13.5 | 115 | 60 | Colorless, transparent film |
| 2,500 | HMDI/HDA - After | 1/3.6/2.6 | 32 | 14.4 | 108 | 60 | Colorless, transparent film |
| | Annealing at | | | | | | |
| | 150° C. for | | | | | | |
| | 12 hours | | | | | | |
| 2,500 | HMDI/HDA | 1/5.2/4.2 | 40 | 16.5 | 110 | 68 | Colorless, transparent film |
| 2,500 | HMDI/HDA | 1/5.7/4.7 | 45 | 19.5 | 115 | 72 | Colorless, transparent film |
| 2,500 | HMDI/HDA - After | 1/5.7/4.7 | 45 | 23 | 100 | 70 | Colorless, transparent film |
| | Annealing at | | | | | | |
| | 150° C. for | | | | | | |
| | 12 hours | | | | | | |
| 2,500 | HMDI/ODA | 1/3.8/2.8 | 35 | 15.0 | 130 | 60 | Colorless, transparent film |
| 2,500 | HMDI/ODA | 1/5.7/4.7 | 45 | 18 | 120 | 65 | Colorless, transparent film |
| 2,500 | HMDI/MPDA | 1/4.4/3.4 | 38 | 12 | 60 | 70 | Colorless, transparent film |
| 2,500 | HMDI/MPDA | 1/5.2/4.2 | 40 | | | | Brittle film |
| 6,200 | HMDI/HDA | 1/10.3/9.3 | 35 | 3.6 | 1.5 | 45 | Colorless, transparent film |
| 6,200 | HMDI/HDA | 1/11.3/10.3 | 45 | 6.2 | 145 | 51 | Colorless, transparent film |

*Average of three determinations.

### (b) T_{g}

Table 4, below, summarizes the lower glass transition temperatures associated with the PIB domain of polyureas determined by DSC and DMTA. From the data shown below, it can be seen that the T_{g}s obtained by DSC are substantially lower (about 20° C.) than those obtained from tan delta traces.

TABLE 4

| | T_{g} (tan delta) | T_{g} (DSC) |
|---|---|---|
| Polyureas | ° C. | ° C. |
| H₂N-PIB-NH₂(2.5K)/HMDI = 9 | −25 | −45 |
| H₂N-PIB-NH₂(2.5K)/HMDI + HDA = 28 | −15 | — |
| H₂N-PIB-NH₂(2.5K)/HMDI + HDA = 35 | −16 | −42 |
| H₂N-PIB-NH₂(6.2K)/HMDI + HDA = 35 | −25 | — |

### (c) TGA

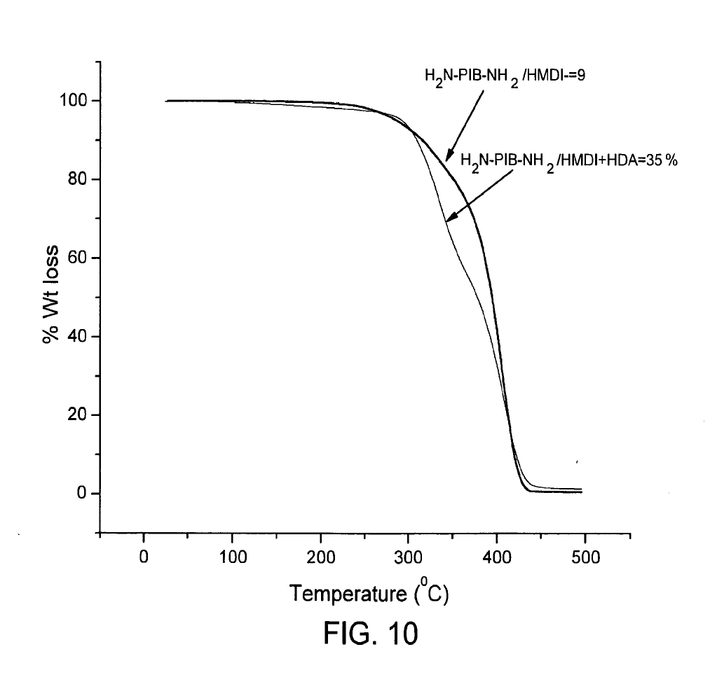

FIG. 10 shows TGA thermograms of representative non-chain-extended and chain-extended PIB-based polyureas. Both polyureas start to degrade at 280° C. The scan of the chain-extended sample suggests a two-step degradation mechanism. In the 320° C. to 425° C. range the thermal stability of the samples decreases with increasing hard segment content; for example, at 380° C.-32 percent of the non-chain-extended polyurea is degraded, whereas 50 percent of the chain-extended sample is degraded.

### (d) DMTA

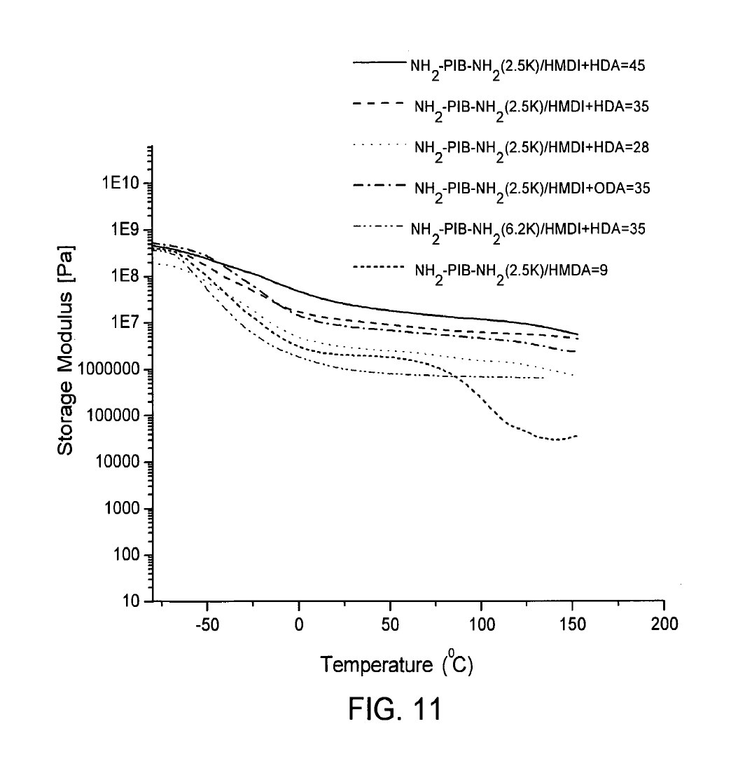

FIG. 11 shows storage moduli (E′) versus temperature traces of various PIB-based polyureas. All the products exhibit typical thermoplastic behavior. All the polyureas are glassy below −40° C. The storage moduli increases somewhat with increasing hard segment content, however, they are unaffected by type of chain-extender. At −50° C. the storage moduli are almost indistinguishable. As the samples are heated and pass through the T_{g}, the E's tend to decrease. The rubbery plateau is in the −30° C. to 150° C. range. In the rubbery plateau the storage moduli of polyureas containing a higher amount of hard segment are higher than those with a lower amount of hard segment.

### (e) Hydrolytic/Oxidative Degradation

The hydrolytic/oxidative vulnerability of conventional polyether- and polyester-based polyurethanes is well documented in the literature and has been discussed by many groups of investigators (see, e.g., R. S. Labow et al.; Biomaterials 1995, 16, 51 through 59). While not wishing to be bound to any one theory, it is generally accepted that hydrolytic damage is due to the presence of carbamate and urethane linkages, and oxidative damage to the —CH₂—O— groups in polyurethane chains.

The present invention seeks to prove that hydrolytically/oxidatively resistant continuous PIB soft segments will shield these vulnerable groups from the penetration of aggressive polar penetrants (water, acids, bases) and thus protect PIB-based polyurethanes from hydrolytic/oxidative attack.

The present invention investigates the hydrolytic/oxidative resistance of PIB-based polyureas under rather harsh testing conditions (exposure to boiling water for 15 days, and to concentrated nitric acid for 12 hours at room temperature—see above) and compared their behavior to those obtained with two commercially available “oxidatively resistant” polyurethanes, Bionate® and Elast-Eon®.

Table 5, below, summarizes these results. Resistance to boiling water is exemplified by the first three lines in Table 5. While two representative PIB-based polyureas showed no visible change and only a negligible deficit in mechanical properties upon exposure, the control, Bionate®, became slightly hazy and suffered a significant decrease in hardness (from 75 to 60) and about a 50 percent loss in tensile strength (from 42 to 20.2 MPa at 500 percent elongation). The water uptake of all the samples is negligible.

The degradation of “hydrolytically resistant” commercial products, Bionate® and Elast-Eon®, upon contact to concentrated nitric acid, is quite spectacular: they became discolored gooey masses within about 30 minutes of exposure. In contrast, representative PIB-based polyureas maintained their dimensional integrity and remained sufficiently strong for mechanical testing. While their hardness and tensile strength decreased and their elongation increased proportionately, they still exhibited respectable properties.

TABLE 5

| | | | | | Hardness | | |
|---|---|---|---|---|---|---|---|
| | Stress (MPa) | | Strain (%) | | (Microshore) | | Visual Observations |
| Polymers | Before | After | Before | After | Before | After | After Exposure |

Submerged in boiling water for 15 days

| | | | | | | | |
|---|---|---|---|---|---|---|---|
| H₂N-PIB-NH₂(2.5K)/HMDI + HDA = 45 | 19.5 | 17.5 | 110 | 115 | 72 | 70 | Optically clear, no color |
| | | | | | | | change |
| H₂N-PIB-NH₂(2.5K)/HMDI + ODA = 45 | 18 | 17.1 | 120 | 125 | 65 | 62 | Optically clear, no color |
| | | | | | | | change |
| Control - Bionate ® | 42 | 20.2 | 500* | 500* | 75 | 60 | Slightly hazy, no color |
| | | | | | | | change |

Stirred with concentrated HNO₃ for 12 hours at room temperature

| | | | | | | | |
|---|---|---|---|---|---|---|---|
| H₂N-PIB-NH₂(6.2K)/HMDI = 4 | 1.6 | 1.1 | 520 | 640 | 48 | 23 | Slightly yellow |
| H₂N-PIB-NH₂(2.5K)/HMDI + HDA = 45 | 19.5 | 3.1 | 110 | 220 | 48 | 23 | Slightly yellow |
| H₂N-PIB-NH₂(2.5K)/HMDI + ODA = 45 | 18 | 2.8 | 120 | 190 | 65 | 32 | Slightly yellow |

Control Bionate ® - completely degraded to a yellow pasty mass, no strength.
Control Elast-Eon ® - completely degraded to a yellow pasty mass, no strength.
*Samples stretched up to 500 percent.

Given the above, it can be concluded that the hydrolytically/oxidatively stable PIB moiety is a barrier to the diffusion of water and acid to the vulnerable hard segments and protects these polyureas from degradation.

### (d) Additional Polyurea Embodiments

### (1) Experimental

### (i) Materials

Amine-telechelic PIB oligomers (H₂N—PIB—NH₂) of Mₙ of 2,500, 3,200 and 6,200 grams/mole are prepared by methods described previously. Aminopropyl-telechelic poly(tetramethylene oxide) (H₂N—PTMO—NH₂) oligomer of Mₙ of 1,100 grams/mole is obtained from Aldrich. Bis(4-isocyanatocyclohexyl)methane (HMDI) of greater than 99.5 percent purity is supplied by BayerTurk, Istanbul and Bayer, USA, and 2-methyl-1,5-diaminopentane (MPDA) is provided by Du Pont. Reagent grade 1,6-hexamethylene diamine (HDA), isopropanol (IPA), dimethylacetamide (DMAc) and cobalt chloride hexahydrate (98 percent) are from Aldrich and used without further purification. Tetrahydrofuran (THF) from Aldrich is distilled prior to use. H₂O₂ (30 percent aqueous solution) is obtained from Acros.

### (ii) Polymer synthesis

Polymerizations are carried out in three-neck round bottom flasks equipped with stirrer, nitrogen inlet, and addition funnel. Polymers are prepared by using a three-step procedure, at room temperature. Calculated amounts of HMDI are weighed into the reactor and dissolved in THF. Desired amounts of H₂N—PIB—NH₂ and H₂N—PTMO—NH₂ oligomers are separately weighed into the Erlenmeyer flasks and dissolved in THF. To prepare the prepolymer PIB solution (first step) and PTMO solution (second step) are sequentially added drop-wise into the reactor containing the HMDI solution, under strong agitation. Before chain extension (third) step, IPA or DMAc is added to increase the polarity of the charge. A stoichiometric amount of diamine chain extender dissolved in IPA or DMAc is added drop-wise into the reactor. The progress of the reactions is monitored by FT-IR spectroscopy following the disappearance of the strong isocyanate peak at 2270 cm⁻¹ and the formation of urea (N—H) and (C═O) carbonyl peaks around 3300 cm⁻¹ and 1700 cm⁻¹, respectively. The charges are homogeneous and clear throughout the polymerization. Table 6 shows the composition, segment molecular weight, and mechanical properties of representative polyureas compositions of polymers prepared and characterized.

TABLE 6

| | | | | | |
|---|---|---|---|---|---|
| | | | | Tensile | |
| Sample | | H₂N-PTMO-NH₂ | Modulus | Strength | Elongation |
| No. | Polymer | (Weight %) | (MPa) | (MPa) | (%) |

1. Stoichiometric (non-extended) PIB-based polyurea

| | | | | | |
|---|---|---|---|---|---|
| 1 | H₂N-PIB-NH₂(2.5K)/HMDI = 9.5 | 0 | 3.50 | 3.30 | 460 |

II. Stoichiometric (non-extended) PTMO-based polyurea

| | | | | | |
|---|---|---|---|---|---|
| 2 | H₂N-PTMO-NH₂(1.1K)/HMDI = 19 | 81 | 6.60 | 27.0 | 950 |

III. PIB-based polyureas with a linear chain extender

| | | | | | |
|---|---|---|---|---|---|
| 3 | H₂N-PIB-NH₂(2K)/HMDI + HDA = 36 | 0 | 60 | 24 | 80 |
| 4 | H₂N-PIB-NH₂(3.2K)/HMDI + HDA = 33 | 0 | 38 | 13.5 | 120 |

IV. PIB-based polyurea with a branched chain extender

| | | | | | |
|---|---|---|---|---|---|
| 5 | H₂N-PIB-NH₂(2.5K)/HMDI + MPDA = 22 | 0 | 15 | 7.6 | 150 |

V. Mixed PIB/PTMO-based polyureas with a linear chain extender

| | | | | | |
|---|---|---|---|---|---|
| 6 | H₂N-PIB-NH₂(2K) + H₂N-PTMO-NH₂ | 12 | 60 | 29 | 200 |
| | 1.1K)/HMDI + HDA = 36 | | | | |
| 7 | H₂N-PIB-NH₂(3.2K) + H₂N-PTMO-NH₂ | 12 | 27 | 16.1 | 290 |
| | (1.1K)/HMDI + HDA = 25 | | | | |
| 8 | H₂N-PIB-NH₂(3.2K) + H₂N-PTMO-NH₂ | 12 | 32 | 20.1 | 310 |
| | (1.1K)/HMDI + HDA = 36 | | | | |
| 9 | H₂N-PIB-NH₂(3.2K) + H₂N-PTMO-NH₂ | 12 | 40 | 24.0 | — |
| | (1.1K)/HMDI + HDA = 45 | | | | |
| 10 | H₂N-PIB-NH₂(6.2K) + H₂N-PTMO-NH₂ | 12 | — | 7.1 | 180 |
| | (1.1K)/HMDI + HDA = 25 | | | | |
| 11 | H₂N-PIB-NH₂(6.2K) + H₂N-PTMO-NH₂ | 12 | — | 8.5 | 160 |
| | (1.1K)/HMDI + HDA = 35 | | | | |

A typical synthesis of a mixed PIB/PTMO based polyurea is as follows. Into a 50 mL three-neck round bottom flask equipped with magnetic stirrer is placed 0.44 grams (0.00167 mmol) HMDI and dissolved in 1 mL dry THF. The flask is sealed by a rubber septum and kept under a nitrogen atmosphere. H₂N—PIB—NH₂ (0.8 grams, 0.0004 mmol, Mₙ=2,000 grams/mole) is dissolved in 4 mL THF in a separate beaker and added dropwise to the HMDI solution by a syringe, and the pre-polymer solution is stirred at room temperature for 10 minutes. H₂N—PTMO—NH₂ (0.2 g, 0.000181 mol, Mₙ=1,100 grams/mole) is dissolved in 1 ml THF and added to the HMDI solution by a syringe. The charge is diluted with 2 mL DMAc and stirred for 10 minutes. The chain extender is HDA (0.13 grams, 0.0011 moles) which is dissolved in 3 mL THF and added dropwise into the reactor by a syringe over 10 minutes. The mixture is stirred at room temperature for an additional 15 minutes, poured into a Teflon mold and dried at 60° C. for a day. The approximately 0.2 mm thick film thus obtained is dried further under vacuum for 24 hours at 50° C.

Mixed soft segments containing both PIB and PTMO chains are symbolized by first showing the abbreviation of the PIB segment (and its M_{w}×1000 in parentheses) followed by a “+” sign and the abbreviations of the PTMO segment (and its M_{w}×1000 in parentheses). The abbreviation of the soft segment(s) is followed by a “/” sign which separates the soft segment from the hard segment. After the soft segments, we show the abbreviation of the diisocyanate and the chain extender, separated by a “+” sign. Finally the hard segment content of the product is given in percent. For example H₂N—PIB—NH₂(2.5K)+H₂N—PTMO—NH₂(1.1K)/HMDI+MPDA=26 stands for a polyurea prepared with a NH₂—PIB—NH₂ of Mₙ=2,500 grams/mole and a H₂N—PTMO—NH₂ of Mₙ=1,100 grams/mole, and HMDI as the diisocyanate and MPDA as the chain extender; the hard segment content is 26 percent.

### (2) Characterization Methods

Number average molecular weights (Mₙ) of H₂N—PIB—NH₂ and H₂N—PTMO—NH₂ are determined by end-group titration assuming 2.0 end-group functionality. FTIR spectra are recorded on a Nicolet Impact 400D spectrophotometer with a resolution of 2 cm⁻¹, using thin films cast on KBr disks.

Copolymer films (0.2 to 0.5 mm thick) for thermal and mechanical tests are prepared by solution casting in Teflon molds, removing the solvent at room temperature overnight and drying at 65° C., or drying at 50° C. and subsequently in a vacuum oven at 75° C., until constant weight. Polymers films are stored at ambient temperature in sealed polyethylene bags.

Dynamic mechanical thermal analysis (DMTA) is performed by a TA DMA Q800 instrument. Measurements are made in tensile mode at 1 Hz, between −120° C. and 200° C., under a nitrogen atmosphere, at a heating rate of 3° C./minute. Hardness (Microshore) of the 0.5 mm thick films is determined by a Micro-O-Ring Hardness Tester—averages of three determinations are reported.

Stress-strain profiles of polyureas are determined by an Instron Model 5543 Universal Tester controlled by Series Merlin 3.11 software. A bench-top die (ASTM 1708) is used to cut 30 mm dog-bone samples (30 mm×3.5 mm×0.2 mm) from films. Stress-strain traces of polyureas containing H₂N—PIB—NH₂ of Mₙ=3,500 grams/mole are obtained by a 4411 Universal Tester. The samples are tested to failure at a crosshead speed of 10 mm/min at room temperature and their load versus displacement behavior is recorded. Average values of at least three samples are used to determine tensile strength, modulus and elongation at failure.

The accelerated hydrolytic/oxidative degradation of samples (solution cast 5 cm×2 cm×0.02 cm films) is investigated by exposure to 100 mL of 0.1 M aqueous CoCl₂ solution containing 20 percent hydrogen peroxide for 40 days at 50° C. The solution is changed twice a week to maintain a relatively constant concentration of radicals. After 40 days the samples are removed from the solutions, thoroughly rinsed with distilled water, and dried in a vacuum oven for 24 hours. Dried samples are used for the determination of mechanical properties.

Scanning electron microscopy (SEM) analysis is performed on samples exposed to CoCl₂/H₂O₂ solution with a JEOL JSM-7401 F instrument at 10 kV with up to 5000 magnification. Oxidized samples are thoroughly rinsed with distilled water and dried in a vacuum oven. Five images of different regions are taken of each specimen.

### (3) Results and Discussion

An early article in this series dealt with the cost effective synthesis of H₂N—PIB—NH₂ and its use for the synthesis of novel PIB-based polyureas exhibiting spectacular oxidative/hydrolytic stability. While phase separation between the soft PIB and hard polyurea sequences is excellent, the mechanical properties of these rubbers are mediocre (about 20 MPa tensile and about 100 percent elongation). One of the objectives of the present invention is to synthesize polyureas with enhanced mechanical properties.

According to rubber reinforcement theory, reinforcement requires chemically linked interfaces or excellent adhesion between interfaces (as, for example, in carbon black reinforced natural rubber or silica reinforced silicone rubber). In the absence of strong interaction between the rubbery matrix and well-dispersed reinforcing particles reinforcement is poor or nonexistent, and the mechanical properties of rubbers suffer.

The present invention shows the mechanical properties of PIB-based polyureas are improved by incorporating PTMO into the networks, which leads to hydrogen bridge formation and improve stress transfer by enhancing the compatibility between the non-polar PIB and polar urea phases. The solubility parameters of PIB and PTMO (16.3 and 18.6 MPa^{1/2} respectively) are reasonably close to each other promising a measure of compatibility between these segments.

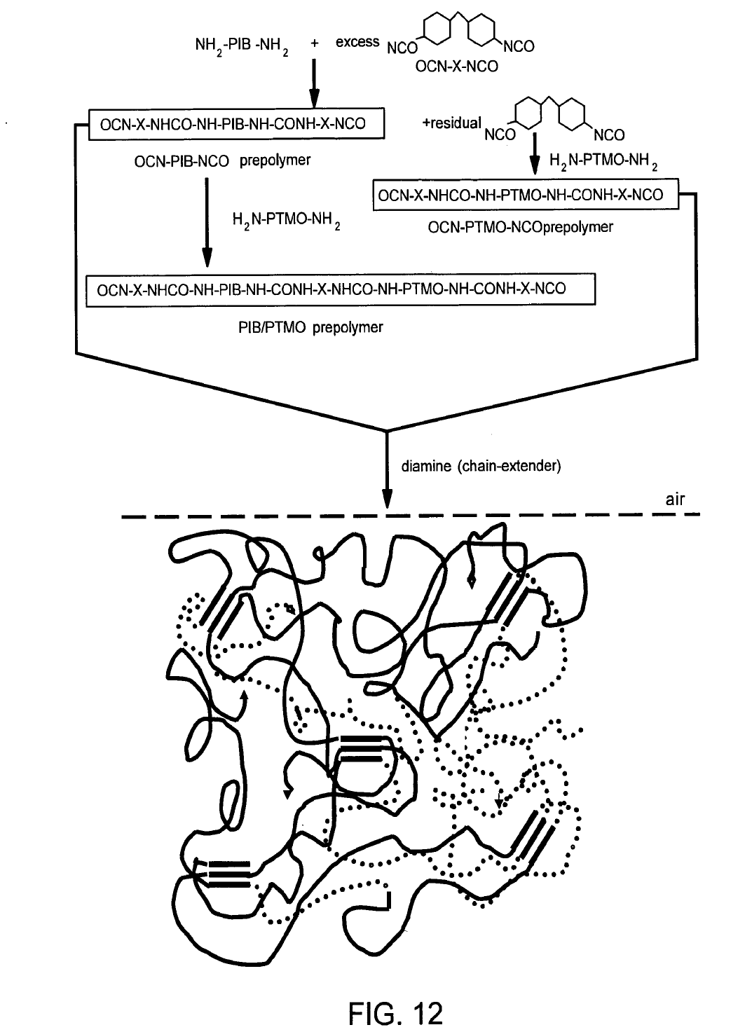

FIG. 12 visualizes the molecular architecture of the target polyurea comprising PIB and PTMO soft segments. Having modified PIB-based polyureas with PTMO the present invention sets out to determine the minimum amount of PTMO to be incorporated to increase the mechanical properties without reducing the outstanding oxidative/hydrolytic resistance of these rubbers.

In FIG. 12, the symbols in this Figure are as follows—PIB [symbol] ; PTMO [symbol] ; hard segment [symbol] ; short hard segment connecting two soft segments [symbol] ; and continuing soft segment [symbol] .

The sections that follow summarize experimental verification of the present invention and demonstrate the preparation of novel polyureas with excellent mechanical properties and oxidative/hydrolytic stability.

### (4) Polyureas Prepared

Table 6 summarizes polyureas prepared, their overall compositions, and select mechanical properties. Subtitles I through V subdivide the numerous examples into coherent groups. Groups I and II contain non-chain extended PIB- and PTMO- based polyureas, respectively; groups III and IV contain chain extended PIB-based polyureas with linear (HDA) and branched (MPDA) chain extenders, respectively; group V contains mixed soft segment PIB/PTMO-based polyureas with a linear (HDA) chain extender. In one embodiment the sample contains between 21 percent and 36 percent hard segments. In another embodiment the sample contains between 21 percent and 32 percent hard segments.

### (i) Stress-Strain Behavior

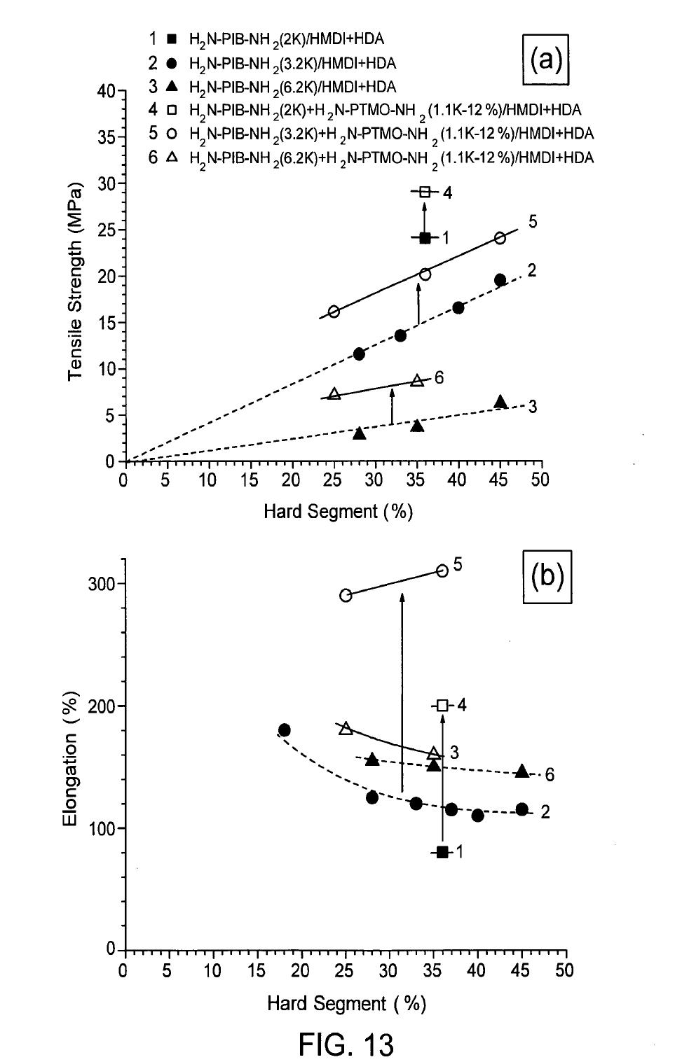

Some of the data in Table 6 is visualized in FIG. 13, i.e., the tensile strengths and elongations as a function of hard segment content of select polyureas synthesized by using 2,000 grams/mole, 3,200 grams/mole and 6,200 grams/mole M_{w} PIB segments in the absence and presence of 12 percent PTMO and the linear diisocyanate HDA (for completeness, data obtained earlier are also included). The tensile strengths and elongations of mixed PIB/PTMO-based polyureas are consistently and significantly higher than those obtained without PTMO (see up arrows). Further, the tensile strength increases with increasing hard segment content and decreasing PIB molecular weight (M_{w}). As discussed above, the tensile strength increases in a nearly linear manner with hard segment content at a given PIB molecular weight. The effect of 12 percent PTMO seems to increase the tensile strength by 5 to 6 MPa irrespective of the PIB molecular weight.

As expected, the Young's moduli of PTMO modified PIB-polyureas increases with increasing PTMO content. While not wishing to be bound to any one theory, these results are in line with the hypothesis that PTMO incorporation improves interfacial adhesion between the PIB and urea phases leading to improved stress transfer between phases which in turn leads to improved tensile strengths without much sacrifice in elongation.

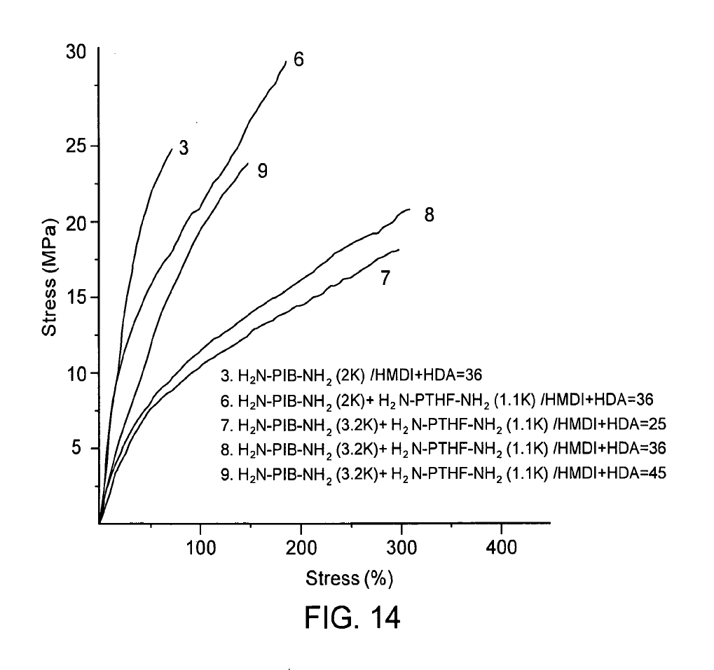

FIG. 14 shows stress-strain traces of select polyureas. Comparison of traces sample numbers 3 and 6 (sample abbreviations in Table 6) clearly indicate the significant improvement in both tensile strengths and elongations due to the incorporation of 12 percent PTMO in the soft segment of a PIB-based polyurea. The addition of PTMO does not seem to affect the initial very high Young modulus (60 MPa) of the polymers. These results support our hypothesis that PTMO incorporation improves interfacial adhesion between the PIB and urea phases, leading to better stress transfer between the hard and soft segments.

### (ii) Hydrolytic/Oxidative Stability

The hydrolytic/oxidative stability of PIB-based polyureas has been documented by exposure to concentrated nitric acid and boiling water. These studies are now extended by exposing representative polyureas samples to aqueous CoCl₂/H₂O₂. The strong oxidizing/hydrolitic action of this reagent and the mechanism of oxidation were extensively discussed by earlier workers.

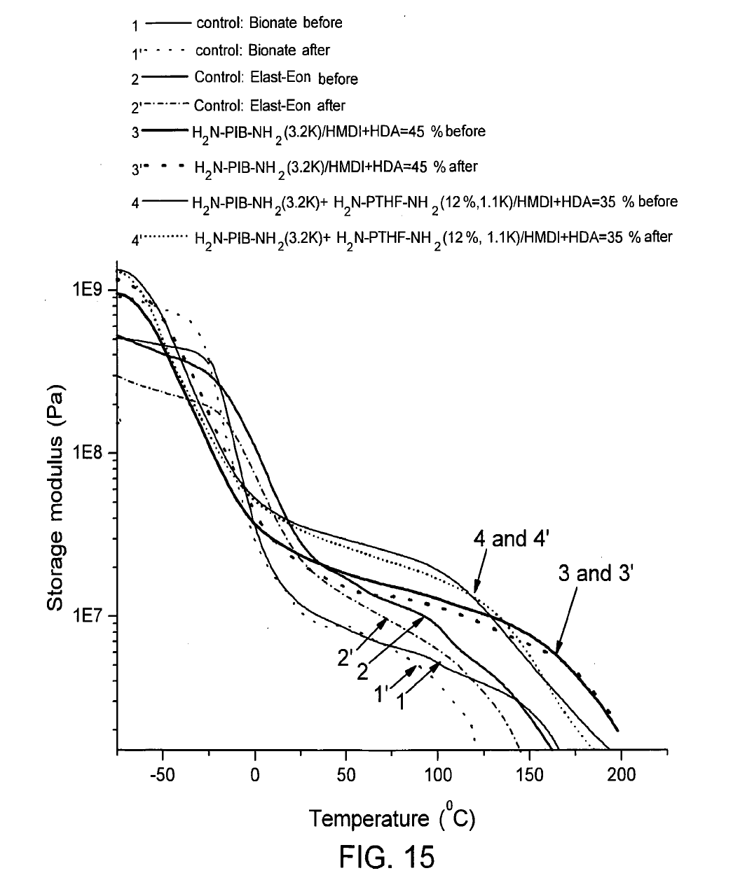

Table 7 together with FIG. 15 summarizes the oxidative/hydrolytic stability experiments and results. Thus, a representative PIB-based polyurea (H₂N—PIB—NH₂(2.5)/HMDI+HDA=45) and one containing PIB plus 12 percent PTMO segments (H₂N—PIB—NH₂(3.2)/PTHF/HMDI+HDA=36) are submerged in aqueous CoCl₂/H₂O₂ for 40 days at 50° C. and the consequences of this treatment are analyzed by various techniques. The positive controls are commercially available Bionate® and Elast-Eon®, i.e., a polycarbonate- and a polydimethylsiloxane-based polyurethane, respectively, marketed for their superior oxidative stability.

TABLE 7

| | Stress (MPa) | | | Strain (%) | | | Hardness (Microshore) | | | |
|---|---|---|---|---|---|---|---|---|---|---|
| | | | Deficit | | | Deficit | | | Deficit | Visual Observations |
| Polymers | Before | After | (%) | Before | After | (%) | Before | After | (%) | After Exposure |

Submerged in CoCl₂/H₂O₂ for 40 days at 50° C.

| | | | | | | | | | | |
|---|---|---|---|---|---|---|---|---|---|---|
| H₂N-PIB-NH₂(2.5K)/HMDI + HDA = 45 | 19.5 | 18.6 | 4.6 | 110 | 100 | 9 | 72 | 70 | 3 | Slightly yellow |
| H₂N-PIB-NH₂(3.2K)/+12 percent | 20 | 17.1 | 15 | 320 | 225 | 29 | 70 | 68 | 3 | Slightly yellow |
| H₂N-PTMO-NH₂ (1.1K)/HMDI + HDA = 36 | | | | | | | | | | |
| Control: Bionate ® | 42 | 28 | 34 | >500* | 480 | Large | 75 | 50 | 33 | Yellow |

*Samples stretched to 500 percent.

Table 7 shows visual observation and mechanical properties of samples before and after exposure to CoCl₂/H₂O₂. While the faintly yellow experimental polyureas darkened only slightly, Bionate became noticeably yellow. The “deficit” columns indicate deterioration in properties due to oxidative/hydrolytic damage. While the properties of the experimental samples diminish only slightly or moderately, Bionate suffers significant oxidative damage.

FIG. 15 summarizes the effect of CoCl₂/H₂O₂ exposure on storage modulus versus temperature (DMTA) traces of experimental polyureas and the controls Bionate® and Elast-Eon®. While the changes in storage moduli upon oxidation of polyureas containing PIB remain experimental variation (compare traces 3 and 3′, and 4 and 4′), those of Bionate® and Elast-Eon® suggest considerable damage (compare traces 1 and 1′, and 2 and 2′). The deficit of Bionate® is particularly prominent above about 75° C. with Elast-Eon® behaving somewhat better.

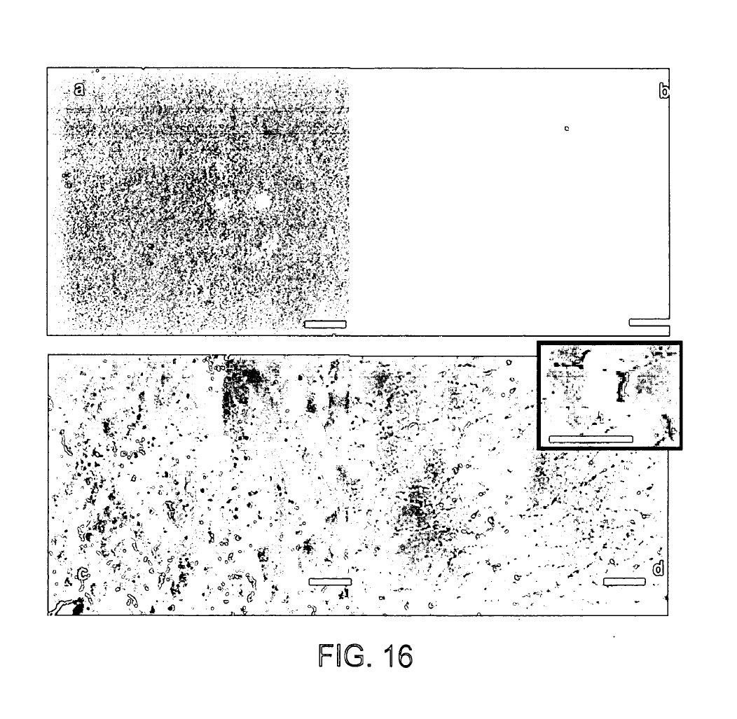

In FIG. 16, (a) is an SEM image of H₂N—PIB—NH₂(2.5K)/HMDI+HDA=45; (b) an SEM image of H₂N—PIB—NH₂(3.2K) +12% H₂N—PTMO—NH₂(1.1K)/HMDI+HDA=36; (c) an SEM image of Elast-Eon®; and (d) an SEM image of Bionate®. The scale bar is equal to 25 μm.

The superior oxidative/hydrolytic resistance of PIB containing polyurethanes is also apparent by surface electron microscopy (SEM). FIG. 16 shows SEM images of surfaces of a PIB-based polyurea (H₂N—PIB—NH₂(2.5)/HMDI+HDA=45), a mixed PIB/PTMO polyurea (H₂N—PIB—NH₂(3.2)/PTHF/HMDI+HDA=36), and the positive controls Bionate® and Elast-Eon® after exposure to CoCl₂/H₂O₂ for 40 days at 50° C. The surface of the PIB-based polyurea is unremarkable and shows no evidence of damage (FIG. 16a). The surface of the mixed PIB/PTMO polyurea shows slight pitting (craters, cavities see FIG. 16b). In contrast, the surface of Elast-Eon® is severely rippled and pitted but cracks are absent (FIG. 16c). Bionate®, however, shows severe cracking all over its surface indicating significant oxidative/hydrolytic damage (FIG. 16d). Evidently, the oxidative/hydrolytic stability of Elast-Eon® is superior to Bionate®.

The superior oxidative/hydrolytic resistance of PIB containing polyureas is due to the protective action of oxidatively inert PIB segments congregating on the surfaces of these materials.

### (iii) Conclusions

This invention focused on the design, synthesis, characterization and structure/morphology of novel polyureas comprising continuous soft phases of two partially compatible soft segments: PIB and PTMO, embedded into finely dispersed polyurea hard/crystalline phases. The addition of even a modest amount (12% by weight) of PTMO to PIB-based polyureas significantly enhances the mechanical properties with minimum reduction in oxidative/hydrolytic stability. The present invention shows that the PTMO segments strengthen/toughen the polyureas by leading to the formation of hydrogen bridges and by facilitating stress transfer from the soft to hard phases. The surfaces of these polyureas are covered/protected with chemically inert PIB segments which impart oxidative/hydrolytic stability. Polyureas containing mixed PIB/PTMO soft segments exhibit good mechanical properties (e.g., 29 MPa and 200% elongation) and oxidative/hydrolytic stabilities far superior to Bionate® and Elast-Eon®.

FIG. 12 outlines a possible synthesis strategy, according to one embodiment of the present invention, for the preparation of polyureas containing mixed PIB/PTMO soft segments and shows the molecular structure/morphology of an idealized network. The sketch reflects major findings of characterization research: It indicates the preferential presence of PIB segments at the air interface; it emphasizes the preferential location of PTMO segments nearer to the hard segments; it reflects the stoichiometric (mole) and weight ratio of the starting materials (see legend); and it helps to visualize the random arrangement and connections between the hard/soft and soft/soft segments.

In another embodiment, the present invention relates to a polymer compound comprising urea or urethane segments therein, the polymer compound comprising: (i) one hard segment, wherein the hard segment is selected from a urea or urethane hard segment; and (ii) two soft segments. In one instance, the polymer compound of this embodiment have two soft segments that are formed from polyisobutylene and poly(tetramethylene oxide).

(VI) Polyurethanes Containing Mixed PIB/PTMO Soft Segments and Partially-Crystalline Hard Segments:

In this example the synthesis, characterization, and structure-property relationship of polyurethanes containing mixed polyisobutylene (PIB)/poly(tetramethylene oxide) (PTMO) soft segments and partially-crystalline bis(4-isocyanatocyclohexyl)methane HMDI/hexanediol (HD) hard segments is discussed. The mechanical (stress/strain, hardness, and hysteresis) properties of these novel polyurethanes are investigated over a broad composition range. The addition of, for example, 20% by weight PTMO to PIB-based polyurethanes increases both their tensile strength and elongation. Because of the large amount of PIB in the soft segments, these segmented copolymers possess oxidative/hydrolytic/enzymatic stabilities superior to commercially available polyurethanes. These new polyurethanes are softer and exhibit hysteresis superior to conventional polyurethanes. According to initial thermal studies, these materials show good processibility. Overall, the mechanical properties of the hybrid polyurethanes are similar or superior to Bionate® and Elast-Eon®, respectively. While not wishing to be bound to any one theory, the results of this example suggest that the addition of PTMO segments to PIB-based polyurethanes facilitates uniform stress distribution within the hard segment, which strengthens and thus improves the elastomeric properties of PIB-based polyurethanes.

As discussed above, in one embodiment various novel PIB-based polyureas exhibiting unprecedented hydrolytic/oxidative stability together with desirable mechanical properties. Further, the above discussion also illustrates that the mechanical properties of these polyureas can be enhanced by the use of mixed PIB/PTMO soft segments.

In this example, a continued examination of the structure/property relationship of these hybrid polyurethanes is conducted. Additionally, this example also illustrates that by altering the nature and composition of the soft and hard segments, one is able to synthesize and/or assemble PIB-based segmented copolymers having outstanding mechanical properties (tensile strength greater than about 30 MPa and an elongation of about 700%), as well as possessing a hydrolytic/oxidative resistance far superior to the best commercially available polyurethanes.

### (a) Experimental

### (1) Materials

The preparation of hydroxyl-telechelic polyisobutylenes (HO—PIB—OH) having an Mₙ equal to 1,500; 4,050 and 11,500 g/mol are prepared as described above. Hydroxyl-telechelic poly(tetramethylene oxide) (HO—PTMO—OH) having a Mₙ=1,100 and 650 g/mol is obtained from Aldrich. Bis(4-isocyanatocyclohexyl)methane (HMDI), dibutyltin-dilaurate (DBTL), 1,6-hexanediol (HD) are obtained from Aldrich and are used without further purification. Tetrahydrofuran (THF) is obtained from Aldrich and is distilled prior to use. Additionally, it should be noted that the present invention is not limited to just the use of hydroxyl-telechelic poly(tetramethylene oxide) (HO—PTMO—OH) having a Mₙ=1,100. Instead any suitable hydroxyl-telechelic poly(tetramethylene oxide) having an Mₙ in the range of about 250 to about 25,000, or from about 500 to about 20,000, or from about 1,000 to about 15,000, or from about 1,500 to about 10,000, or from about 2,000 to about 7,500, or even from about 2,500 to about 5,000. Here, as well as elsewhere in the specification and claims, individual range limits can be combined to form alternative non-disclosed ranges and/or range limits.

### (2) Preparation of Polyurethanes

Polymerizations are carried out in three-neck round bottom flasks equipped with a stirrer, and nitrogen inlet. The desired amounts of HO—PIB—OH (and/or HO—PTMO—OH) and HMDI are weighed into the reactor, dissolved in THF, stirred and heated. After the addition of 0.5% dibutyltin dilaurate (DBTDL) the mixture is heated at 65° C. for 3 hours to obtain a prepolymer. A stoichiometric amount of 1,6-hexanediol (HD) is added to the prepolymer solution and heating is continued for an additional 12 hours at 65° C. Progress (and completion) of reactions are monitored by IR spectroscopy as is known to those of skill in the art. The highly viscous solution is diluted with THF and poured into a glass mold. Films are formed by drying the cast solution for 1 day at 70° C. in an air oven and the placing such samples into sealed polyethylene bags for two days at room temperature before measurements.

### (3) Characterization

The number average molecular weights (Mₙ) of HO—PIB—OH is determined by ¹H NMR spectroscopy using a Varian Unity Plus 400-MHz spectrometer with the use of CDCl₃ as a solvent. FTIR spectra are recorded on a Nicolet Impact 400D spectrophotometer with of 2 cm⁻¹ resolution, using thin films cast on KBr disks or by using a Shimadzu FTIR 8300 instrument equipped with an ATR head.

Thermal and mechanical tests are carried out on solution cast polymer films (0.2 to 0.5 mm thick). The solvent is removed at room temperature overnight at 65° C. and dried at 50° C. in a vacuum oven, until constant weight.

Differential scanning calorimetry (DSC) is performed with a DuPont 2100 thermal analyzer equipped with a liquid-nitrogen cooling accessory. Measurements are made under a nitrogen atmosphere with 10° C./min heating and cooling. The hardness (Microshore) of approximately 0.5 mm thick films is determined by a Micro-O-Ring Hardness Tester. Averages of three determinations are reported.

Stress-strain behavior is determined by an Instron Model 5543 Universal Tester controlled by Series Merlin 3.11 software. A bench-top die (ASTM 1708) is used to cut 30 mm dog-bone samples (30×3.5×0.2) from films. The samples (Lₒ=24.0 mm) are tested to failure at a crosshead speed of 20 mm/min at room temperature. Averages of at least 2 measurements are reported.

Regarding the abbreviations of product compositions used throughout the specification, the abbreviations specify the nature of the two soft segments, their molecular weights, and percentages; this is followed by a “/” sign and then the make-up and percentages of the hard segment or segments.

### a) Results and Discussion

### (i) Mechanical Properties

### Stress/Strain Studies

This example is directed to the synthesis and mechanical property characterization of novel polyurethanes containing PIB segments in combination with PTMO soft segments, and partially crystalline HMDI/HD hard segments.

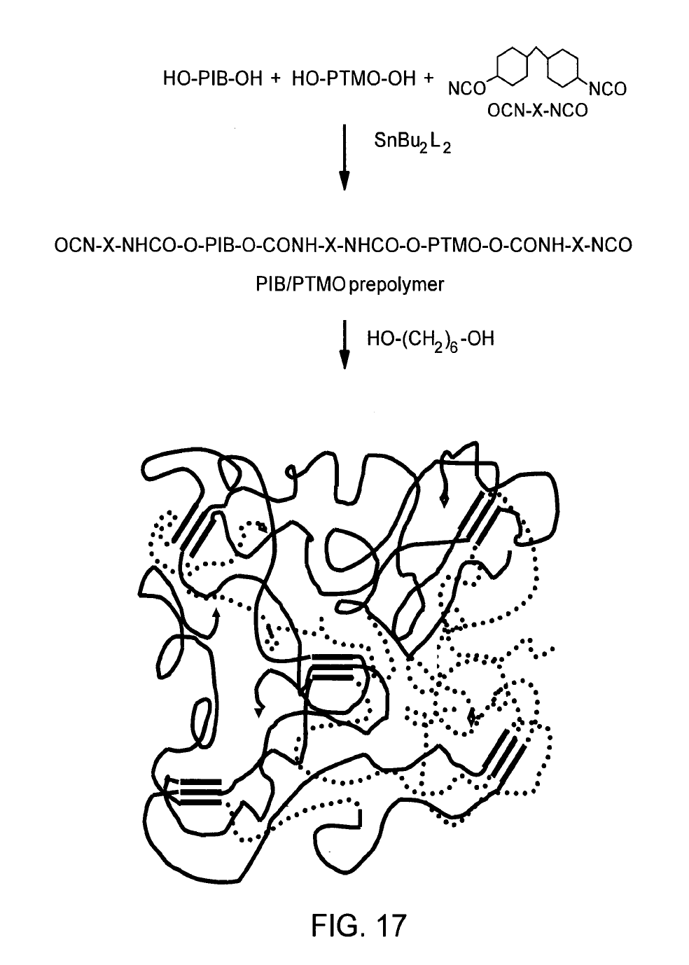

FIG. 17 outlines an exemplary synthesis scheme together with an idealized phase-separated microstructure of a mixed soft segment polyurethane. The first step of the synthesis involves the preparation of the PIB/PTMO prepolymer by reacting the soft segment(s) and the HMDI in the presence of the DBTL catalyst in a common solvent such as tetrahydrofuran. The use of this solvent is necessary with this synthesis method since the PIB, the PTMO and the HMDI are incompatible during the initial phase of the reaction. In the second step, the polymerization is completed by the addition of the HD chain extender. The THF solution of the polymer is solution cast to form films for the various characterizations.

FIG. 17 is an exemplary synthesis route of a PIB/PTMO-based polyurethane. In FIG. 17, the PIB segments are represented by [symbol] ; the PTMO segments by [symbol] ; the hard segment by [symbol] ; a short hard segment connecting two soft segments is represented by [symbol] ; and a continuing soft segment is represented by [symbol] .

To gain insight into the effect of the individual components on mechanical properties, the nature and amount of the constituents are varied systematically and stress/strain, and hardness are determined and analyzed.

Table 8 shows the compositions of various exemplary polyurethanes that are prepared together with characterization results. The polyurethanes are prepared with PIBs of having Mₙs equal to 1,500; 4,050; and 11,500 g/mol in both the absence and presence of PTMO. The two lower molecular weight PIBs (Mₙs equal to 1,500 and 4,050 g/mol) are similar to the molecular weights used in conventional polyurethanes, whereas the 11,000 g/mol PIB is used because the entanglement molecular weight of PIB is close to this value, thus one should expected improved elongations and hysteresis with this PIB.

The amount of PTMO is varied in the 10% by weight to 30% by weight range and that of the hard segment in the 15% by weight to 50% by weight range. PIBs of Mₙ=4,050 and 11,500 g/mol are mixed with PTMO having an Mₙ equal to 1,000 g/mol; however, with the 1,500 g/mol PIB a PTMO having an Mₙ equal to 650 g/mol is used so as to match the end-to-end distance of the mixed PIB/PTMO soft segments. The lengths of the soft segments PIB and PTMO are very similar in the PIB(4k)/PTMO(1k) and PIB(1.5k)/PTMO(0.6k) products. While not wishing to be bound to any one theory, it is believed that if the end-to-end distances of the soft segments are widely different, the stress distribution may become non-uniform, which in turn could lead to mediocre properties. For comparison purposes polyurethanes with only PTMO are prepared (i.e., in the absence of PIB).

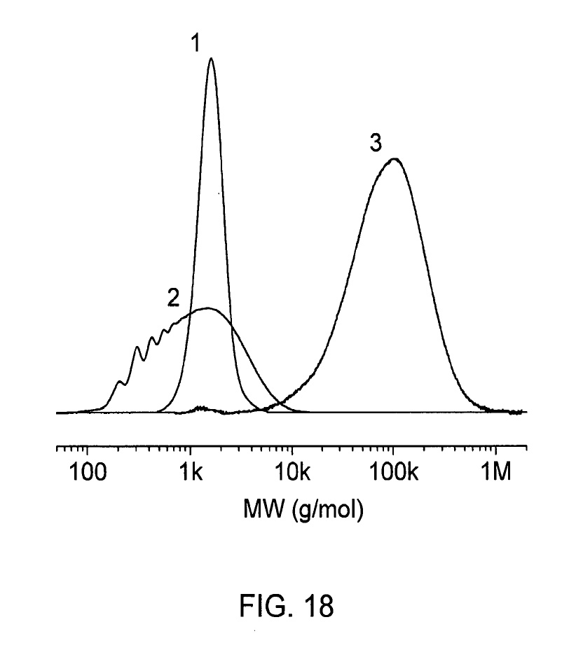

FIG. 18 is a graph showing representative GPC traces of the soft segment HO—PIB—OH (Mₙ=1,500 g/mol, marked “1”); HO—PTMO—OH (Mₙ=650 g/mol, marked “2”); and the polyurethane HO—PIB—OH(1.5K-40%)+HO—PTMO—OH(0.6k-20%)/HMDI+HD=40% (marked “3”) (THF eluent, PSt calibration).

The M_{w}s of unannealed samples are determined by GPC. FIG. 18 shows GPC traces of a mixed soft segment polyurethane (HO—PIB—OH(1.5K-40%)+HO—PTMO—OH(0.6k-20%)/HMDI+HD=40%) together with the starting materials of the soft segment, HO—PIB—OH and HO—PTMO—OH. The large shift toward higher M_{w}s indicates high conversion upon extension. The absence of low M_{w} starting moieties means that the OH- functionalities of both the HO—PIB—OH and HO—PTMO—OH starting materials are essentially theoretical (i.e., 2.0). The degree of polymerization (i.e., the number of soft segments per chain) of this polyurethane is 32. Since the calculation of Mₙ is based on linear PSt standards, and THF is used for the GPC measurement is not a good solvent for the hard segment, the molecular weights of these polymers are expected to be somewhat higher than reported.

According to the data in Table 8 the M_{w}s of the polyurethanes are in the 40,000 to 120,000 g/mol range, which corresponds to a DP of 15 to 75 for the soft segments. Annealing for one day at 70° C. considerably increases the M_{w} of polyurethanes prepared with PTMO (not shown) and appears to be partially crosslinked, probably because of the formation of allophanates (most of the samples are prepared with a slight excess (about 2 to about 5%) of diisocyanate). Interestingly, this behavior is absent, or is less prominent, with polyurethanes that are prepared only with HO—PIB—OH (i.e., in the absence of HO—PTMO—OH).

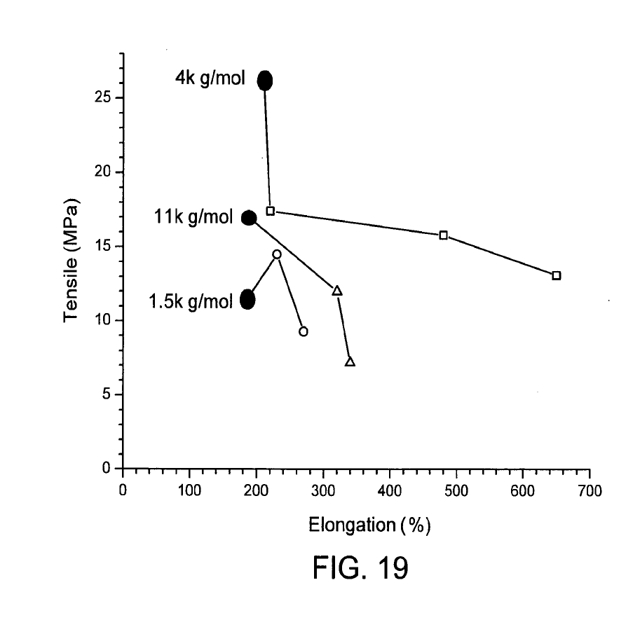

FIG. 19 is a graph showing tensile strengths and elongations of PIB-based polyurethanes (absence of PTMO) with various hard segment contents and molecular weights (where each line corresponds to a single MW PIB soft segment and each point in a line represents a different PIB/HS ratio).

PIB-based polyurethanes synthesized earlier by the use of the various diisocyanates and chain extenders exhibit less-desirable mechanical properties. While not wishing to be bound to any one theory, it is theorized that the hard segments of these products fail to provide adequate reinforcement because the highly crystalline hard segments (MDI/BDO) lead to massive phase separation between the polar hard and non-polar soft segments and the lack of interaction between the soft PIB and the crystalline hard MDI/BDO segments lead to unsatisfactory stress transfer. Thus, in one embodiment, the polymers of the present invention have a decreased crystallinity in their one or more hard segments due to the use of combinations of HMDI and HD, which are expected to provide a measure of flexibility and compatibility between the hard and soft segments.

FIG. 19 is a graph showing tensile strengths versus elongations of PIB-based polyurethanes as a function of elongations using three PIB molecular weights and a hard segment content of between 15% by weight and 50% by weight. As expected, higher hard segment content increases the tensile strength and decreases the elongation (hard segment content increases monotonically from right to left on each line). Unexpectedly, the best results are obtained by the use of 4,050 g/mol PIB, whereas polyurethanes with 1,500 and 11,000 g/mol PIB show significantly poorer properties. The strength of polyurethanes with 4,050 g/mol PIB soft segments are significantly higher than those of earlier PIB-based polyurethanes (approximately 15 MPa tensile strength even at greater than a 400% elongation).

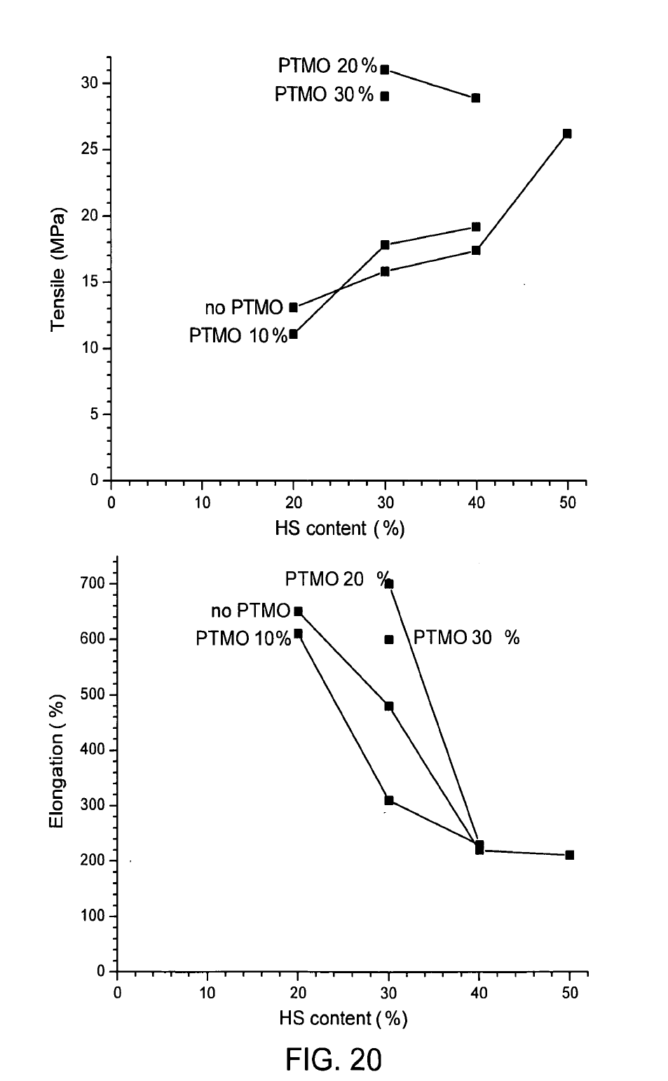

Turning to FIG. 20, FIG. 20 is a set of graphs that shown the effect of PTMO content on the tensile strength and elongation of polyurethanes. The molecular weights of PIB and PTMO=4,050 and 1,000 g/mol, respectively.

Given the above, it is shown that via the addition of a suitable amount of PTMO to PIB-based polyureas an unexpected improvement of the mechanical properties of same can be achieved. Next, an examination of the effect of added PTMO on the mechanical properties of polyurethanes is conducted. FIG. 20 is a set of graphs showing the effect of PTMO addition on the tensile strength and elongation of PIB/PTMO mixed soft segment polyurethanes. In the absence, or presence, of 10% by weight PTMO the tensile strength increases from about 10 to about 25 MPa nearly linearly with the hard segment content. The addition of 20% by weight PTMO, however, elicited an unexpected increase, for example, the tensile doubles at 30% by weight hard segment content. The further addition of more PTMO does not increase the effect. FIG. 20 also shows elongations: the large increase in the tensile strength is accompanied by a moderate increase in the elongations when compared at the same hard segment content. This indicates that the interaction between the PTMO and the hard segment produces a more uniform stress distribution within the hard segment at higher elongations.

The segment size of chain extended hard segments strongly affects the thermal and mechanical properties of polyurethanes. The degree of polymerization of the hard segment (P_{HS}) is calculated for the chain extended polyurethanes (see Table 8). Because the M_{w} of the PTMO is much lower than that of the PIB, the P_{HS}'s of the products with mixed soft segments are quite low, (close to stoichiometric ratios), particularly for polyurethanes made with 1.5k g/mol PIB/650 g/mol PTMO soft segment combination.

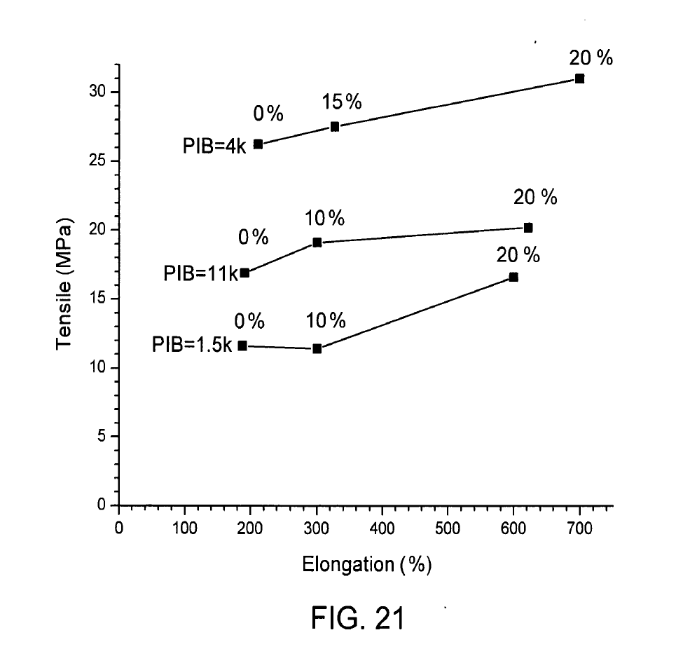

FIG. 21 shows the effect of PTMO addition on the tensile strength and elongation of polyurethanes prepared with different molecular weight PIB soft segments. Because the PIB exhibits the highest oxidative/hydrolytic stability among the constituents, the oxidative stability of mixed soft segment polyurethanes is expected to show a strong correlation with the PIB content. Thus, an examination of the mechanical properties of polyurethanes with different PTMO/hard segment ratios at constant (50%) PIB content is undertaken. Interestingly, both elongations and tensile strengths improve markedly at every PIB molecular weight with increasing PTMO content from 0% by weight to 20% by weight. Tensile strengths increase 2 to 5 MPa, and elongations increase from about 200% to about 600% to 700% upon the addition of 20% by weight PTMO.

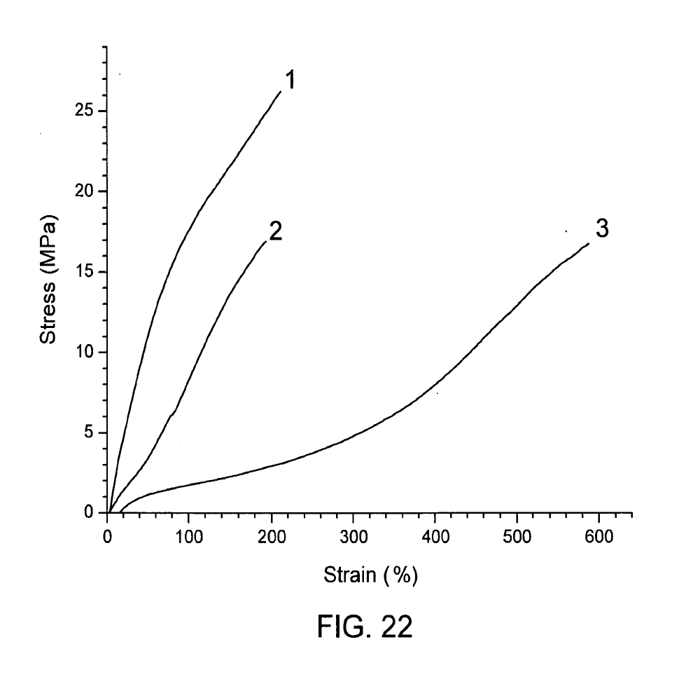

FIG. 21 is a graph showing tensile strength versus elongations at various PTMO contents and PIB molecular weights (PIB content=50%, the digits indicate percent PTMO). FIG. 22 is a graph showing stress strain curves of representative PIB-based polyurethanes: HO—PIB—OH(4k-50)/HMDI+HD=50% (marked “1”) , HO—PIB—OH(11k-50)/HMDI+HD=50% (marked “2”), HO—PIB—OH(11k-50)/HO—PTMO—OH(1k-20)/HMDI+HD=30% (marked “3”).

Turning to FIG. 22, this figure shows stress-strain traces of select polyurethanes. As expected, samples with 50% by weight hard segment (e.g., HO—PIB—OH(4K-50%)/HMDI+HD=50%) show rather high moduli at low elongations which suggests partially interconnected hard domains. Polyurethanes containing 20% by weight or more PTMO showed a significant increase in modulus at approximately 400% elongation which is most likely due to stress induced crystallization of the PTMO segments. Polyurethanes made in the absence, or with 10% by weight PTMO, do not show this behavior. Polyurethanes containing high molecular weight (11,000g/mol) PIBs exhibited remarkably low moduli below approximately 300% elongation.

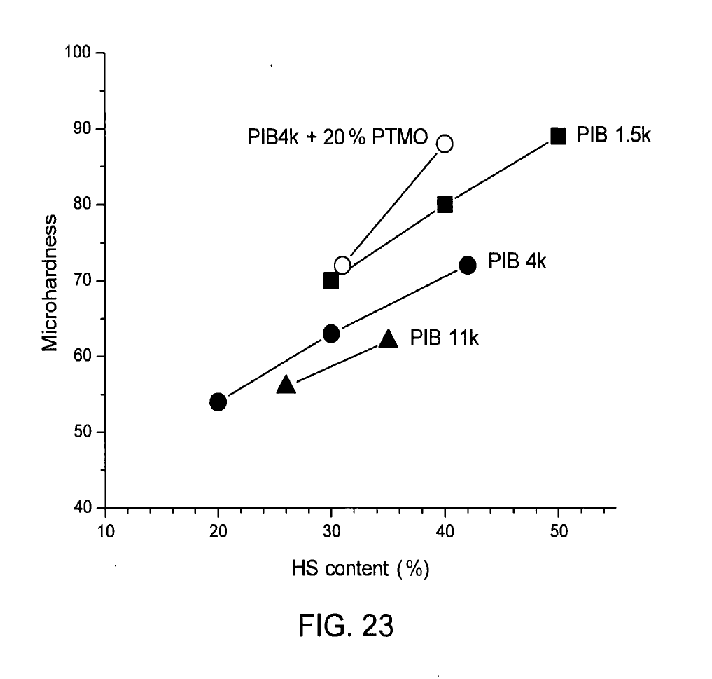

Turning to FIG. 23, FIG. 23 is a graph showing the effect of PIB molecular weight and 20% by weight PTMO on hardness (Microhardness as a function of hard segment content).

### (b) Hardness

The microhardness of PIB-based polyurethanes is investigated (see data in Table 8). It is discovered that the hardness of our polyurethanes is strongly affected by both the hard segment content and the molecular weight of the PIB. Microhardness increases linearly with hard segment content for all three PIB MWs. Polyurethanes prepared with 11,000 and 4,050 g/mol PIB show 63 or less hardness at moderate hard segment (HS) contents (15% by weight and 30% by weight). Polyurethanes with 1,500 g/mol PIB have a fairly high hardness. As expected, PTMO addition increases hardness by about 8 to about 18 units within the 30% by weight to 40% by weight hard segment range at identical hard segment contents.

### (C) DSC

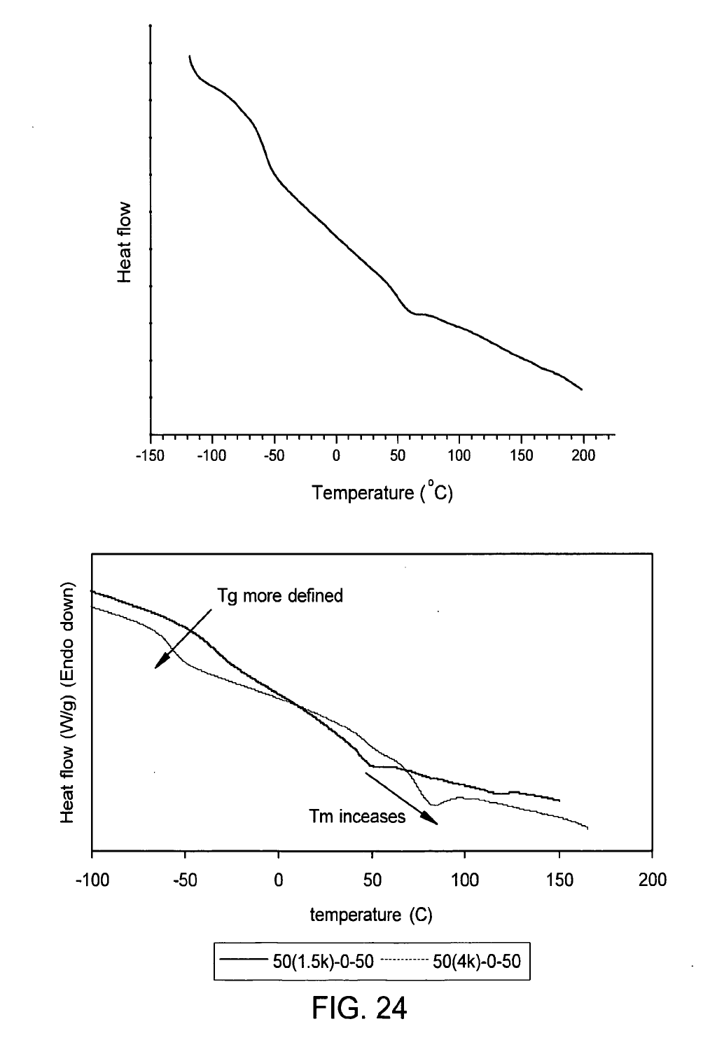

DSC studies are carried out with PIB+PTMO-based polyurethanes. Briefly, it can be stated that the addition of PTMO to PIB-based polyureas decreases the crystallinity of the hard segments. The DSC trace of a representative mixed soft segment polyurethane (FIG. 24) shows a small melting peak at approximately 50° C. In contrast, conventional polyurethanes that contain crystalline MDI/BDO hard segments show very pronounced melting peaks in the 100° C. to 200° C. range. While not wishing to be bound to any one theory, it is believed that the semi-crystalline HMDI/HD hard segments reduce the melting peak. Furthermore, it is also believed that the incorporation of PTMO suppresses the melting peak of hard segments even further because the PTMO forms hydrogen bonds with the hard segments, which disturb their crystallization.

The M_{w} of PIB affected the thermal properties of polyurethanes as well. FIG. 24 shows the DSC traces of two polyurethanes with identical compositions (50% by weight hard segment, no PTMO), and PIB soft segments of 1,500 and 4,050 g/mol. The polyurethane with the shorter PIB chain shows a very weak Tₘ at 50° C., while the 4,050 g/mol PIB product exhibits a Tₘ at 80° C. While not wishing to be bound to any one theory, it is believed that most likely the 1,500 g/mol PIB segment is too short for microphase separation to occur and the smaller hard segment domains yield a lower melting point. Consequently, products made with 1,500 g/mol PIB exhibit poorer mechanical properties than products made with 4,050 g/mol PIB.

FIG. 24 is a graph showing a representative DSC trace of a mixed soft segment polyurethane [HO—PIB—OH(4K, 50%)+HO—PTMO—OH(1K, 20%)/HMDI+HD=30%]. Table 8 below sets forth the composition, mechanical properties and M_{w}s of various exemplary PIB-PUs.

TABLE 8
Composition, Mechanical Properties and M_{W}s of PIB-PUs

| | | Mw | Tensile | Elongation | |
|---|---|---|---|---|---|
| Sample | P_{HS}* | (g/mol) | MPa | % | Hardness |
| PUs with PTMO soft segment (no PIB) | | | | | |
| HO-PTMO-OH(0.6k-70%)/HMDI + HD = 30% | 0 | | 34 | 520 | 68 |
| PUs with 1.5k PIB soft segment | | | | | |
| HO-PIB-OH(1.5k-70%)/HMDI + HD = 30% | 1 | 56,500 | 9.3 | 270 | 70 |
| HO-PIB-OH(1.5k-60%)/HMDI + HD = 40% | 2 | 45,200 | 14.5 | 230 | 80 |
| HO-PIB-OH(1.5k-50%)/HMDI + HD = 50% | | 43,500 | 11.5 | 189 | 89 |
| HO-PIB-OH(1.5k-50%) + HO-PTMO-OH(0.6k-10%)/HMDI + HD = 40% | 1.5 | 61,300 | 16.5 | 380 | 81 |
| HO-PIB-OH(1.5k-45%) + HO-PTMO-OH(0.6k-15%)/HMDI + HD = 40% | | 66,300 | 24.3 | 482 | |
| HO-PIB-OH(1.5k-50%) + HO-PTMO-OH(0.6k-20%)/HMDI + HD = 30% | 0.5 | 86,200 | 16.6 | 600 | 68 |
| HO-PIB-OH(1.5k-40%) + HO-PTMO-OH(0.6k-20%)/HMDI + HD = 40% | 1.3 | 115,200 | 32.5 | 425 | 86 |
| PUs with 4k PIB soft segment | | | | | |
| HO-PIB-OH(4k-80%)/HMDI + HD = 20% | 2 | 112,800 | 13.1 | 650 | 54 |
| HO-PIB-OH(4k-60%)/HMDI + HD = 40% | 7 | 65,800 | 17.4 | 220 | 72 |
| HO-PIB-OH(4k-70%)/HMDI + HD = 30% | 3.9 | 76,700 | 15.8 | 480 | 63 |
| HO-PIB-OH(4k-50%)/HMDI + HD = 50% | | 68,200 | 26.2 | 211 | 86 |
| HO-PIB-OH(4k-70%) + HO-PTMO-OH(1k-10%)/HMDI + HD = 20% | 1.2 | 84,400 | 11.1 | 610 | 52 |
| HO-PIB-OH(4k-60%) + HO-PTMO-OH(1k-10%)/HMDI + HD = 30% | 2.4 | 88,600 | 17.8 | 310 | 68 |
| HO-PIB-OH(4k-50%) + HO-PTMO-OH(1k-10%)/HMDI + HD = 40% | 3.8 | 78,300 | 19.2 | 230 | |
| HO-PIB-OH(4k-50%) + HO-PTMO-OH(1k-20%)/HMDI + HD = 30% | 1.6 | 51,300 | 31.0 | 700 | 72 |
| HO-PIB-OH(4k-40%) + HO-PTMO-OH(1k-20%)/HMDI + HD = 40% | | 73,300 | 28.9 | 230 | 88 |
| HO-PIB-OH(4k-40%) + HO-PTMO-OH(1k-30%)/HMDI + HD = 30% | 1.2 | 112,700 | 29.0 | 600 | 69 |
| HO-PIB-OH(4k-40%) + HO-PTMO-OH(1k-30%)/HMDI + HD = 30% | | 103,100 | 27.5 | 327 | |
| PUs with 11k PIB soft segment | | | | | |
| HO-PIB-OH(11k-75%)/HMDI + HD = 25% | 9.6 | | 7.2 | 340 | 56 |
| HO-PIB-OH(11k-65%)/HMDI + HD = 35% | 15.1 | | 12.0 | 320 | 62 |
| HO-PIB-OH(11k-50%)/HMDI + HD = 50% | | | 16.9 | 191 | |
| HO-PIB-OH(11k-60%) + HO-PTMO-OH(1k-15%)/HMDI + HD = 25% | 2.3 | | 13.6 | 640 | 49 |
| HO-PIB-OH(11k-50%) + HO-PTMO-OH(1k-15%)/HMDI + HD = 35% | 3.7 | | 19.1 | 300 | 71 |
| HO-PIB-OH(11k-50%) + HO-PTMO-OH(1k-20%)/HMDI + HD = 30% | | | 20.2 | 622 | |

*P_{HS}: Polymerization degree of hard segment defined by the average number of HD between two soft segments.

### (VII) Additional PIB-Based Polyurethanes and Polyureas

### Materials

Poly(hexamethylene carbonate) diol (PC) (M_{w}=860 g/mol), 1,4-butanediol (BDO), dibutyltin dilaurate (DBTDL) are purchased from Aldrich and used without further purification. Tetrahydrofuran (THF) and 4,4′-methylenebis(cyclohexyl isocyanate) (HMDI) are from Aldrich and purified distillation.

### (b) Synthesis of Polyurethanes and Polyureas

PIB+PTMO based polyurethanes and PIB+PTMO based polyureas are synthesized using a method discussed above. PIB+PC based polyurethanes are produced by reacting PIB and PC macrodiols with HMDI and chain-extending the prepolymer with BDO in the presence of DBTDL as a catalyst and THF as a solvent (20% solid content). For example, 1 gram of PIB macrodiol is mixed with 0.59 grams of HMDI in the presence of 4.5 grams of THF at 60° C. Three drops of DBTDL is added. After about 1.5 hours, 0.3 grams of PC macrodiol is added with 1.5 grams of THF and the charge is further reacted for about 1.5 hours. BDO (0.13 grams) is added and reacted for about 3 hours. The reaction is stopped after isocyanate (NCO) is completely consumed which is confirmed with FT-IR by examining NCO peaks at 2270 cm⁻¹.

### (c) Characterization

Polyurethanes/PUrea films (100 to 300 pm thick) are prepared using THF as a solvent and then casting in a Teflon mold and drying at room temperature for a day followed by drying in oven at 70° C. overnight. Samples are stored for a week at room temperature before testing the mechanical properties thereof.

Stress-strain behavior is determined by an Instron Model 5543 Universal Tester controlled by Series Merlin 3.11 software. A bench-top die (ASTM 1708) is used to cut dog-bone samples from films. The samples (25 mm long, 3.5 mm in width at the neck) are tested to failure at a crosshead speed of 25 mm/min at room temperature. FTIR spectra are obtained by a Nicolet 7600 FTIR spectrometer using solution cast films on KBr discs dried with a heat gun. Twenty scans are taken for each spectrum with 2 cm-1 resolution.

Melting temperatures (Tₘ) and glass transition temperatures (T_{g}) of polyurethanes and polyureas are obtained by the use of a TA Instruments Q2000 Differential Scanning calorimeter (DSC) with 5 to 10 mg samples enclosed in aluminum pans and heated 10° C./min from −100° C. to 200° C. Dynamic mechanical thermal analysis (DMTA) is performed by a PerkinElmer dynamic mechanical analyzer. Measurements are made in tensile mode at 1 Hz, between −100° C. and 200° C., under a nitrogen atmosphere, at a heating rate of 3° C./min.

Small Angle X-ray Scattering (SAXS) experiments are performed under vacuum with S-Max 3000 SAXS instrument operating at 45 kV and 0.88 mA. MicroMax-002+x-ray generator equipped with Cu tube (wavelength 1.542 Angstroms) is used. SAXS data are collected for exposures of 1,000 seconds at room temperature. Interdomain spacing (d) is determined by:

$$d = \frac{2 π}{{q}_{ma x}} ,$$

where qₘₐₓ is the location of scattering peak in the plot of scattering intensity (I) vs. scattering vector (q). The Atomic Force Microscopy (AFM) image is taken with a Veeco Metrology Group MultiMode Scanning Probe Microscope (Digital Instruments) (a similar method is utilized for the same data in the results above).

### (d) Results and Discussion

### (1) The Model

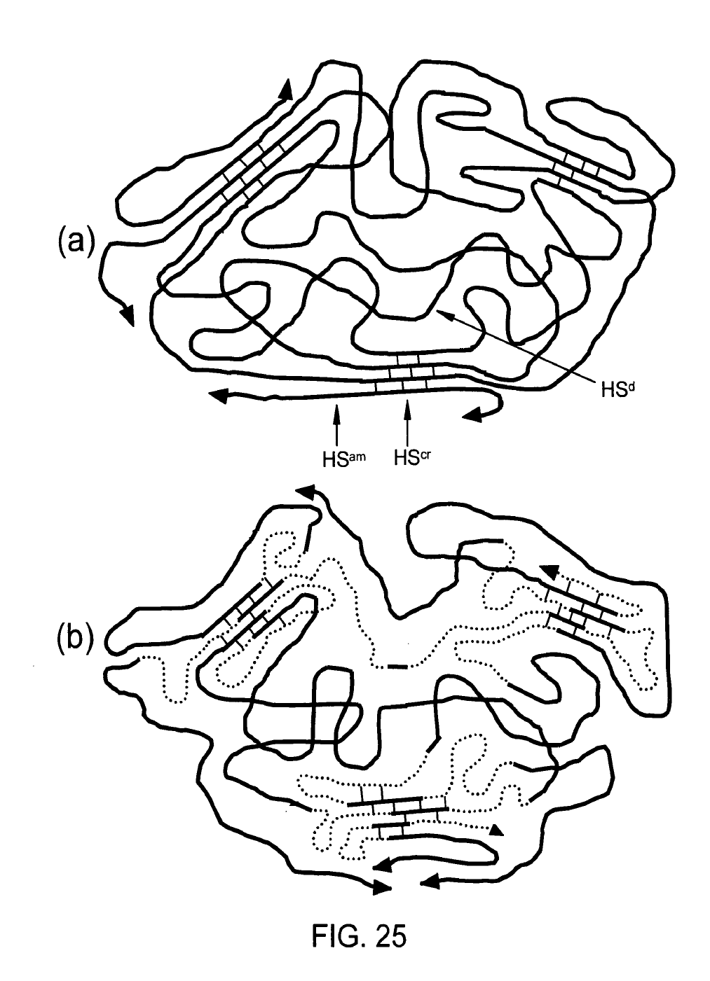

The schemes in FIGS. 25a and 25b help to visualize the idealized micro-architectures of polyurethanes and polyureas containing PIB soft segments (FIG. 25a) and hybrid PIB/PTMO or PIB/PC soft segments (FIG. 25b), respectively, both in combination with somewhat flexible semi-crystalline hard segments consisting of conformationally labile 4,4′-Methylenebis(cyclohexyl isocyanate) (HMDI) and 1,6-hexamethylene diol (HDO) units. Because of the large polarity difference between the PIB and HMDI/HDO phases the soft/non-polar and hard/polar phases are strongly segregated, and the interfaces between them are proposed to be mainly disorganized/amorphous. While not wishing to be bound to any one theory, it is believed that hydrogen bridges cannot form between the hard and soft phases (which may go a long way to explain the properties of PIB-based polyurethanes). However, they exist within the semi-crystalline HMDI/HDO phases. Hydrogen bridge formation between PTMO and hard segment further diminishes order (increases the amorphous content) within the hard segment. While the PTMO or PC segments remain largely segregated, the hydrogen bridges that arise between the donor —NH— groups of HMDI and the acceptor —CH₂—O—CH₂— or —O—CO—O— groups of PTMO or PC, respectively. The important consequence of multiple hydrogen (H) bridges is to establish contact between the soft and hard segments, which facilitates stress transfer from the soft to the hard phase and thus enhances the mechanical properties of these hybrid polymers. The sections that follow describe and discuss experiments carried out to substantiate the proposed structural models.

Regarding FIG. 25, FIG. 25 is an illustration of one proposed morphology of: (a) PIB-based PUs, and (b) PIB+PTMO- or PIB+PC-based PUs, where HS^{cr} denotes crystalline region of HS, HS^{am} amorphous region of HS, HS^{d} short hard segments connecting two soft segments where a solid curve=PIB; a dotted curve=PTMO or PC and hydrogen bonds are represented by short thin lines.

### (2) DSC Studies: The Effect of PTMO and PC Addition on the Thermal Behavior and Mechanical Properties of PIB-Based Polyurethanes and Polyureas

The addition of PTMO or PC segments to PIB-based polyurethanes and polyureas is expected to affect the thermal behavior of these segmented copolymers. Thus, experiments are carried out to compare the DSC profiles of polyurethanes and polyureas prepared with (a) only PIB, and (b) combinations of hybrid PIB/PTMO or PIB/PC soft segments. Additional DSC studies are carried out with PIB-based polyurethanes synthesized by the use of increasing amounts (0% by weight to 30% by weight) of PTMO.

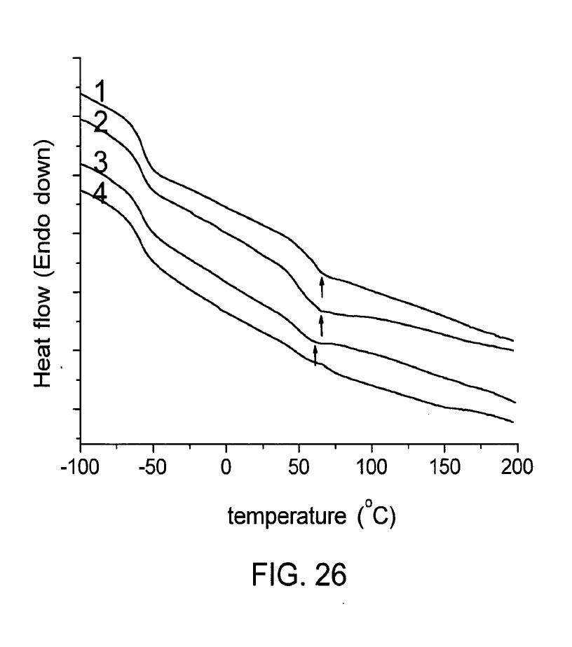

Table 9 and FIG. 26 show thermal transitions (T_{g} and Tₘ data), together with tensile strengths and elongations reported above. All the polyurethanes exhibited a pronounced T_{g} at approximately −58° C. due to the presence of soft PIB segments. In contrast, the position and intensity of the Tₘ's are affected by the amount of added PTMO: In the absence or presence of relatively small amounts (10% by weight) of PTMO (see the first and second examples from the top of Table 9) the Tₘ is 65° C. with signals readily discernible. Upon increasing the PTMO to 21% by weight (see the third example from the top of Table 9) the Tₘ decreased to 58° C. and the intensity of the signal diminished suggesting decreasing order in the hard phase. And by increasing the PTMO to 30% by weight the Tₘ signal essentially disappeared (see the fourth example from the top of Table 9).

Thus, the tensile strengths and elongations of the products reflect the changes observed in thermal behavior. In the absence or presence of only 10% by weight PTMO (see the first and second examples from the top of Table 9) the tensile strengths and elongations are relatively low (15.8 MPa to 17.8 MPa, and 480% to 310%, respectively), however, in the presence of 21% by weight PTMO (see the third example from the top of Table 9) the tensile strength rises to 31 MPa and the elongation also reaches a value of 700%. Increasing the PTMO content to 30% by weight (see the fourth example from the top of Table 9) does not further increase strength or elongation. Apparently, a maximum tensile strength and elongation are reached with 20% to 30%, by weight, PTMO at this hard segment content. The fact that PTMO-based polyurethanes exhibit similar tensile strengths and elongations at this hard segment content supports this conclusion.

TABLE 9
Thermal and Mechanical Properties of PIB-, PIB/PTMO-,
and PIB/PC-based Polyurethanes and Polyureas

| | | | | |
|---|---|---|---|---|
| | | | Tensile | Elongation |
| Materials | T_{g} (° C.) | Tm (° C.) | (MPa) | (%) |

Polyurethanes with PTMO

| | | | | |
|---|---|---|---|---|
| HO-PIB-OH(4K, 70%)/HMDI+HDO = 30% | −58 | 65 | 15.8 | 480 |
| HO-PIB-OH(4K, 60%) + HO-PTMO- | −57 | 65 | 17.8 | 310 |
| OH(1K, 10%)/HMDI + HDO = 30% | | | | |
| HO-PIB-OH(4K, 48%) + HO-PTMO- | −58 | 58 | 31 | 700 |
| OH(1K, 21%)/HMDI + HDO = 31% | | | | |
| HO-PIB-OH(4K, 40%)+HO-PTMO- | −60 | Not discernible | 29 | 600 |
| OH(1K, 30%)/HMDI + HDO = 30% | | | | |

Polyureas with PTMO

| | | | | |
|---|---|---|---|---|
| H₂N-PIB-NH₂(2K, 65%)/HMDI + HDA = 35% | −48 | 212 | 24 | 80 |
| H₂N-PIB-NH₂(2K, 53%) + H₂N-PTMO- | −50 | 78, 129, 198 | 29 | 200 |
| NH₂(1.1K, 12%)/HMDI + HDA = 35% | | | | |

Polyurethanes with PC

| | | | | |
|---|---|---|---|---|
| HO-PIB-OH(3.4K, 65%)/HMDI + BDO = 35% | −59 | 91, 136 | 13.2 | 165 |
| HO-PIB-OH(3.4K, 50%) + HO-PC- | −59 | 55, 78, 112, 153 | 15.9 | 180 |
| OH(0.86K, 15%)/HMDI + BDO = 35% | | | | |
| HO-PIB-OH(3.4K, 45%) + HO-PC- | −58 | 56, 123, 168 | 19.5 | 230 |
| OH(0.86K, 20%)/HMDI + BDO = 35% | | | | |
| HO-PIB-OH (3.4K, 40%) + HO-PC- | −59 | 56, 118, 163 | 22.1 | 280 |
| OH(0.86K, 25%)/HMDI + BDO = 35% | | | | |

Polyurethanes with PTMO and BDO

| | | | | |
|---|---|---|---|---|
| HO-PIB-OH (3.4K, 50%) + HO-PTMO- | −59 | 57, 114, 168 | 14.7 | 350 |
| OH(1K, 15%)/HMDI + BDO = 35% | | | | |

FIG. 26 is a graph of DSC traces of various exemplary PIB/PTMO-based polyurethanes, where the numbers 1 through 4 denote the first four examples from the top of Table 9 below and where the arrows denote the melting peaks.

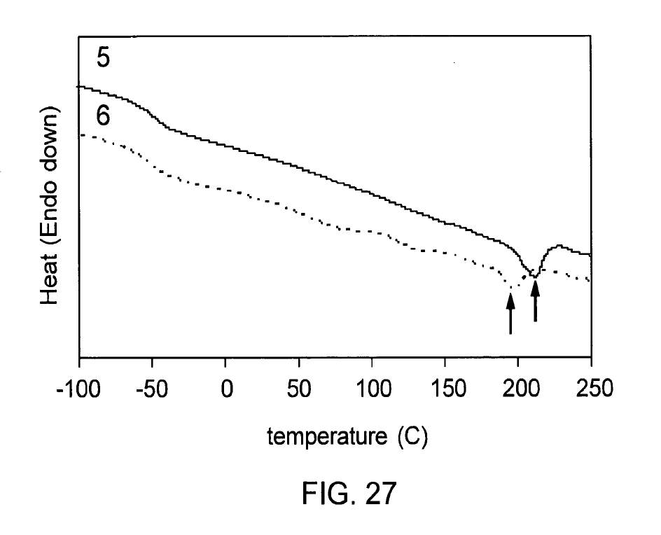

Turning to the fifth and sixth examples from the top of Table 9, FIG. 27 shows data obtained with polyureas prepared in the presence of 12% by weight PTMO at the same hard segment content (35%). The trends exhibited by the polyurethanes and polyureas are similar, however, as expected, the Tₘ's of the polyureas are much higher and more pronounced than those of polyurethanes on account of the stronger and larger number of H bridges in the polyureas.

The DSC scan obtained with the polyurea containing 12% by weight PTMO (see the sixth example from the top of Table 9) shows two new melting ranges centered at approximately 78° C. and approximately 129° C., which suggest the presence and melting of new H bridged structures. Accordingly, both the tensile strength and elongation of the polyurea prepared with PTMO are significantly higher than that obtained in the absence of PTMO. The proposed model is in line with these observations.

While not wishing to be bound to any one theory, it is believed that the stronger and larger numbers of H bridges in polyureas relative to polyurethanes produce strong interactions between the soft and hard segments and lead to enhanced strength. Excessive strengthening and overly high Tₘ's can be undesirable with respect to melt processibility because these polyureas will tend to degrade before they melt. The addition of PTMO not only reduces the Tₘ leading to better melt processibility, but it also improves stress transfer from the soft to the hard segments and improves the mechanical properties.

FIG. 27 is a graph of DSC traces of various exemplary PIB/PTMO-based polyureas, where the numbers 5 and 6 denote the fifth and sixth examples from the top of Table 9 and where the arrows denote the melting peaks.

Additionally, a determination and analysis of the thermal transitions of PIB-based polyurethanes prepared in the absence and presence of PC soft segments is made. The PC segment is selected because polyurethanes prepared with the Poly(hexamethylene carbonate) macrodiol exhibit superior biological, oxidative and/or hydrolytic stabilities to those of PTMO-based polyurethanes. The increased stability of PC-based polyurethanes relative to PTMO-based polyurethanes is due to the lower number of vulnerable acidic hydrogens in the former. In addition, the —O—CO—O— group is a stronger H acceptor than the —CH₂—O—CH₂— group and is expected to form stronger H bridges.

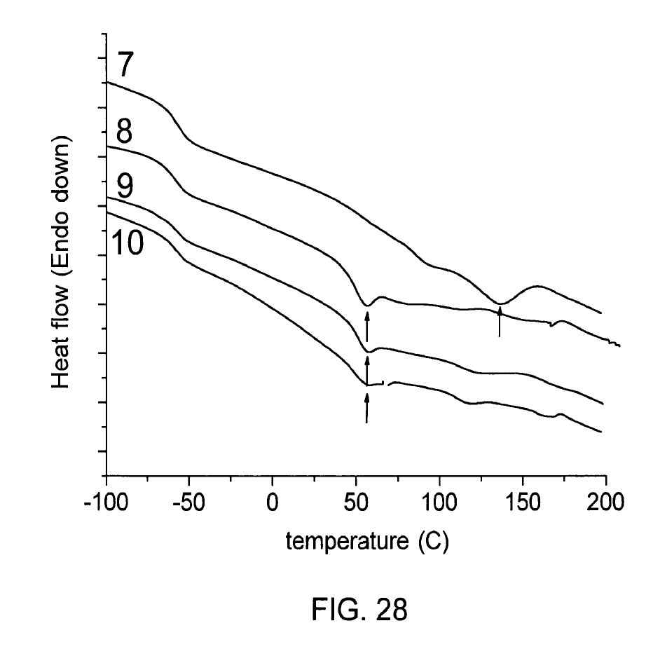

Table 9 and FIG. 28 show the composition of the polyurethanes synthesized together with their thermal transitions and tensile properties. All the DSC traces exhibit well-discernible T_{g}'s at −59° C. due to the PIB segment. The PIB-based polyurethane with the HMDI/BDO hard segment (see the seventh example from the top of Table 9) exhibits marked Tₘ's at 91° C. and 136° C. Polyurethanes prepared with the HMDI/HDO combination (see the first example from the top of Table 9) do not show these high transitions, which suggest higher order in the HMDI/BDO than in the HMDI/HDO phase. The multiple melting transitions in polyurethanes containing increasing amounts of PC (from 15% by weight to 25% by weight, see the eighth through tenth examples of Table 9) indicate the presence of various hard segments of various crystallinities.

FIG. 28 is a graph of DSC traces of various exemplary PIB/PC-based polyurethanes, where the numbers 7 through 10 denote seventh through tenth examples from the top of Table 9 and where the arrows denote the melting peaks.

A comparison of the Tₘ's of PIB-based polyurethanes prepared with the same amount (15% by weight) of PC and PTMO (see the eighth and eleventh examples of Table 9) suggests largely similar products, albeit the former shows a transition at 78° C. which is absent in the latter. While their tensile strengths are quite similar, the elongation of the polyurethane made with PTMO is far superior to the one made with PC, at the same (35% by weight) hard segment content (elongations 180% versus 350%, compare the eighth and eleventh examples from the top of Table 9). At the same weight of additive, the number of H bridge acceptor sites in PTMO (ether oxygen atoms) is nearly double that in the PC (carbonate groups). When these polyurethanes are stretched the H bonds break and reform (relax) between adjacent functional groups. Thus, the polyurethane made with PTMO may break and relax at twice the strain than the ones made with PC.

In sum, according to these findings the addition of PTMO or PC soft segments to PIB-based polyurethanes and polyureas lead to improved mechanical properties. Thus, the present invention supports the proposition that these added soft segments form hybrid soft phases with PIB lead to H bridges between the soft and hard phases, which in turn lead to more efficient stress transfer from the soft to the hard phases, and thus yield improved mechanical properties.

### (3) AFM Studies

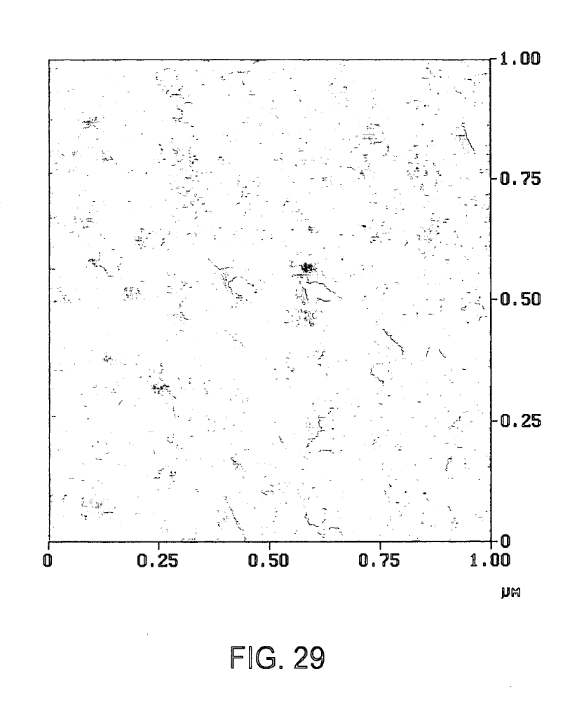

To gain further insight into the morphology of these novel polyurethanes AFM studies are carried out. FIG. 29 is an AFM phase image of HO—PIB—OH(4K,48%)+HO—PTMO—OH(1 K,21%)/HMDI+HDO=31% (third example from the top of Table 9). Turning to this Figure, FIG. 29 shows the phase image of a representative polyurethane containing hybrid PIB/PTMO soft segment. The image shows a typical phase-separated micro-morphology. Although a thin (most likely 2 to 10 nm) PIB layer covers the entire scanned area, phase separation is clearly indicated. The dark areas are the hybrid soft domains (PIB+PTMO) and the light areas are percolating hard segments. This image is similar to that of Elast-Eon E2A (40% MDI/BDO hard segment, 60% soft segment of PDMS and PHMO).

### (4) SAXS Studies: The Effect of PTMO on Interdomain Spacing

Thus, further insight into the mechanical-property-enhancing effect of PTMO addition to PIB-based segmented copolymers is gained by SAXS experiments. SAXS provides information as to the interdomain spacing between hard domains dispersed in a continuous soft matrix.

While not wishing to be bound to any one theory, it is theorized that the introduction of PTMO into the continuous soft PIB matrix may increase the extent of dispersion of the hard domains and thus decrease interdomain spacing. Experiments are carried out with PIB-based polyurethanes and a PIB-based polyurea (see the first, fifth, and seventh examples from the top of Table 9), and the same products with added PTMO or PC soft co-segments (see the second to fourth and sixth examples from the top of Table 9 and eighth to tenth examples from the top of Table 9, respectively).

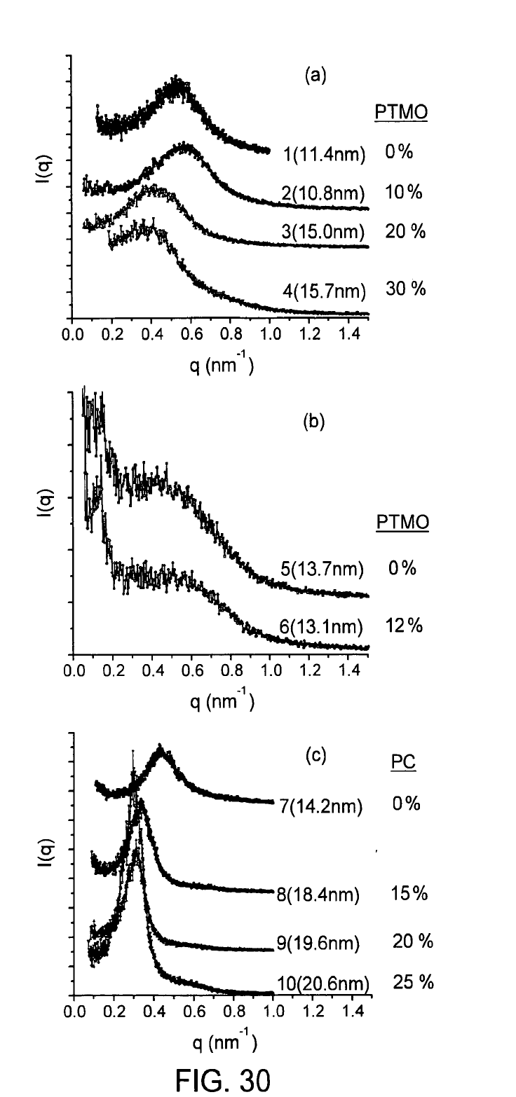

FIG. 30 shows the relevant SAXS data. FIG. 30a shows the SAXS spectrum of a polyurethane containing only PIB soft segments and those of polyurethanes containing mixed PIB/PTMO soft segments with increasing amounts of PTMO at the same hard segment content. According to the spectra, the interdomain spacings in the absence of PTMO or presence of a small amount of PTMO (10% by weight) are within experimental error, approximately 11 nm, suggesting that 10% by weight PTMO does not affect interdomain spacing. However, the spacing increases to 15 nm and 15.7 nm by increasing the PTMO content to 20% by weight and 30% by weight, respectively. While not wishing to be bound to any one theory, it is believed that replacing PIB with lower molecular weight PTMO increases the number of short hard segments between two soft segments, and therefore yields shorter hard segments for hard domain formation and lowers degree of hard domain dispersion in the soft matrix; hence, interdomain spacing increases. The interdomain spacing should be expected not to change by replacing PIB with the same molecular weight PTMO. The SAXS spectra of PIB- and PIB/PTMO-based polyureas show a similar trend (see FIG. 30b). The interdomain spacing of a polyurea made with PIB is similar to the one made with PIB plus 12% by weight PTMO (see the fifth and sixth example from the top of Table 9) at the same hard segment content. The SAXS spectra of polyurethanes containing only PIB and those with mixed PIB/PC soft co-segments show a similar trend (see FIG. 30c, see the seventh and eighth to tenth examples from the top of Table 9, respectively).

While not wishing to be bound to any one theory, it is believed that the improvement in mechanical strength of polyurethanes and polyureas obtained in the presence of PTMO or PC is not due to increased dispersion of hard domains but to the formation of H-bonds (hydrogen bonds). Enhanced elongation is most likely due to the flexibilization of the hard segments by PTMO segments. The proposed model is in line with these observations and conclusions.

Turning to FIG. 30, FIG. 30 is a SAXS graph of PIB- and PIB/PTMO-, and PIB/PC-based polyurethanes or polyureas where the numbers 1 through 10 denote the first through tenth examples from the top of Table 9 and where the number in parentheses denotes the interdomain spacing.

### (5) DMTA Studies: Flow Temperature and Melt-Processibility of Hybrid Polyurethanes

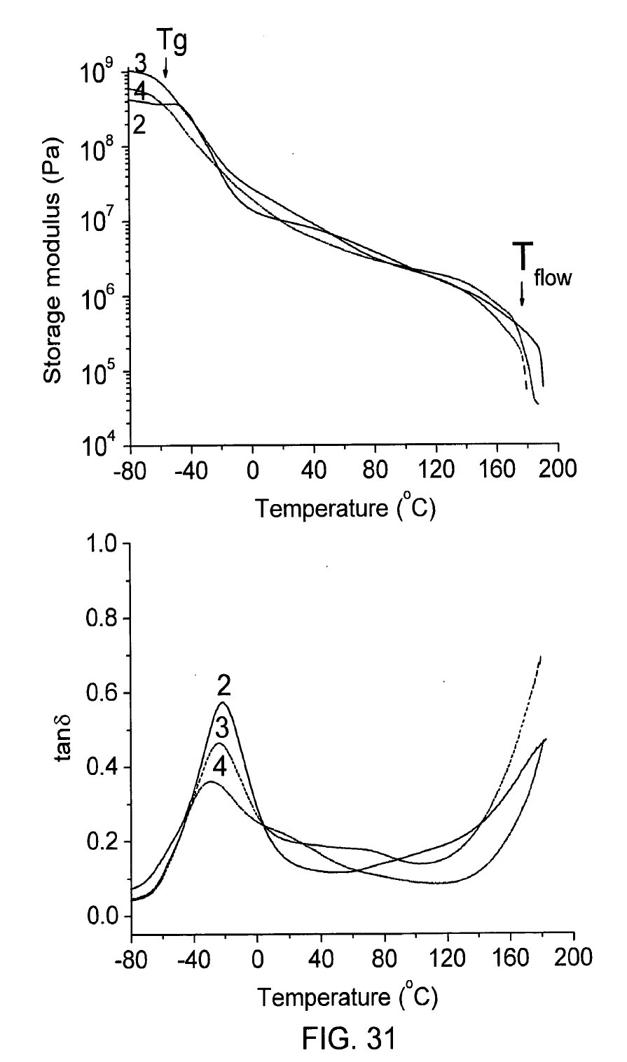

The storage moduli and flow temperatures of hybrid (PIB/PTMO)-based polyurethanes are studied by DMTA. FIG. 31 shows DMTA traces of three representative polyurethanes containing increasing amounts of PTMO (from 10% by weight to 30% by weight) at the same hard segment content. The samples exhibit a T_{g} at approximately −50° C. due to the PIB segment, and flow temperatures at approximately 180° C. According to DSC studies the products show melting transitions at approximately 50° C. (see FIG. 26), however, the samples do not flow until approximately 180° C. is reached where the hydrogen bonds start to break. The product with the lowest amount of PTMO (10% by weight) shows prominent crystal-crystal slips at approximately 50° C. With increasing amounts of PTMO, this region becomes flatter, which agrees well with DSC data that show less pronounced melting at approximately 50° C. The 180° C. flow temperature is, in some applications, desirable for melt-processibility.

Turning to FIG. 31, FIG. 31 is a DMTA graph of PIB/PTMO-based polyurethanes where the numbers 2 through 4 denote the second through fifth examples from the top of Table 9.

### (6) FTIR Studies: The effect of PTMO Incorporation on Hydrogen Bonding and Peak Positions

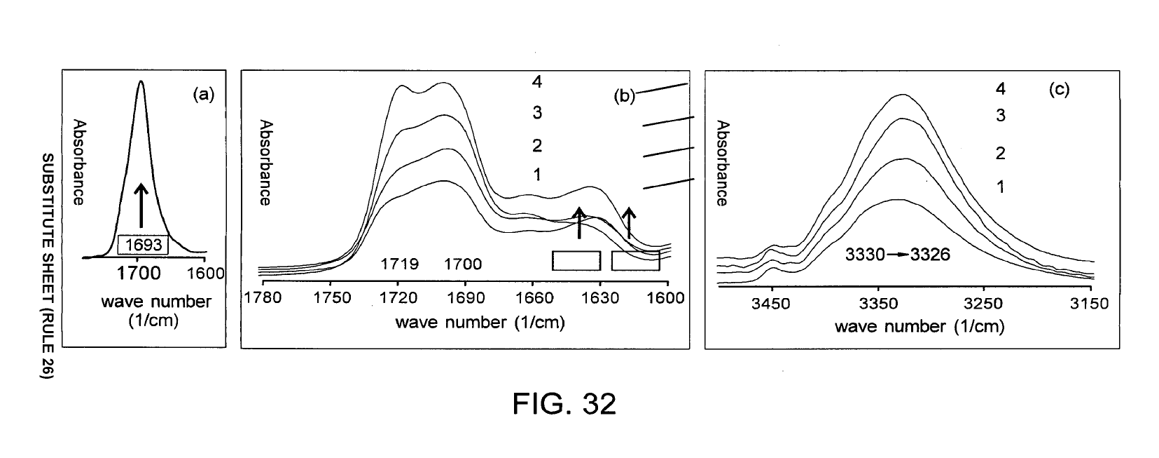

Infrared spectroscopy (IR) is a simple informative technique for the investigation of hydrogen bonding. The principle that makes IR useful for polyurethanes is its sensitivity to peak shifts due to the extent of hydrogen bonding between carbonyl groups. Turning to FIG. 32, FIG. 32 is FTIR spectra of: (a) the carbonyl region of the model hard segment (CHI—HDO—HMDI—HDO—HMDI—HDO—HMDI—HDO—CHI), (b) the carbonyl region of PIB/PMTO-based polyurethanes, and (c) the N—H region of various polyurethanes where the parenthetical numbers correspond to the following compounds (1) HO—PIB—OH(4K,70%)/HMDI+HDO=30%; (2) HO—PIB—OH(4K,60%)+HO—PTMO—OH(1K,10%)/HMDI+HDO=30% (3) HO—PIB—OH(4K,48%)+HO—PTMO—OH(1K,21%)/HMDI+HDO=31%; (4) HO—PIB—OH(4K,40%)+HO—PTMO—OH(1K,30%)/HMDI+HDO=30%. Specifically, FIG. 32 shows the N—H and carbonyl regions of FTIR spectra of polyurethanes and a model urethane hard segment based on HMDI and HDO.

FIG. 32a shows the carbonyl region of a model compound (CHI—HDO—HMDI—HDO—HMDI—HDO—HMDI—HDO—CHI) prepared for these investigations. The model urethane compound displays a sharp and symmetrical carbonyl (C═O) peak centered at 1693 cm⁻¹, indicating the presence of strongly hydrogen bonded urethane groups. FIG. 32b shows the carbonyl region of PIB/PTMO-based polyurethanes (see Table 9 for compositions). The PIB-based polyurethane displays broad and asymmetric carbonyl absorption with a fairly well defined peak at 1700 cm⁻¹ and a broad shoulder at 1719 cm⁻¹. The 1700 cm⁻¹ peak indicates the presence of strongly hydrogen bonded carbonyl groups within the urethane groups (see HS^{cr} in FIG. 25), and suggests good microphase separation and well ordered hard segments. The shoulder at 1719 cm⁻¹ indicates the presence of weakly hydrogen bonded or somewhat disordered urethane hard segments (see HS^{am} in FIG. 25). With increasing amounts of PTMO, the shoulder at 1719 cm⁻¹ becomes a well defined band with a maximum at 1719 cm⁻¹. The product containing 30% by weight PTMO displays a well defined doublet with maxima at 1700 cm⁻¹ and 1719 cm⁻¹ associated with the carbonyl group. The 1700 cm⁻¹ peak indicates the presence of strongly hydrogen bonded and microphase separated hard segments, whereas the 1719 cm⁻¹ peak is probably due to carbonyl groups interacting with PTMO segments.

In the 3450 cm⁻¹ to 3150 cm⁻¹ region (FIG. 32c), all copolymers show well defined symmetrical N—H stretching peaks. With increasing amounts of PTMO the peak maxima slightly shift towards lower wave numbers, from 3330 cm⁻¹ to 3326 cm⁻¹.

### General Embodiments

In light of the above, the present invention relates to various polyurethanes and/or polyureas that contain one or more types of hard segments and one or more types of soft segments. In one embodiment, such polyurethanes and polyureas of the present invention are made in accordance with the methods and examples discussed above using the appropriate reactants selected from those stated below.

Regarding the PIBs utilized in the present invention, in one embodiment the PIBs of the present invention are selected from linear, or star-shaped, or hyperbranched, or arborescent PIB compounds, where such compounds contain one or more primary alcohol-terminated segments and/or one or more primary amine terminated segments. In another embodiment, the PIBs of the present invention are selected from linear, or star-shaped, or hyperbranched, or arborescent PIB compounds, where such compounds contain two or more primary alcohol-terminated segments and/or two or more primary amine terminated segments. In still another embodiment, the PIBs of the present invention are selected from linear, or star-shaped, or hyperbranched, or arborescent PIB compounds, where such compounds contain two primary alcohol-terminated segments or two primary amine terminated segments.

In one embodiment, the number of repeating units in the various repeating PIB portions of an alcohol terminated and/or amine terminated PIB compound is in the range of 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

In one embodiment, the number of repeating units in the various repeating PTMO portions of the present invention is in the range of 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

In one embodiment, the number of repeating units in the various repeating aliphatic polycarbonate (PC) portions of the present invention is in the range of 2 to about 5,000, or from about 7 to about 4,500, or from about 10 to about 4,000, or from about 15 to about 3,500, or from about 25 to about 3,000, or from about 75 to about 2,500, or from about 100 to about 2,000, or from about 250 to about 1,500, or even from about 500 to about 1,000. Here, as well as elsewhere in the specification and claims, individual range limits can be combined to form alternative non-disclosed ranges and/or range limits.

In one embodiment, the one or more aliphatic portion of the polycarbonates utilized in conjunction with the present invention are selected from linear or branched C₁ to C₂₀ alkyl groups, linear or branched C₂ to C₂₀ alkenyl, or linear or branched C₂ to C₂₀ alkynyl. In another embodiment, the one or more aliphatic portion of the polycarbonates utilized in conjunction with the present invention are selected from linear or branched C₂ to C₁₅ alkyl groups, linear or branched C₃ to C₁₅ alkenyl, or linear or branched C₃ to C₁₅ alkynyl. In still another embodiment, the one or more aliphatic portion of the polycarbonates utilized in conjunction with the present invention are selected from linear or branched C₃ to C₁₀ alkyl groups, linear or branched C₄ to C₁₀ alkenyl, or linear or branched C₄ to C₁₀ alkynyl. Here, as well as elsewhere in the specification and claims, individual range limits can be combined to form alternative non-disclosed ranges and/or range limits.

Thus, in light of the above the polyurethanes and/or polyureas of the present invention are formed from an appropriate combination of an alcohol terminated and/or amine terminated PIB compound, as described above, with one or more of a PTMO or a PC, as described above. In some embodiments, where desired, at least one suitable chain extender and/or at least one diisocyanate is used in combination with the desired PIB compound and the one or more desired PTMO or PC compounds.

In another embodiment, the polymer compounds of the present invention, where applicable, have soft segment contents in the range of about 10 weight percent to about 98 weight percent, about 15 weight percent to about 95 weight percent, about 20 weight percent to about 90 weight percent, about 25 weight percent to about 85 weight percent, about 30 weight percent to about 80 weight percent, about 35 weight percent to about 75 weight percent, about 40 weight percent to about 70 weight percent, about 45 weight percent to about 65 weight percent, or even about 50 weight percent to about 60 weight percent. In still another embodiment, the polymer compounds of the present invention, where applicable, have soft segment contents in the range of about 50 weight percent to about 70 weight percent, about 52 weight percent to about 68 weight percent, about 54 weight percent to about 66 weight percent, about 56 weight percent to about 64 weight percent, or even about 58 weight percent to about 62 weight percent. Here, as well as elsewhere in the specification and claims, individual range limits can be combined to form alternative non-disclosed ranges and/or range limits.

In another embodiment, the polymer compounds of the present invention, where applicable, have hard segment contents in the range of about 1 weight percent to about 90 weight percent, about 2 weight percent to about 85 weight percent, about 5 weight percent to about 80 weight percent, about 10 weight percent to about 75 weight percent, about 15 weight percent to about 70 weight percent, about 20 weight percent to about 65 weight percent, about 25 weight percent to about 60 weight percent, about 30 weight percent to about 55 weight percent, or even about 35 weight percent to about 50 weight percent. In still another embodiment, the polymer compounds of the present invention, where applicable, have hard segment contents in the range of about 30 weight percent to about 50 weight percent, about 32 weight percent to about 48 weight percent, about 34 weight percent to about 46 weight percent, about 36 weight percent to about 44 weight percent, or even about 38 weight percent to about 42 weight percent. In still yet another embodiment, the polymer compounds of the present invention, where applicable, have hard segment contents in the range of about 1 weight percent to about 12 weight percent, about 1.5 weight percent to about 10 weight percent, or even about 2 weight percent to about 9 weight percent. Here, as well as elsewhere in the specification and claims, individual range limits can be combined to form alternative non-disclosed ranges and/or range limits.

As would be apparent to those of skill in the art, when a polymer composition of the present invention has both hard and soft segments, the amount of both should total to 100 percent or less even though the above ranges for both may exceed in their broadest amounts more than 100 percent when totaled together at their widest amounts.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A method for producing a polyisobutylene compound containing urea hard segments comprising the steps of:
(A) providing a primary amine-terminated polyisobutylene having at least two primary amine termini;
(B) reacting the primary amine-terminated polyisobutylene with a diisocyanate and a chain extender; and
(C) recovering the polyisobutylene compound containing various urea hard segments.

2. The method of claim 1, wherein the primary amine-terminated polyisobutylene compound is a linear molecule.

3. The method of claim 1, wherein the diisocyanate is HMDI.

4. The method of claim 1, wherein the chain extender is selected from ethylenediamine, 1,4-diaminobutane, 1,6-diaminohexane, or mixtures of two or more thereof.

5. The method of claim 1, wherein the chain extender is ethylene diamine.

6. A polyisobutylene compound formed from the method of claim 1, wherein the polyisobutylene is connected to urea hard segment portions.

7. The polyisobutylene compound of claim 6, wherein the amount of urea hard segments is in the range of about 1 weight percent to about 90 weight percent.

8. The polyisobutylene compound of claim 6, wherein the amount of urea hard segments is in the range of about 2 weight percent to about 85 weight percent.

9. The polyisobutylene compound of claim 6, wherein the amount of urea hard segments is in the range of about 5 weight percent to about 80 weight percent.

10. The polyisobutylene compound of claim 6, wherein the amount of urea hard segments is in the range of about 10 weight percent to about 75 weight percent.

11. The polyisobutylene compound of claim 6, wherein the amount of urea hard segments is in the range of about 15 weight percent to about 70 weight percent.

12. The polyisobutylene compound of claim 6, wherein the amount of urea hard segments is in the range of about 20 weight percent to about 65 weight percent.

13. The polyisobutylene compound of claim 6, wherein the amount of urea hard segments is in the range of about 25 weight percent to about 60 weight percent.

14. The polyisobutylene compound of claim 6, wherein the amount of urea hard segments is in the range of about 36 weight percent to about 44 weight percent.

15. The polyisobutylene compound of claim 6, wherein the amount of urea hard segments is in the range of about 38 weight percent to about 42 weight percent.

16. A polyisobutylene compound formed from the method of claim 15, wherein the polyisobutylene is connected to urea segment portions.

17. A polyisobutylene compound formed from the method of claim 1, wherein the amount of urea hard segments is in the range of about 1 weight percent to about 12 weight percent.

18. A polyisobutylene compound formed from the method of claim 1, wherein the amount of urea hard segments is in the range of about 1.5 weight percent to about 10 weight percent.

19. A polyisobutylene compound formed from the method of claim 1, wherein the amount of urea hard segments is in the range of about 2 weight percent to about 9 weight percent.

20. A polymer product made by the method of claim 1.

21. A method for producing a polyisobutylene compound containing urethane segments comprising the steps of:
(a) providing a primary alcohol-terminated polyisobutylene having at least two primary alcohol termini;
(b) reacting the primary alcohol-terminated polyisobutylene with a diisocyanate and a chain extender; and
(c) recovering the polyisobutylene compound containing various urethane segments.

22. The method of claim 21, wherein the primary alcohol-terminated polyisobutylene compound is a linear molecule.

23. The method of claim 21, wherein the diisocyanate is HMDI.

24. The method of claim 21, wherein the chain extender is selected from 1,2-ethanediol, 1,4-butanediol, 1,6-hexanediol, or mixtures of two or more thereof.

25. The method of claim 21, wherein the chain extender is 1,6-hexanediol.

26. A polyisobutylene compound formed from the method of claim 21, wherein the polyisobutylene is connected to urethane segment portions.

27. The polyisobutylene compound of claim 26, wherein the amount of urethane hard segments is in the range of about 1 weight percent to about 90 weight percent.

28. The polyisobutylene compound of claim 26, wherein the amount of urethane hard segments is in the range of about 2 weight percent to about 85 weight percent.

29. The polyisobutylene compound of claim 26, wherein the amount of urethane hard segments is in the range of about 5 weight percent to about 80 weight percent.

30. The polyisobutylene compound of claim 26, wherein the amount of urethane hard segments is in the range of about 10 weight percent to about 75 weight percent.

31. The polyisobutylene compound of claim 26, wherein the amount of urethane hard segments is in the range of about 15 weight percent to about 70 weight percent.

32. The polyisobutylene compound of claim 26, wherein the amount of urethane hard segments is in the range of about 20 weight percent to about 65 weight percent.

33. The polyisobutylene compound of claim 26, wherein the amount of urethane hard segments is in the range of about 25 weight percent to about 60 weight percent.

34. The polyisobutylene compound of claim 26, wherein the amount of urethane hard segments is in the range of about 36 weight percent to about 44 weight percent.

35. The polyisobutylene compound of claim 26, wherein the amount of urethane hard segments is in the range of about 38 weight percent to about 42 weight percent.

36. A polyisobutylene compound formed from the method of claim 35, wherein the polyisobutylene is connected to urethane segment portions.

37. A polyisobutylene compound formed from the method of claim 21, wherein the amount of urethane hard segments is in the range of about 1 weight percent to about 12 weight percent.

38. A polyisobutylene compound formed from the method of claim 21, wherein the amount of urethane hard segments is in the range of about 1.5 weight percent to about 10 weight percent.

39. A polyisobutylene compound formed from the method of claim 21, wherein the amount of urethane hard segments is in the range of about 2 weight percent to about 9 weight percent.

40. A polymer product made by the method of claim 21.

41. A polymer compound comprising urea or urethane segments therein, the polymer compound comprising:
(i) one hard segment, wherein the hard segment is selected from a urea or urethane hard segment; and
(ii) two soft segments.

42. The polymer compound of claim 41, wherein the two soft segments are formed from polyisobutylene in combination with poly(tetramethylene oxide) and/or polycarbonate.

43. The polymer compound of claim 41, wherein the amount of soft segments in the polymer compound is in the range of about 10 weight percent to about 98 weight percent.

44. The polymer compound of claim 41, wherein the amount of soft segments in the polymer compound is in the range of about 15 weight percent to about 95 weight percent.

45. The polymer compound of claim 41, wherein the amount of soft segments in the polymer compound is in the range of about 20 weight percent to about 90 weight percent.

46. The polymer compound of claim 41, wherein the amount of soft segments in the polymer compound is in the range of about 25 weight percent to about 85 weight percent.

47. The polymer compound of claim 41, wherein the amount of soft segments in the polymer compound is in the range of about 30 weight percent to about 80 weight percent.

48. The polymer compound of claim 41, wherein the amount of soft segments in the polymer compound is in the range of about 35 weight percent to about 75 weight percent.

49. The polymer compound of claim 41, wherein the amount of soft segments in the polymer compound is in the range of about 40 weight percent to about 70 weight percent.

50. The polymer compound of claim 41, wherein the amount of soft segments in the polymer compound is in the range of about 45 weight percent to about 65 weight percent.

51. The polymer compound of claim 41, wherein the amount of soft segments in the polymer compound is in the range of about 56 weight percent to about 64 weight percent.

52. The polymer compound of claim 41, wherein the amount of soft segments in the polymer compound is in the range of about 58 weight percent to about 62 weight percent.

53. The polymer compound of claim 41, wherein the amount of hard segments in the polymer compound is in the range of about 1 weight percent to about 90 weight percent.

54. The polyisobutylene compound of claim 41, wherein the amount of hard segments in the polymer compound is in the range of about 2 weight percent to about 85 weight percent.

55. The polyisobutylene compound of claim 41, wherein the amount of hard segments in the polymer compound is in the range of about 5 weight percent to about 80 weight percent.

56. The polyisobutylene compound of claim 41, wherein the amount of hard segments in the polymer compound is in the range of about 10 weight percent to about 75 weight percent.

57. The polyisobutylene compound of claim 41, wherein the amount of hard segments in the polymer compound is in the range of about 15 weight percent to about 70 weight percent.

58. The polyisobutylene compound of claim 41, wherein the amount of hard segments in the polymer compound is in the range of about 20 weight percent to about 65 weight percent.

59. The polyisobutylene compound of claim 41, wherein the amount of hard segments in the polymer compound is in the range of about 25 weight percent to about 60 weight percent.

60. The polyisobutylene compound of claim 41, wherein the amount of hard segments in the polymer compound is in the range of about 36 weight percent to about 44 weight percent.

61. The polyisobutylene compound of claim 41, wherein the amount of hard segments in the polymer compound is in the range of about 38 weight percent to about 42 weight percent.

62. A polyisobutylene compound formed from the method of claim 41, wherein the amount of hard segments in the polymer compound is in the range of about 1 weight percent to about 12 weight percent.

63. A polyisobutylene compound formed from the method of claim 41, wherein the amount of hard segments in the polymer compound is in the range of about 1.5 weight percent to about 10 weight percent.

64. A polyisobutylene compound formed from the method of claim 41, wherein the amount of hard segments in the polymer compound is in the range of about 2 weight percent to about 9 weight percent.

65. The method of claim 1, wherein the primary amine-terminated polyisobutylene is a linear, star-shaped, hyperbranched, or arborescent compound.

66. The method of claim 1, wherein the primary amine-terminated polyisobutylene is a linear molecular and has two primary amine termini.

67. The method of claim 1, wherein the primary amine-terminated polyisobutylene is a star molecular and has two or more primary amine termini.

68. The method of claim 21, wherein the primary alcohol-terminated polyisobutylene is a linear, star-shaped, hyperbranched, or arborescent compound.

69. The method of claim 21, wherein the primary alcohol-terminated polyisobutylene is a linear molecular and has two primary amine termini.

70. The method of claim 21, wherein the primary alcohol-terminated polyisobutylene is a star molecular and has two or more primary amine termini.
